(19) United States
(12) Patent Application Publication
(10) Pub. No.: US 2023/0079783 A1
(43) Pub. Date: Mar. 16, 2023

(54) SYSTEM, METHOD, AND COMPUTER PROGRAM FOR ENABLING OPERATION BASED ON USER AUTHORIZATION

(71) Applicant: Duelight LLC, Sunnyvale, CA (US)

(72) Inventors: William Guie Rivard, Menlo Park, CA (US); Brian J. Kindle, Sunnyvale, CA (US)

(21) Appl. No.: 17/874,086

(22) Filed: Jul. 26, 2022

Related U.S. Application Data
(63) Continuation of application No. 16/460,807, filed on Jul. 2, 2019, now abandoned.

(51) Int. Cl. B60R 25/25; B60R 25/30; B60W 40/08; G06V 40/16

(52) U.S. Cl. CPC B60R 25/25; B60R 25/305; B60W 40/08; G06V 40/165; B60W 2540/043

(57) ABSTRACT

A system, method, and computer program are provided for enabling operation based on user authorization. In use, a first user is authenticated by receiving at least one first image based on a first set of sampling parameters, identifying at least one face associated with the at least one first image, and determining that the at least one face is an authorized user. Based on the authentication, the first user is permitted to access a first vehicle. Additionally, use of the first vehicle is verified for the first user, and in response to the verification, operation of the first vehicle by the first user is enabled.

### RELATED APPLICATIONS

This application is a continuation of and claims priority to and the benefit of U.S. patent application Ser. No. 16/460,807 filed Jul. 2, 2019, entitled “SYSTEM, METHOD, AND COMPUTER PROGRAM FOR ENABLING OPERATION BASED ON USER AUTHORIZATION,” the contents of which are incorporated herein by reference for all purposes.

This application is related to the following U.S. patent application, the entire disclosures being incorporated by reference herein for all purposes: application Ser. No. 13/573,252 (DUELP003/DL001), now U.S. Pat. No. 8,976,264, filed Sep. 4, 2012, entitled “COLOR BALANCE IN DIGITAL PHOTOGRAPHY”; application Ser. No. 14/568,045, now U.S. Pat. No. 9,406,147 (DUELP003A/DL001A), filed Dec. 11, 2014, entitled “COLOR BALANCE IN DIGITAL PHOTOGRAPHY”; application Ser. No. 14/534,068 (DUELP005/DL011), now U.S. Pat. No. 9,167,174, filed Nov. 5, 2014, entitled “SYSTEMS AND METHODS FOR HIGH-DYNAMIC RANGE IMAGES”; application Ser. No. 15/289,039 (DUELP006A/DL013A), filed Oct. 7, 2016, entitled “SYSTEM AND METHOD FOR GENERATING A DIGITAL IMAGE;” application Ser. No. 14/534,079 (DUELP007/DL014), now U.S. Pat. No. 9,137,455 filed Nov. 5, 2014, entitled “IMAGE SENSOR APPARATUS AND METHOD FOR OBTAINING MULTIPLE EXPOSURES WITH ZERO INTERFRAME TIME”; application Ser. No. 14/534,089 (DUELP008/DL015), now U.S. Pat. No. 9,167,169, filed Nov. 5, 2014, entitled “IMAGE SENSOR APPARATUS AND METHOD FOR SIMULTANEOUSLY CAPTURING MULTIPLE IMAGES”; application Ser. No. 14/535,274 (DUELP009/DL016), now U.S. Pat. No. 9,154,708, filed Nov. 6, 2014, entitled “IMAGE SENSOR APPARATUS AND METHOD FOR SIMULTANEOUSLY CAPTURING FLASH AND AMBIENT ILLUMINATED IMAGES”; application Ser. No. 14/535,279 (DUELP010/DL017), now U.S. Pat. No. 9,179,085, filed Nov. 6, 2014, entitled “IMAGE SENSOR APPARATUS AND METHOD FOR OBTAINING LOW-NOISE, HIGH-SPEED CAPTURES OF A PHOTOGRAPHIC SCENE”; application Ser. No. 14/536,524 (DUELP012/DL019), now U.S. Pat. No. 9,160,936, filed Nov. 7, 2014, entitled “SYSTEMS AND METHODS FOR GENERATING A HIGH-DYNAMIC RANGE (HDR) PIXEL STREAM”; application Ser. No. 13/999,343 (DUELP021/DL007), now U.S. Pat. No. 9,215,433, filed Feb. 11, 2014, entitled “SYSTEMS AND METHODS FOR DIGITAL PHOTOGRAPHY”; application Ser. No. 14/887,211 (DUELP021A/DL007A), filed Oct. 19, 2015, entitled “SYSTEMS AND METHODS FOR DIGITAL PHOTOGRAPHY”; application Ser. No. 13/999,678 (DUELP022/DL008), filed Mar. 14, 2014, entitled “SYSTEMS AND METHODS FOR A DIGITAL IMAGE SENSOR”; application Ser. No. 15/354,935 (DUELP022A/DL008A), filed Nov. 17, 2016, entitled “SYSTEMS AND METHODS FOR A DIGITAL IMAGE SENSOR”; application Ser. No. 15/201,283 (DUELP024/DL027), filed Jul. 1, 2016, entitled “SYSTEMS AND METHODS FOR CAPTURING DIGITAL IMAGES;” application Ser. No. 15/254,964 (DUELP025/DL028), filed Sep. 1, 2016, entitled “SYSTEMS AND METHODS FOR ADJUSTING FOCUS BASED ON FOCUS TARGET INFORMATION;” application Ser. No. 15/976,756 (DUELP029/DL031), filed May 10, 2018, entitled “SYSTEM, METHOD, AND COMPUTER PROGRAM FOR CAPTURING AN IMAGE WITH CORRECT SKIN TONE EXPOSURE;” and application Ser. No. 16/244,982 (DUELP032/DL034), filed Jan. 10, 2019, entitled “SYSTEMS AND METHODS FOR TRACKING A REGION USING AN IMAGE SENSOR.”

### FIELD OF THE INVENTION

The present invention relates to authorizing a user, and more particularly to enabling operation based on user authorization.

### BACKGROUND

Conventional authentication systems typically rely on knowledge-based systems (such as a password, two-factor authentication), secondary device(s) (such as smart card, key fob), and/or biometric characteristic (such as fingerprint, iris detection, face scan). Currently, use of photographic systems within the context of authentication systems is problematic for multiple reasons. For example, a lack of image quality or capture accuracy, a latency associated with capturing and processing an image for authentication, required processing power (e.g. to authentic a face), and/or a plethora of varying capture conditions (e.g. lighting, weather, etc.) may each contribute and further confound difficulties with capturing, and accurately and/or timely authenticating a resulting image.

There is thus a need for addressing these and/or other issues associated with the prior art.

### SUMMARY

A system, method, and computer program are provided for enabling operation based on user authorization. In use, a first user is authenticated by receiving at least one first image based on a first set of sampling parameters, identifying at least one face associated with the at least one first image, and determining that the at least one face is an authorized user. Based on the authentication, the first user is permitted to access a first vehicle. Additionally, use of the first vehicle is verified for the first user, and in response to the verification, operation of the first vehicle by the first user is enabled.

### BRIEF DESCRIPTION OF THE DRAWINGS

FIG. 1 illustrates an exemplary method for enabling operation based on user authorization, in accordance with one possible embodiment.

FIG. 2 illustrates a method for enabling operation of a vehicle based on user authorization, in accordance with one embodiment.

FIG. 3A illustrates a digital photographic system, in accordance with an embodiment.

FIG. 3B illustrates a processor complex within a digital photographic system, according to one embodiment.

FIG. 3C illustrates a camera module configured to sample an image and transmit a digital representation of the image to a processor complex, according to an embodiment.

FIG. 3D illustrates a camera module in communication with an application processor, in accordance with an embodiment.

FIG. 3E illustrates a vehicle, in accordance with an embodiment.

FIG. 3F illustrates a vehicle interior, in accordance with an embodiment.

FIG. 4A illustrates a method for admitting an authorized user into a vehicle based on visual metrics, in accordance with an embodiment.

FIG. 4B illustrates a method for admitting an authorized user into a vehicle based on visual and iris metrics, according to one embodiment.

FIG. 4C illustrates a method for admitting an authorized user into a vehicle based on visual metrics and RF/data network authentication, in accordance with an embodiment.

FIG. 4D illustrates a method for admitting an authorized user into a vehicle based on visual metrics and NFC authentication, in accordance with another embodiment.

FIG. 4E illustrates a method for admitting an authorized user into a vehicle based on visual and voice metrics, and/or NFC authentication, according to one embodiment.

FIG. 5A illustrates a method for verifying use of vehicle by an authorized user based on visual metrics, in accordance with an embodiment.

FIG. 5B illustrates a method for verifying use of vehicle by an authorized user based on visual and voice metrics, according to one embodiment.

FIG. 5C illustrates a method for verifying use of vehicle by an authorized user based on visual metrics and NFC authentication, in accordance with an embodiment.

FIG. 5D illustrates a method for verifying use of vehicle by an authorized user based on iris scan metrics, in accordance with another embodiment.

FIG. 5E illustrates a method for verifying use of vehicle by an authorized user based on a response during an iris scan, according to one embodiment.

FIG. 5F illustrates iris dilation in response to a pulse of light, in accordance with an embodiment.

FIG. 6A illustrates a method for enabling operation of a vehicle based on a user driving within a geo-fence, in accordance with an embodiment.

FIG. 6B illustrates a method for enabling operation of a vehicle based on one user and a self-driving vehicle operating within a geo-fence, according to one embodiment.

FIG. 6C illustrates a method for enabling operation of a vehicle based on multiple users and a self-driving vehicle operating within a geo-fence, in accordance with an embodiment.

FIG. 7A illustrates a system for enabling and directing operation of a vehicle, in accordance with an embodiment.

FIG. 7B illustrates a method for configuring a neural-net inference subsystem, according to one embodiment.

FIG. 8 illustrates a communications network architecture, in accordance with one possible embodiment.

FIG. 9 illustrates an exemplary system, in accordance with one embodiment.

FIG. 10A illustrates a first exemplary method for capturing an image, in accordance with one possible embodiment.

FIG. 10B illustrates a second exemplary method for capturing an image, in accordance with one possible embodiment.

FIG. 10C illustrates an exemplary scene segmentation into a face region and non-face regions, in accordance with one possible embodiment.

FIG. 10D illustrates a face region mask of a scene, in accordance with one possible embodiment.

FIG. 10E illustrates a face region mask of a scene including a transition region, in accordance with one possible embodiment.

FIG. 11 illustrates an exemplary transition in mask value from a non-face region to a face region, in accordance with one possible embodiment.

FIG. 12 illustrates an exemplary method carried out for adjusting focus based on focus target information, in accordance with one possible embodiment.

FIG. 13 illustrates an exemplary system configured to adjust focus based on focus target information, in accordance with one embodiment.

FIG. 14 illustrates a camera module in communication with an application processor, in accordance with an embodiment.

FIG. 15 illustrates an array of focus pixels within an image sensor, in accordance with an embodiment.

FIG. 16 illustrates an array of focus pixel point(s) and focus region(s) within an image sensor, in accordance with an embodiment.

FIG. 17 illustrates a method for adjusting focus based on focus target information, in accordance with an embodiment.

FIG. 18 illustrates a method for monitoring vehicle condition, in accordance with an embodiment.

FIG. 19 illustrates a method for participating in a search operation, in accordance with an embodiment.

### DETAILED DESCRIPTION

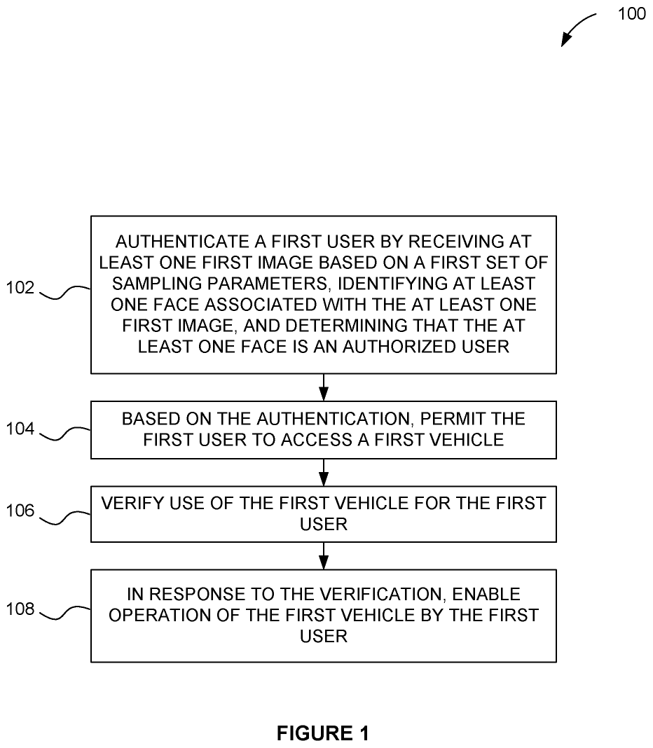

FIG. 1 illustrates an exemplary method 100 for enabling operation based on user authorization, in accordance with one possible embodiment.

As shown, a first user (e.g., a person) is authenticated by receiving at least one first image based on a first set of sampling parameters, identifying at least one face associated with the at least one first image, and determining that the at least one face is an authorized user (potential vehicle operator, driver, passenger, or occupant). See operation 102. In one embodiment, the at least one face may be identified by creating a face model, and comparing the face model to a database of authorized face models. The database of authorized face models may reside locally (e.g., at a vehicle) or remotely (e.g., at a remote server). Additionally, the at least one face may be identified by using at least one depth map, a texture map representation of the at least one image, or a combination thereof.

In an embodiment, the face model may include and/or derive from an image depth map, an image surface texture map, an audio map, a correlation map, or a combination thereof. The correlation map may associate audio information (e.g., phonetics, intonations, and/or emotional voice variations, etc.), with visual information (e.g., facial expression, mouth position, etc.).

The first user may be further authenticated by receiving at least one second image based on a second set of sampling parameters, and blending the at least one first image and the at least one second image to form a blended image (e.g., to generate a high-dynamic range image, a fused multi-spectral image, a set of fused images, or a fused image that combines flash and ambient images). The at least one first image may be aligned with the at least one second image.

In one embodiment, the first set of sampling parameters may relate to an ambient exposure, and at least one second image based on a second set of sampling parameters may be received, the second set of sampling parameters relating to a strobe exposure. The first set of sampling parameters may include exposure coordinates. In an embodiment, the exposure coordinates define one or more exposure points of interest that may be metered to calculate sampling parameters for exposure. In an embodiment, one or more of the exposure coordinates are positioned within a region of the at least one first image that bounds the at least one face (e.g. of the first user).

Additionally, the first user may be further authenticated by receiving an audio input, the audio input compared against an audio signature of authorized users, and/or by receiving an iris scan, the iris scan compared against iris scans of authorized users. In an embodiment, the user speaks one or more words to provide the audio input. Furthermore, the user may speak the one or more words while a video camera samples their face in motion; an analysis of the user face in motion may then be used, in part (e.g., in combination with the audio input), to authenticate the user. In another embodiment, an iris (or retina) scan is performed while the user speaks one or more words. The iris/retina scan may then be used, in part, to authenticate the user.

Still yet, the first user may be further authenticated using a secondary device, such as a near-field communication (NFC) security device. The NFC security device may be configured to operate in a card emulation mode. In an embodiment, the NFC security device may comprise an NFC-enabled credit card. In yet another embodiment, the NFC security device may comprise a smart key. In still yet another embodiment, the secondary device may comprise a key fob device. The first user may be further authenticated by an audio signature in combination with the secondary device.

Based on the authentication, the first user is permitted to access a first vehicle. See operation 104. Additionally, a use of the first vehicle for the first user is verified. See operation 106. In one embodiment, the use of the first vehicle may be verified using at least one of a geo-fence, vehicle conditions, road conditions, user conditions, or user restriction rules.

Further, in response to the verification, operation of the first vehicle by the first user is enabled. See operation 108. In one embodiment, it may be determined that the first vehicle is being operated in a non-compliant manner, and in response, a report may be provided to a second user. In an embodiment, the non-compliant manner may be overridden (e.g., allowed) based on feedback from the second user in response to the report. In various scenarios, an individual who is not authenticated is not permitted access to the vehicle, or an individual who is not verified to use the vehicle may be denied use, and so forth.

Additionally, the use of the first vehicle may be restricted based on one or all occupants of the first vehicle, each occupant of the occupants having a separate occupant profile (e.g., a face model for facial recognition/authentication). The first vehicle may be enabled with no restriction or at least one restriction based on a combination of all occupant profiles of the occupants, the at least one restriction including at least one of a time restriction, a speed limit restriction, a route restriction, a location restriction, a passenger restriction, or a driver restriction. In various embodiments, arbitrary Boolean combinations may define whether a vehicle is authorized. For example, a specific driver (e.g., a teenager with a learner's permit but not a driver's license) may require at least one passenger (a parent or older sibling) from a required passenger list. In another example, a specific driver (a teenager with a license) may not operate the vehicle with a restricted person in the vehicle (e.g., a distracting friend restricted by the driver's parent, or stranger not known to the vehicle). Such Boolean combinations or required and/or restricted person may be applied to any applicable methods disclosed herein. Furthermore, such combinations may be generally applied to govern geographic, geo-fence, and/or driving corridor restrictions.

More illustrative information will now be set forth regarding various optional architectures and uses in which the foregoing method may or may not be implemented, per the desires of the user and/or manufacturer. It should be strongly noted that the following information is set forth for illustrative purposes and should not be construed as limiting in any manner. Any of the following features may be optionally incorporated with or without the exclusion of other features described.

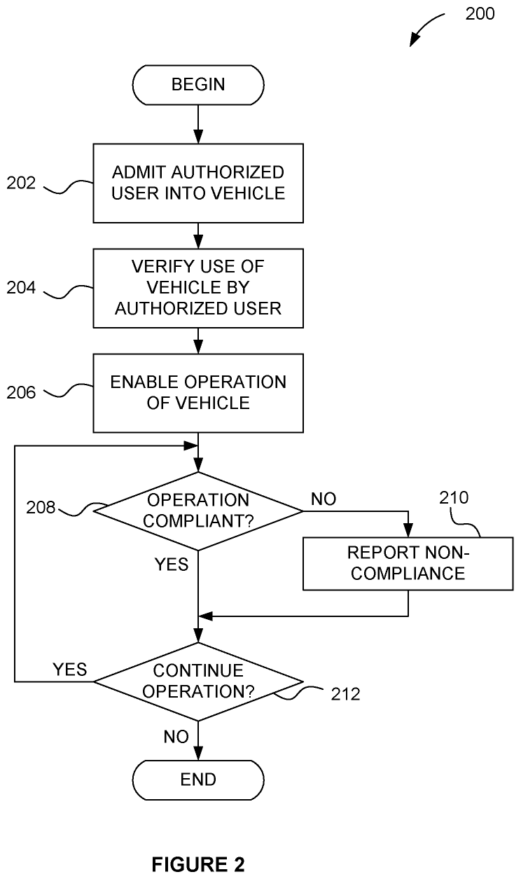

FIG. 2 illustrates a method 200 for enabling operation of a vehicle based on user authorization. As an option, the method 200 may be implemented in the context of any one or more of the embodiments set forth in any previous and/or subsequent figure(s) and/or description thereof. Of course, however, the method 200 may be implemented in the context of any desired environment. Further, the aforementioned definitions may equally apply to the description below.

Although the method 200 describes the authorization in the context of a vehicle, it is to be appreciated that the method 200 may apply equally to any context or situation where authorization may arise, including use of drones; entrance to a building, wall, room, or other physical location or barrier; use of a device; and/or any security-related system, etc.

As shown, the method 200 begins at operation 202 where an authorized user is admitted into a vehicle. In the context of the present description, an authorized user includes a user that has permission or authorization. In various embodiments, the operation 202 may determine whether to admit a user into a vehicle based on any or all of the method 400, method 401, method 403, method 405, and/or method 407, described hereinbelow. In one embodiment, the operation 202 may use any detection system, including a secondary device, biometric characteristics, and/or photograph systems.

Next, use of the vehicle is verified by the authorized user. See operation 204. In various embodiments, the operation 204 may verify use of the vehicle by authorized user based on any or all of the method 500, method 501, method 503, method 505, and/or method 507, described hereinbelow. Verifying use of the vehicle may include a determination that the authorized user is in an acceptable chemical state (e.g., not intoxicated) and/or emotional state (e.g., not sleepy or angry) if use of the vehicle includes driving the vehicle.

An operation of the vehicle is enabled. See operation 206. In various embodiments, the operation 206 may enable an operation of the vehicle based on any or all of the method 600, method 601, and/or method 603, described hereinbelow.

It is determined whether the operation is compliant. See decision 208. If the decision 208 is compliant, the method 200 proceeds to decision 212 where it is determined whether to continue operation. If the decision 208 is not compliant, the method 200 proceeds to operation 210 where a non-compliance indication is reported, after which the method continues to the decision 212. If the decision 212 continues, then the method 200 continues back to the decision 208, else the method 200 ends.

In various embodiments, determining whether the operation is compliant may include one or more of: determining whether the vehicle follows a predetermined route(s), determining whether the vehicle is within a predetermined geo-fence, determining whether the vehicle is operated within predetermined hours, determining whether the vehicle is operated at a predetermined maximum (or minimum) speed, determining whether the vehicle is operated at a speed limit for a given span of road, determining whether the vehicle is operating according to traffic control signs and/or lights, determining whether the vehicle includes pre-approved occupants (other than the driver, or the user sitting in the driver's seat), determining whether the vehicle does not include prohibited occupants, etc.

In one embodiment, compliance may be overridden. For example, in one embodiment, in response to a non-compliance indication being reported to a parent (e.g., an administrator for the vehicle), the parent may provide authorization to continue on to a new destination that would otherwise be non-compliant. Additionally, in another embodiment, one or more conditions of the vehicle may prompt a purposeful non-compliance. For example, a gas or electric power level may fall below a predetermined threshold, an accident on the current pre-approved route may prompt a new route to be approved that may otherwise not be approved, or a time delay along the current pre-approved route may prompt a new route to be approved that may otherwise not be approved, etc.

Additionally, a non-compliance indication/report may include any indication of non-compliance, including a fault report (e.g., mechanical issue with vehicle), a message (email, SMS, etc.), a log entry, etc., or any other technically feasible message or notification. In one embodiment, the non-compliance indication may be sent to one or more users, including, for example, the authorized user, a predetermined user (such as a parent or guardian, etc.), etc.

Further, in additional embodiments, determining whether to continue may include one or more of: determining whether the authorized user is in the driver's seat of the vehicle (is the vehicle driver), determining whether a time curfew has been surpassed, determining whether the occupants of the vehicle have changed, determining whether any prior condition (prior to the enabling of the vehicle) has changed, receiving an exception to compliance criteria from the parent, etc.

In one embodiment, the method 200 may build upon previously gathered data. In this manner, a system performing the method 200 may learn from previously completed actions and/or gathered metrics. For example, a first user may repeatedly use the vehicle to travel to and from work. Based on daily usage of the vehicle, daily photographs (for authorization to be admitted to the vehicle) may be taken in a variety of environments, lighting, hair styles, etc. As time passes, the time to authorize the user may decrease and/or diversity of appearance of the authorized user may increase based on a greater dataset that allows for more accurate determination that the authorized user is present. Any technically feasible machine learning or other adaptive techniques may be applied in this context.

Further, the method 200 may relate to driving experience awareness. For example, the method 200 may allow for a customized set of settings to be applied based on the authorized user that is admitted. For example, a first-time user of the vehicle with no other restrictions may have unlimited use of vehicle controls and operational privileges, whereas a youth that already has restrictions applied (e.g., as set by a parent), may have limited operational privileges. Such vehicle controls and/or operational privileges may include, without limitation, a maximum acceleration, a breaking speed-distance boundary for activating collision avoidance breaking, maximum speed (or fraction of road speed limit), a lower maximum speed and acceleration in degraded road conditions (e.g. rain, snow, ice), and so forth.

As another example, the method 200 may allow for contextual awareness. For example, a time of day (morning, midday, night), a location of the vehicle, a number of occupants to be admitted to the vehicle, a state of a user (e.g. sober, etc.), a connection state, and/or nearby devices may be used as input for the vehicle to be contextually aware. Such inputs may be used to guide admission into the vehicle, verification of use of the vehicle, operational control limits of the vehicle, and compliance determination.

In an embodiment, techniques described herein may be performed by systems built into a vehicle at initial manufacturing. In other embodiments, the techniques may be performed by an upgrade kit installed into the vehicle after initial manufacturing. The upgrade kit may include any or all of various system elements described herein. In yet other embodiments, the techniques may be performed, at least in part, by a user device such as a smartphone.

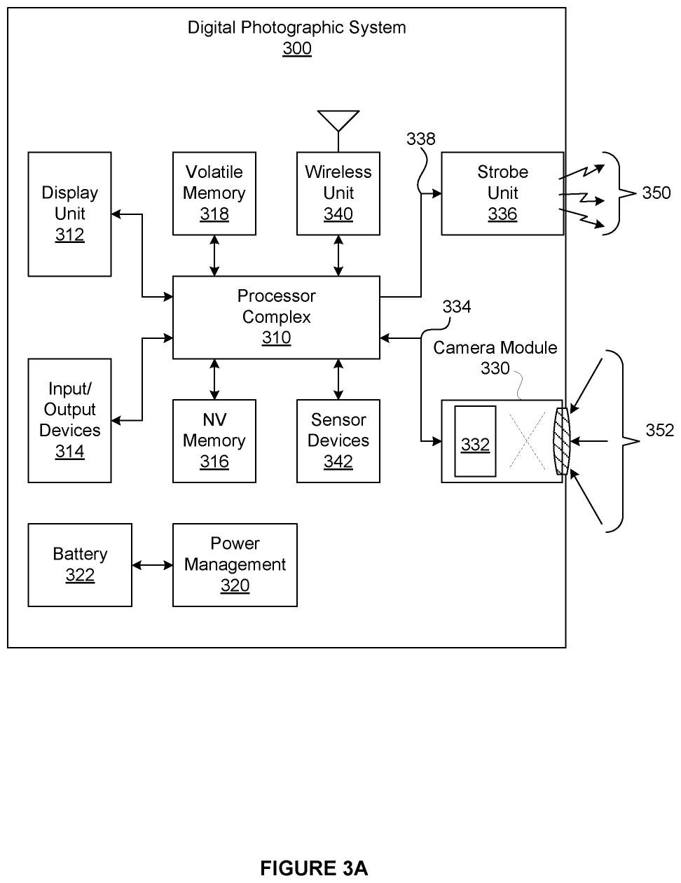

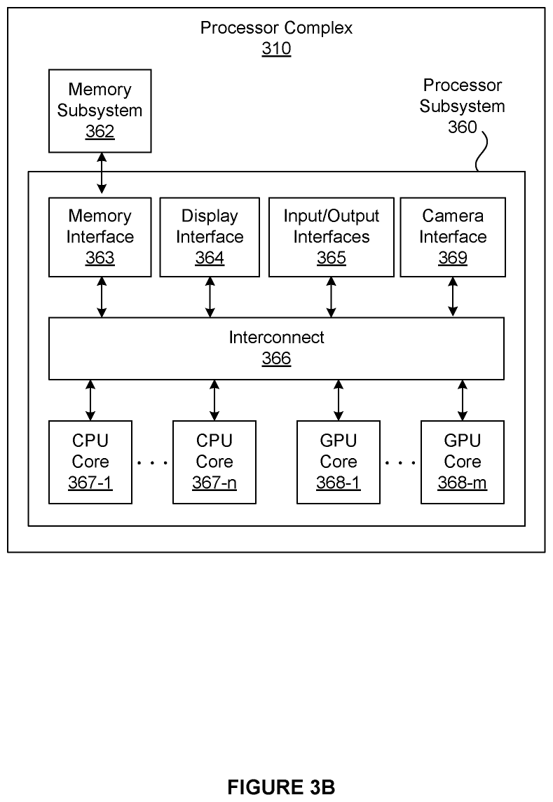

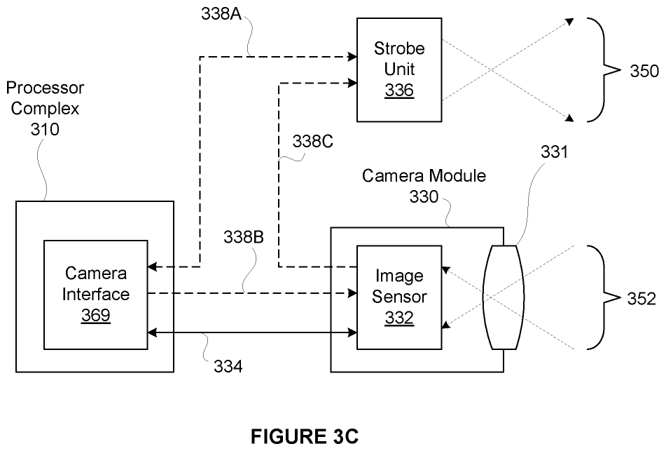

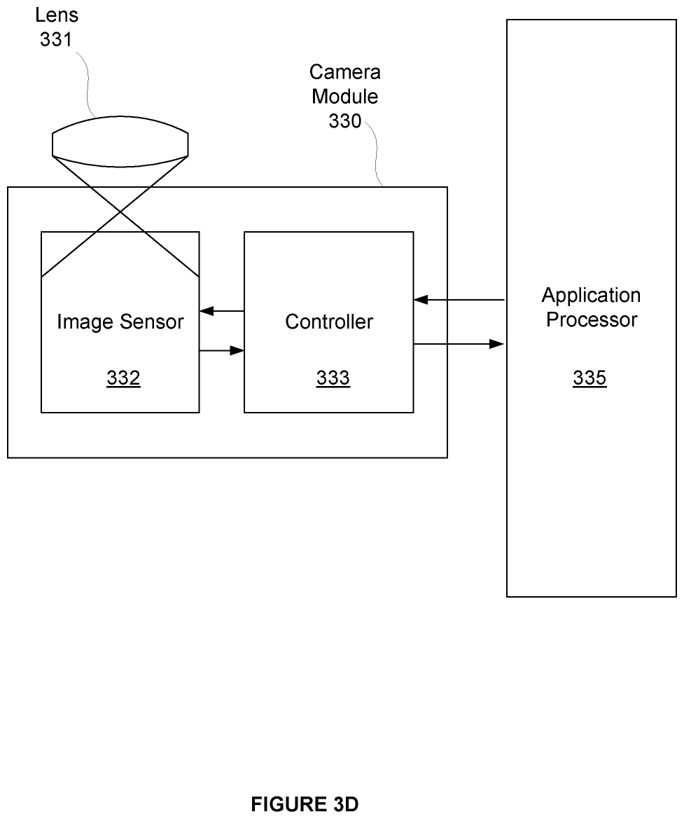

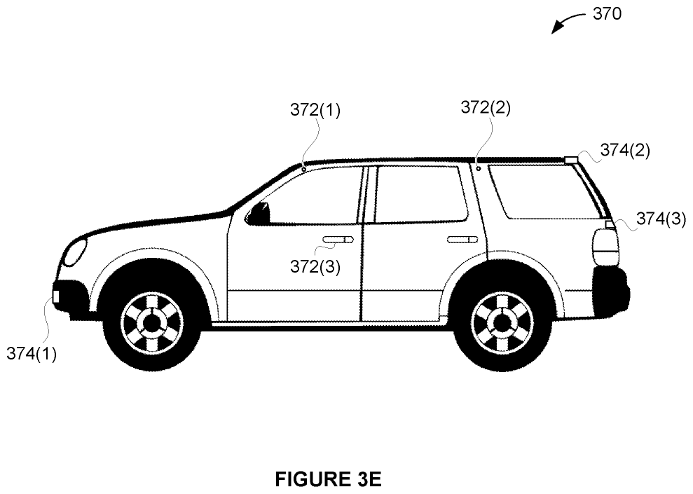

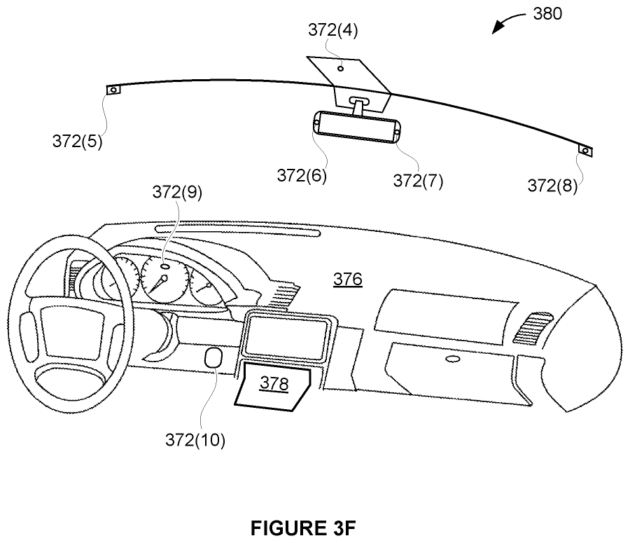

FIG. 3A illustrates a digital photographic system 300, in accordance with one embodiment. As an option, the digital photographic system 300 may be implemented in the context of the details of any of the Figures disclosed herein. Of course, however, the digital photographic system 300 may be implemented in any desired environment. Further, the aforementioned definitions may equally apply to the description below.

As shown, the digital photographic system 300 may include a processor complex 310 coupled to a camera module 330 via an interconnect 334. In one embodiment, the processor complex 310 is coupled to a strobe unit 336. The digital photographic system 300 may also include, without limitation, a display unit 312, a set of input/output devices 314, non-volatile memory 316, volatile memory 318, a wireless unit 340, and sensor devices 342, each coupled to the processor complex 310. In one embodiment, a power management subsystem 320 is configured to generate appropriate power supply voltages for each electrical load element within the digital photographic system 300. A battery 322 may be configured to supply electrical energy to the power management subsystem 320. The battery 322 may implement any technically feasible energy storage system, including primary or rechargeable battery technologies. Of course, in other embodiments, additional or fewer features, units, devices, sensors, or subsystems may be included in the system. Furthermore, the battery 322 and/or any other source of electrical power may be disposed physically outside the digital photographic system 300.

In one embodiment, a strobe unit 336 may be configured to provide strobe illumination 350 during an image sample event performed by the digital photographic system 300. The strobe unit 336 may comprise one or more LED devices, a gas-discharge illuminator (e.g. a Xenon strobe device, a Xenon flash lamp, etc.), or any other technically feasible illumination device. In certain embodiments, two or more strobe units are configured to synchronously generate strobe illumination in conjunction with sampling an image. In one embodiment, the strobe unit 336 is controlled through a strobe control signal 338 to either emit the strobe illumination 350 or not emit the strobe illumination 350. The strobe control signal 338 may be implemented using any technically feasible signal transmission protocol. The strobe control signal 338 may indicate a strobe parameter (e.g. strobe intensity, strobe color, strobe time, etc.), for directing the strobe unit 336 to generate a specified intensity and/or color of the strobe illumination 350. The strobe control signal 338 may be generated by the processor complex 310, the camera module 330, or by any other technically feasible combination thereof. In one embodiment, the strobe control signal 338 is generated by a camera interface unit (not shown) within the processor complex 310 and transmitted to both the strobe unit 336 and the camera module 330. In another embodiment, the strobe control signal 338 is generated by the camera module 330 and transmitted to the strobe unit 336 via the interconnect 334. In an embodiment, the strobe unit 336 is configured to generate infrared and/or ultraviolet light and substantially no visible light. In another embodiment, the strobe unit 336 is configured to generate (or also generate) visible light.

Optical scene information 352, which may include at least a portion of the strobe illumination 350 reflected from objects in a photographic scene, is focused as an optical image onto an image sensor 332 within the camera module 330. The image sensor 332 generates an electronic representation of the optical image. The electronic representation comprises spatial color intensity information, which may include different color intensity samples (e.g. red, green, and blue, infrared, ultraviolet light, etc.). In other embodiments, the spatial color intensity information may also include samples for white light. The electronic representation is transmitted to the processor complex 310 via the interconnect 334, which may implement any technically feasible signal transmission protocol.

In one embodiment, input/output devices 314 may include, without limitation, a capacitive touch input surface, a resistive tablet input surface, one or more buttons, one or more knobs, light-emitting devices, light detecting devices, sound emitting devices, sound detecting devices, or any other technically feasible device for receiving user input and converting the input to electrical signals, or converting electrical signals into a physical signal. In one embodiment, the input/output devices 314 include a capacitive touch input surface coupled to a display unit 312. A touch entry display system may include the display unit 312 and a capacitive touch input surface, also coupled to processor complex 310.

Additionally, in other embodiments, non-volatile (NV) memory 316 is configured to store data when power is interrupted. In one embodiment, the NV memory 316 comprises one or more flash memory devices (e.g. ROM, PCM, FeRAM, FRAM, PRAM, MRAM, NRAM, etc.). The NV memory 316 comprises a non-transitory computer-readable medium, which may be configured to include programming instructions for execution by one or more processing units within the processor complex 310. The programming instructions may implement, without limitation, an operating system (OS), UI software modules, image processing and storage software modules, one or more input/output devices 314 connected to the processor complex 310, one or more software modules for sampling an image stack through camera module 330, one or more software modules for presenting the image stack or one or more synthetic images generated from the image stack through the display unit 312. As an example, in one embodiment, the programming instructions may also implement one or more software modules for merging images or portions of images within the image stack, aligning at least portions of each image within the image stack, or a combination thereof. In another embodiment, the processor complex 310 may be configured to execute the programming instructions, which may implement one or more software modules operable to create a high dynamic range (HDR) image, a fused multi-spectra image, a fused ambient and flash image, an infrared image (e.g., short, medium, and/or long wave), an ultraviolet image, or an image stack comprising one or more images and/or one or more fused images (e.g., visible light image fused with non-visible light image). In an embodiment, images stack and/or resulting fused images are further processed to generate a three-dimensional (3D) model of a scene from fused images. In this way, for example, infra-red image data may be fused with visible image data to generate a detailed 3D geometric model of a scene object having thermal coloring (temperature based false color) as a surface texture. If the scene object includes a person's face, the thermal coloring may indicate whether the person is ill (running a fever, or hypothermic). Furthermore, such a geometric model may be used for identifying specific individuals, such as for authentication purposes.

Still yet, in one embodiment, one or more memory devices comprising the NV memory 316 may be packaged as a module configured to be installed or removed by a user. In one embodiment, volatile memory 318 comprises dynamic random access memory (DRAM) configured to temporarily store programming instructions, image data such as data associated with an image stack, and the like, accessed during the course of normal operation of the digital photographic system 300. Of course, the volatile memory may be used in any manner and in association with any other input/output device 314 or sensor device 342 attached to the processor complex 310.

In one embodiment, sensor devices 342 may include, without limitation, one or more of an accelerometer to detect motion and/or orientation, an electronic gyroscope to detect motion and/or orientation, a magnetic flux detector to detect orientation, a global positioning system (GPS) module to detect geographic position, or any combination thereof. Of course, other sensors, including but not limited to a motion detection sensor, a proximity sensor, an RGB light sensor, an infrared light detector, a gesture sensor, a 3-D input image sensor, a pressure sensor, and an indoor position sensor, may be integrated as sensor devices. In one embodiment, the sensor devices may be one example of input/output devices 314.

Wireless unit 340 may include one or more digital radios configured to send and receive digital data. In particular, the wireless unit 340 may implement wireless standards (e.g. WiFi, Bluetooth, NFC, etc.), and may implement digital cellular telephony standards for data communication (e.g. CDMA, 3G, 4G, LTE, LTE-Advanced, etc.). Of course, any wireless standard or digital cellular telephony standards may be used.

In one embodiment, the digital photographic system 300 is configured to transmit one or more digital photographs (e.g., still images, video footage) to a network-based (online) or “cloud-based” photographic media service via the wireless unit 340. The one or more digital photographs may reside within either the NV memory 316 or the volatile memory 318, or any other memory device associated with the processor complex 310. In one embodiment, a user may possess credentials to access an online photographic media service and to transmit one or more digital photographs for storage to, retrieval from, and presentation by the online photographic media service. The credentials may be stored or generated within the digital photographic system 300 prior to transmission of the digital photographs. In certain embodiments, one or more digital photographs are generated by the online photographic media service based on image data (e.g. image stack, HDR image stack, image package, etc.) transmitted to servers associated with the online photographic media service. In such embodiments, a user may upload one or more source images from the digital photographic system 300 for processing by the online photographic media service.

In another embodiment, the digital photographic system 300 is configured to transmit the one or more digital photographs to a mobile device (e.g., a smartphone). The smartphone may be located at the vehicle, such as within the passenger compartment. Furthermore, the vehicle may communicate directly with the smartphone, for example using a direct wireless link provided by wireless unit 340. In an embodiment, the smartphone may store and upload the one or more digital photographs to the network-based or “cloud-based” photographic media service upon connection with a mobile wireless carrier or upon connection with an appropriate local WiFi access point.

In one embodiment, the digital photographic system 300 comprises at least one instance of a camera module 330. In another embodiment, the digital photographic system 300 comprises a plurality of camera modules 330. Such an embodiment may also include at least one strobe unit 336 configured to illuminate a photographic scene, sampled as multiple views by the plurality of camera modules 330. The plurality of camera modules 330 may be configured to sample a wide angle view (e.g., greater than forty-five degrees of sweep among cameras) to generate a synthetic aperture photograph, for example to capture a sweep view of all persons in front seats (e.g., driver and passengers) within the vehicle. An additional synthetic aperture photograph may be generated to capture a sweep view of all passengers in back seats within the vehicle. Alternatively, individual views from each camera module 330 may be processed separately. In one embodiment, a plurality of camera modules 330 may be configured to sample two or more narrow angle views (e.g., less than forty-five degrees of sweep among cameras) to generate an iris and/or retina scan of an individual presenting as an authorized user of the vehicle. In other embodiments, a plurality of camera modules 330 may be configured to generate a 3-D image, for example to generate a face model of a person presenting as an authorized user of the vehicle.

In one embodiment, a display unit 312 may be configured to display a two-dimensional array of pixels to form an image for display. The display unit 312 may comprise a liquid-crystal (LCD) display, a light-emitting diode (LED) display, an organic LED display, or any other technically feasible type of display. In certain embodiments, the display unit 312 may be able to display a narrower dynamic range of image intensity values than a complete range of intensity values sampled from a photographic scene, such as within a single HDR image or over a set of two or more images comprising a multiple exposure or HDR image stack. In one embodiment, images comprising an image stack may be merged according to any technically feasible HDR and/or multispectral fusing or blending technique to generate a synthetic image for processing and/or display within dynamic range constraints of the display unit 312. In one embodiment, the limited dynamic range may specify an eight-bit per color channel binary representation of corresponding color intensities. In other embodiments, the limited dynamic range may specify more than eight-bits (e.g., 10 bits, 12 bits, or 14 bits, etc.) per color channel binary representation.

FIG. 3B illustrates a processor complex within a digital photographic system, in accordance with one embodiment. In an embodiment, the processor complex comprises processor complex 310 within digital photographic system 300 of FIG. 3A. As an option, the processor complex 310 may be implemented in the context of the details of any of the Figures disclosed herein. Of course, however, the processor complex 310 may be implemented in any desired environment. Further, the aforementioned definitions may equally apply to the description below.

As shown, the processor complex 310 includes a processor subsystem 360 and may include a memory subsystem 362. In one embodiment, processor complex 310 may comprise a system on a chip (SoC) device that implements processor subsystem 360, and memory subsystem 362 comprises one or more DRAM devices coupled to the processor subsystem 360. In another embodiment, the processor complex 310 may comprise a multi-chip module (MCM) encapsulating the SoC device and the one or more DRAM devices comprising the memory subsystem 362.

The processor subsystem 360 may include, without limitation, one or more central processing unit (CPU) cores 367, a memory interface 363, input/output interfaces unit 365, each coupled to an interconnect 366. The processor subsystem 360 may also include a display interface unit 364. The one or more CPU cores 367 may be configured to execute instructions residing within the memory subsystem 362, volatile memory 318, NV memory 316, or any combination thereof. Each of the one or more CPU cores 367 may be configured to retrieve and store data through interconnect 366 and the memory interface 363. In one embodiment, each of the one or more CPU cores 367 may include a data cache, and an instruction cache. Additionally, two or more of the CPU cores 367 may share a data cache, an instruction cache, or any combination thereof. In one embodiment, a cache hierarchy is implemented to provide each CPU core 367 with a private cache layer, and a shared cache layer.

In some embodiments, processor subsystem 360 may include one or more graphics processing unit (GPU) cores 368. Each GPU core 368 may comprise a plurality of multi-threaded execution units that may be programmed to implement, without limitation, graphics acceleration functions. In various embodiments, the GPU cores 368 may be configured to execute multiple thread programs according to well-known standards (e.g. OpenGL™, WebGL™, OpenCL™, CUDA™, etc.), and/or any other language for programming GPUs. In certain embodiments, at least one GPU core 368 implements at least a portion of a motion estimation function, such as a well-known Harris detector or a well-known Hessian-Laplace detector. Such a motion estimation function may be used at least in part to align images or portions of images within an image stack prior to generating a merged or fused image. For example, in one embodiment, an HDR image may be compiled based on an image stack, where two or more images are first aligned prior to compiling the HDR image. In certain embodiments, the GPU cores 368 and/or the CPU cores 367 may be programmed or otherwise configured to implement a neural network structure, such as a convolutional neural network for performing inference operations. Such operations may provide object identification, scene segmentation, scene deconstruction, and so forth. In other embodiments, special purpose processors (not shown) such as, without limitation, programmable and/or fixed-function digital signal processors (DSPs), application processing units (APUs), neural network processors (e.g., hardware-assisted neural network function units), and so forth, may be included within processor complex 310 and execute certain overall method steps of methods disclosed herein.

As shown, the interconnect 366 is configured to transmit data between and among the memory interface 363, the display interface unit 364, the input/output interfaces unit 365, the CPU cores 367, and the GPU cores 368. In various embodiments, the interconnect 366 may implement one or more buses, one or more rings, a cross-bar, a mesh, or any other technically feasible data transmission structure or technique. The memory interface 363 is configured to couple the memory subsystem 362 to the interconnect 366. The memory interface 363 may also couple NV memory 316, volatile memory 318, or any combination thereof to the interconnect 366. The display interface unit 364 may be configured to couple a display unit 312 to the interconnect 366. The display interface unit 364 may implement certain frame buffer functions (e.g. frame refresh, etc.). Alternatively, in another embodiment, the display unit 312 may implement certain frame buffer functions (e.g. frame refresh, etc.). The input/output interfaces unit 365 may be configured to couple various input/output devices to the interconnect 366. In an embodiment, a camera interface unit 369 may be configured to communicate with one or more camera modules 330 through interconnect(s) 334, and each interconnect 334 may each comprise one or more high-speed serial connections. The camera interface unit 369 may include input/output interface circuits and any relevant communications state machines and/or buffers for communicating with the camera modules 330. Optionally, the camera interface unit 369 may be configured to transmit control signals to one or more strobe units 336.

In certain embodiments, a camera module 330 is configured to store exposure parameters for sampling each image associated with an image stack. For example, in one embodiment, when directed to sample a photographic scene, the camera module 330 may sample a set of images comprising the image stack according to stored exposure parameters. A software module comprising programming instructions executing within a processor complex 310 may generate and store the exposure parameters prior to directing the camera module 330 to sample the image stack. In other embodiments, the camera module 330 may be used to meter an image or an image stack, and the software module comprising programming instructions executing within a processor complex 310 may generate and store metering parameters prior to directing the camera module 330 to capture the image. Of course, the camera module 330 may be used in any manner in combination with the processor complex 310.

In one embodiment, exposure parameters associated with images comprising the image stack may be stored within an exposure parameter data structure that includes exposure parameters for one or more images. In another embodiment, the camera interface unit 369 may be configured to read exposure parameters from the exposure parameter data structure and to transmit associated exposure parameters to the camera module 330 in preparation of sampling a photographic scene. After the camera module 330 is configured according to the exposure parameters, the camera interface may direct the camera module 330 to sample the photographic scene; the camera module 330 may then generate a corresponding image stack. The exposure parameter data structure may be stored within the camera interface unit, a memory circuit within the processor complex 310, volatile memory 318, NV memory 316, the camera module 330, or within any other technically feasible memory circuit. Further, in another embodiment, a software module executing within processor complex 310 may generate and store the exposure parameter data structure.

FIG. 3C illustrates camera module 330 configured to sample an image and transmit a digital representation of the image to processor complex 310, in accordance with one embodiment. As an option, the processor complex 310 and/or the camera module 330 may be implemented in the context of the details of any of the Figures disclosed herein. Of course, however, the camera module 330 may be implemented in any desired environment. Further, the aforementioned definitions may equally apply to the description below.

In an embodiment, the camera module 330 may be configured to control strobe unit 336 through a strobe control signal 338C. As shown, a lens 331 is configured to focus optical scene information 352 onto image sensor 332 to be sampled. In an embodiment, image sensor 332 (or any other circuit within the camera module 330) advantageously controls detailed timing of the strobe unit 336 though the strobe control signal 338C to reduce inter-sample time between an image sampled with the strobe unit 336 enabled, and an image sampled with the strobe unit 336 disabled. For example, the image sensor 332 may sample an ambient image and subsequently sample a strobe image; during the process of sampling the ambient image and the strobe image, the image sensor 332 may enable the strobe unit 336 to emit strobe illumination 350 at any desired time offset between starting and ending exposure times between the ambient image and the strobe image. For example, the image sensor 332 may enable the strobe unit 336 less than one microsecond (or any desired time duration) after image sensor 332 completes an exposure time associated with sampling the ambient image. In an embodiment, the strobe unit 336 is enabled prior to sampling the strobe image. In other embodiments, the strobe image is sampled first and the ambient image is subsequently sampled, with the image sensor 332 disabling (e.g. turning off) the strobe unit 336 prior to starting (or completing) an exposure time for sampling the ambient image. In certain embodiments, the ambient image may be sampled with the strobe unit 336 enabled during a portion of a respective exposure time for the ambient image.

In certain embodiments, the strobe illumination 350 may be configured based on a desired one or more target points. For example, in one embodiment, the strobe illumination 350 may light up an object in the foreground, and depending on the length of exposure time, the strobe illumination 350 may also light up an object in the background of the image. In such an example, exposure metering at the one or more target points may determine, without limitation, exposure time, exposure sensitivity, strobe intensity, strobe duration, or a combination thereof. In one embodiment, once the strobe unit 336 is enabled, the image sensor 332 may then immediately begin exposing a strobe image. The image sensor 332 may directly control sampling operations, including enabling and disabling the strobe unit 336, associated with generating an image stack. The image stack may comprise at least one image sampled with the strobe unit 336 disabled, and at least one image sampled with the strobe unit 336 either enabled or disabled. In one embodiment, data comprising the image stack sampled by the image sensor 332 is transmitted via interconnect 334 to a camera interface unit 369 within processor complex 310. In some embodiments, the camera module 330 may include an image sensor controller (e.g., controller 333 of FIG. 3D), which may be configured to generate the strobe control signal 338 in conjunction with controlling operation of the image sensor 332.

In one embodiment, the camera module 330 may be configured to sample an image based on state information for strobe unit 336. The state information may include, without limitation, one or more strobe parameters (e.g. strobe intensity, strobe color, strobe time, etc.), for directing the strobe unit 336 to generate a specified intensity and/or color of the strobe illumination 350. In one embodiment, commands for configuring the state information associated with the strobe unit 336 may be transmitted through a strobe control signal 338A/338B, which may be monitored by the camera module 330 to detect when the strobe unit 336 is enabled. For example, in one embodiment, the camera module 330 may detect when the strobe unit 336 is enabled or disabled within a microsecond or less of the strobe unit 336 being enabled or disabled by the strobe control signal 338A/338B. To sample an image requiring strobe illumination, a camera interface unit 369 may enable the strobe unit 336 by sending an enable command through the strobe control signal 338A. The enable command may comprise a signal level transition, a data packet, a register write, or any other technically feasible transmission of a command. The camera module 330 may sense that the strobe unit 336 is enabled and then cause image sensor 332 to sample one or more images requiring strobe illumination while the strobe unit 336 is enabled. In such an implementation, the image sensor 332 may be configured to wait for an enable signal destined for the strobe unit 336 as a trigger signal to begin sampling a new exposure.

In one embodiment, camera interface unit 369 may transmit exposure parameters and commands to camera module 330 through interconnect 334. In certain embodiments, the camera interface unit 369 may be configured to directly control strobe unit 336 by transmitting control commands to the strobe unit 336 through strobe control signal 338. By directly controlling both the camera module 330 and the strobe unit 336, the camera interface unit 369 may cause the camera module 330 and the strobe unit 336 to perform their respective operations in precise time synchronization. In one embodiment, precise time synchronization may be less than five hundred microseconds of event timing error. Additionally, event timing error may be a difference in time from an intended event occurrence to the time of a corresponding actual event occurrence.

In another embodiment, camera interface unit 369 may be configured to accumulate statistics while receiving image data from camera module 330. In particular, the camera interface unit 369 may accumulate exposure statistics for a given image while receiving image data for the image through interconnect 334. Exposure statistics may include, without limitation, one or more of an intensity histogram, a count of overexposed pixels, a count of under-exposed pixels, an intensity-weighted sum of pixel intensity, spatial exposure for different regions, an absolute brightness estimate, a dynamic range estimate, or any combination thereof. Additionally, color statistics (e.g., for estimating scene white-balance) may be accumulated. The camera interface unit 369 may present the exposure statistics as memory-mapped storage locations within a physical or virtual address space defined by a processor, such as one or more of CPU cores 367, within processor complex 310. In one embodiment, exposure statistics reside in storage circuits that are mapped into a memory-mapped register space. In other embodiments, the exposure statistics are transmitted in conjunction with transmitting pixel data for a captured image. For example, the exposure statistics for a given image may be transmitted as in-line data, following transmission of pixel intensity data for the captured image. Exposure statistics may be calculated, stored, or cached within the camera interface unit 369. In other embodiments, an image sensor controller within camera module 330 may be configured to accumulate the exposure statistics and transmit the exposure statistics to processor complex 310, such as by way of camera interface unit 369. In one embodiment, the exposure statistics are accumulated within the camera module 330 and transmitted to the camera interface unit 369, either in conjunction with transmitting image data to the camera interface unit 369, or separately from transmitting image data.

In one embodiment, camera interface unit 369 may accumulate color statistics for estimating scene white-balance. Any technically feasible color statistics may be accumulated for estimating white balance, such as a sum of intensities for different color channels comprising red, green, and blue color channels. The sum of color channel intensities may then be used to perform a white-balance color correction on an associated image, according to a white-balance model such as a gray-world white-balance model. In other embodiments, curve-fitting statistics are accumulated for a linear or a quadratic curve fit used for implementing white-balance correction on an image. As with the exposure statistics, the color statistics may be presented as memory-mapped storage locations within processor complex 310. In one embodiment, the color statistics may be mapped in a memory-mapped register space, which may be accessed through interconnect 334. In other embodiments, the color statistics may be transmitted in conjunction with transmitting pixel data for a captured image. For example, in one embodiment, the color statistics for a given image may be transmitted as in-line data, following transmission of pixel intensity data for the image. Color statistics may be calculated, stored, or cached within the camera interface 369. In other embodiments, the image sensor controller within camera module 330 may be configured to accumulate the color statistics and transmit the color statistics to processor complex 310, such as by way of camera interface unit 369. In one embodiment, the color statistics may be accumulated within the camera module 330 and transmitted to the camera interface unit 369, either in conjunction with transmitting image data to the camera interface unit 369, or separately from transmitting image data.

In one embodiment, camera interface unit 369 may accumulate spatial color statistics for performing color-matching between or among images, such as between or among an ambient image and one or more images sampled with strobe illumination. As with the exposure statistics, the spatial color statistics may be presented as memory-mapped storage locations within processor complex 310. In one embodiment, the spatial color statistics are mapped in a memory-mapped register space. In another embodiment the camera module may be configured to accumulate the spatial color statistics, which may be accessed through interconnect 334. In other embodiments, the color statistics may be transmitted in conjunction with transmitting pixel data for a captured image. For example, in one embodiment, the color statistics for a given image may be transmitted as in-line data, following transmission of pixel intensity data for the image. Color statistics may be calculated, stored, or cached within the camera interface 369.

In one embodiment, camera module 330 may transmit strobe control signal 338C to strobe unit 336, enabling the strobe unit 336 to generate illumination while the camera module 330 is sampling an image. In another embodiment, camera module 330 may sample an image illuminated by strobe unit 336 upon receiving an indication signal from camera interface unit 369 that the strobe unit 336 is enabled. In yet another embodiment, camera module 330 may sample an image illuminated by strobe unit 336 upon detecting strobe illumination within a photographic scene via a rapid rise in scene illumination. In one embodiment, a rapid rise in scene illumination may include at least a rate of increasing intensity consistent with that of enabling strobe unit 336. In still yet another embodiment, camera module 330 may enable strobe unit 336 to generate strobe illumination while sampling one image, and disable the strobe unit 336 while sampling a different image.

In an embodiment, strobe unit 336 is configured to generate strobe illumination 350 having an arbitrary spatial intensity pattern. For example, the spatial intensity pattern may provide more intense strobe illumination 350 within a region located by a given point of interest in a photographic scene The strobe unit 336 may include a one-dimensional or two-dimensional array of illumination devices (e.g., LEDs) with substantially independent intensity control for each illumination device to facilitate generating arbitrary spatial patterns of illumination. Furthermore, a strobe lens (not shown) may be configured to direct light generated by a given illumination device into a predefined spatial region of the photographic scene. In an embodiment, the illumination devices may generate a mix of different wavelengths so that each predefined spatial region may be illuminated by different intensities of different wavelengths. In an embodiment, the different wavelengths include infrared wavelengths. In another embodiment, the different wavelengths include ultraviolet wavelengths. In yet another embodiment, the wavelengths include a combination of visible light and one or more of infrared and ultraviolet.

FIG. 3D illustrates camera module 330, in accordance with one embodiment. As an option, the camera module 330 may be implemented in the context of the details of any of the Figures disclosed herein. Of course, however, the camera module 330 may be implemented in any desired environment. Further, the aforementioned definitions may equally apply to the description below.

In one embodiment, the camera module 330 may be in communication with an application processor 335. The camera module 330 is shown to include image sensor 332 in communication with a controller 333. Further, the controller 333 is shown to be in communication with the application processor 335.

In one embodiment, the application processor 335 may reside outside of the camera module 330. As shown, the lens 331 may be configured to focus optical scene information to be sampled onto image sensor 332. The optical scene information sampled by the image sensor 332 may then be communicated, as an electrical representation, from the image sensor 332 to the controller 333 for at least one of subsequent processing and communication to the application processor 335. In another embodiment, the controller 333 may control storage of the optical scene information sampled by the image sensor 332, or storage of processed optical scene information.

In another embodiment, the controller 333 may enable a strobe unit to emit strobe illumination for a short time duration (e.g. less than ten milliseconds) after image sensor 332 completes an exposure time associated with sampling an ambient image. Further, the controller 333 may be configured to generate strobe control signal 338 in conjunction with controlling operation of the image sensor 332.

In one embodiment, the image sensor 332 may be a complementary metal oxide semiconductor (CMOS) sensor or a charge-coupled device (CCD) sensor. In another embodiment, the controller 333 and the image sensor 332 may be packaged together as an integrated system, multi-chip module, multi-chip stack, or integrated circuit. In yet another embodiment, the controller 333 and the image sensor 332 may comprise discrete packages. In one embodiment, the controller 333 may provide circuitry for receiving the electrical representation of optical scene information from the image sensor 332, processing the electrical representation, timing of various capture functions, and communication signaling associated with the application processor 335. Further, in another embodiment, the controller 333 may provide circuitry for control of one or more of exposure time, exposure sensitivity, shuttering, white balance, and gain adjustment. Processing of the electrical representation by the circuitry of the controller 333 may include one or more of gain application, amplification, and analog-to-digital conversion. After processing the electrical representation, the controller 333 may transmit corresponding digital pixel data, such as to the application processor 335.

In one embodiment, the application processor 335 may be implemented on processor complex 310 and at least one of volatile memory 318 and NV memory 316, or any other memory device and/or system. The application processor 335 may be previously configured for receiving and processing digital pixel data communicated from the camera module 330 to the application processor 335.

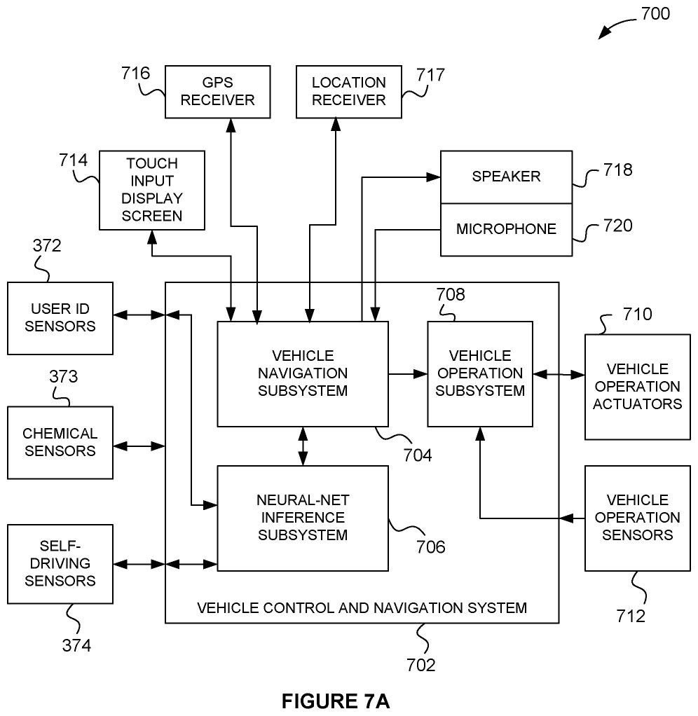

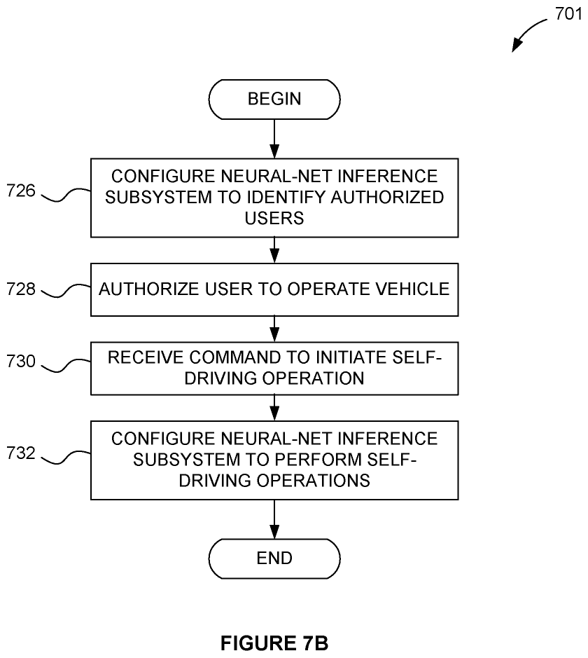

FIG. 3E illustrates a vehicle 370, in accordance with an embodiment. As shown, the vehicle 370 is configured to include user ID sensors 372(1)-372(3) and/or self-driving sensors 374(1)-374(3). The vehicle 370 may include an on-board processing system (not shown), such as system 700 of FIG. 7A.

The user ID sensors 372 may include, without limitation, any combination of digital camera modules and/or related subsystems such as camera modules 330 and digital photographic systems 300. The user ID sensors 372 may also include one or more audio input devices (e.g., microphone), one or more biometric input devices such as a thumb/finger print scanner, iris scanner (may include an illuminator), and so forth. In an embodiment, the user ID sensors 372 are configured to collect data for determining whether to admit a person into vehicle 370. For example, biometric data (an image of a face, a thumbprint, an iris pattern, etc.) may be collected and processed (e.g., by the on-board processing system) to identify whether a person seeking admission into the vehicle 370 is an authorized user and should be admitted.

The self-driving sensors 374 may be configured to provide environmental data for computing driving decisions. The self-driving sensors 374 may include, without limitation, one or more ultrasonic proximity scanners, one or more radar scanners (e.g., mm radar scanner), one or more Light Detection and Ranging (LiDAR) scanners, one or more lasers, one or more light pulse generators, one or more visual light cameras, one or more infrared cameras, one or more ultraviolet cameras, an accelerometer, an electronic gyro, an electronic compass, a positioning subsystem, and so forth. In an embodiment, self-driving sensors 374 include camera module 330, and one or more strobe units 336 positioned to illuminate towards the front of vehicle 370 (directionality according to headlights). Furthermore, the strobe unit 336 may be configured to generate infrared illumination comprising peaks at one or more infrared wavelengths and the image sensor 332 may include infrared pixel elements sensitive to the one or more infrared wavelengths.

In an embodiment, a self-driving sensor 374(1) may include one or more mm radar scanners, one or more LiDAR scanners, and/or a one or more digital cameras. Data from the self-driving sensor 374(1) may be used to surmise driving constraints on a road ahead; such constraints may include vehicles, objects on or near the road, a contour of the road, road markings, instantaneous vehicle velocities, and so forth. In an embodiment, the constraints are analyzed by the on-board processing system to compute vehicle operation decisions for the vehicle 370. Any technically feasible techniques may be performed to analyze the constraints and compute vehicle operation decisions.

In an embodiment, in the context of a manually-driven vehicle, data from one or more self-driving sensors 374 may be collected and processed to assess a specific driver's ability. The assessment may be performed over a very short interval (seconds to minutes) to determine whether the driver is presently driving safely. Additionally, the assessment may be performed over a longer interval (minutes to days, days to months). The assessment may be provided to the driver, an administrator (e.g., parent) or owner of the vehicle 370, an insurance carrier for the vehicle 370, and so forth. In certain embodiments, the data is processed by a machine learning subsystem to identify, and optionally quantize, specific driving metrics such as collective breaking rate, acceleration rate, breaking margin (tailgating or not), and/or metrics that may gather and summarize various metrics to calculate an overall driving safety metric for the driver.

In an embodiment, the on-board processing system of vehicle 370 is configured to record information about vehicle occupants in real time. In an embodiment the information may include real-time 3D models of occupants, video footage of the occupants, audio of the occupants (from vehicle cabin), and so forth. The information may be recorded in a circular buffer that stores a specified time interval (e.g., ten minutes). The recording in the circular buffer may be permanently recorded if an incident occurs, thereby providing a permanent record of vehicle occupant and vehicle activity immediately prior to the incident. Such an incident may include an accident, loss of vehicle control, mechanical failure, and so forth. In certain embodiments, the information also includes mechanical measurements of vehicle operation such as motor speed, vehicle speed, gas and brake pedal positions, steering wheel position, actual vehicle acceleration (e.g., force in three axes), and so forth. In certain embodiments, the information may be optionally released to an insurance company or appropriate other third parties. For example, a vehicle owner may choose to release the information for the purpose of having the insurance company assess the incident. Alternatively, the information may be aggregated with information from other incidents and used to generate overall actuarial data.

FIG. 3F illustrates a vehicle interior 380, in accordance with an embodiment. As shown, user ID sensors 372(4)-372(9) may be mounted in various locations of the vehicle interior 380, including within a dash board 376. In an embodiment, the vehicle interior 380 may include a charging cradle 378.

In an embodiment, the user ID sensors 372 include digital cameras configured to detect one or more of visible, infrared (e.g., short, medium, and/or long wave infrared), and/or ultraviolet wavelengths. Furthermore, the user ID sensors 372 may include an illuminations source, which may emit visible and/or invisible light. In some embodiments, one or more user ID sensor 372 comprises an iris and/or retina scanner. In an embodiment, user ID sensor 372(10) comprises a finger print and/or handprint scanner, which may be operable to identify a specific known user and/or authenticate the user as an authorized user of the vehicle. As described herein, user ID sensors 372 may gather data to authenticate one or more user within the vehicle 370. The authentication may serve to enable operation of the vehicle, limit operation of the vehicle, guide operation of the vehicle, and so forth.

In an embodiment, the charging cradle 378 is configured to, without limitation, receive, detect, communicate with, and/or charge a smartphone. In an embodiment, the smartphone is charged using wireless charging, such as resonant wireless (e.g., inductive) charging; furthermore, the charging cradle 378 may communicate with the smartphone using NFC techniques. In an embodiment, the charging cradle 378 communicates with the smartphone to receive an authentication credential the vehicle 370 may require to enable operation. For example, the smartphone may communicate one or more of an electronic code stored within the smartphone, a user identifier entered on the display screen of the smartphone, a fingerprint scan, a spoken phrase recorded and validated by the smartphone, and so forth. In various embodiments, authentication and validation of user input by the smartphone may be in addition to such input conveyed directly to the user ID sensors 372.

In various embodiments, image data and/or other data such as sensor data, vehicle data, biometric data, etc. is recorded at any or all steps of the disclosed methods. In particular, image data of faces presented for authentication may be recorded even if such recording is not explicitly recited (e.g., for brevity and clarity) in the disclosed methods. For example, image data of a presented face may be recorded at step 408 of method 400 even though such recording is not explicitly recited with respect to step 408. Furthermore, an ongoing record of any and all image data generated by various digital cameras mounted at vehicle 370 may be stored for later retrieval or review. In certain embodiments, said storage may be for a specified time (e.g., a day, a week, a month) before being deleted or archived away from the vehicle 370. Furthermore, an alert may be sent at any authentication failure point in any of the disclosed methods, even if sending such sending an alert is not explicitly recited (again, for brevity and clarity) in the disclosed methods. For example, an alert may be sent at step 410 even though such sending an alert is not explicitly recited with respect to step 410.

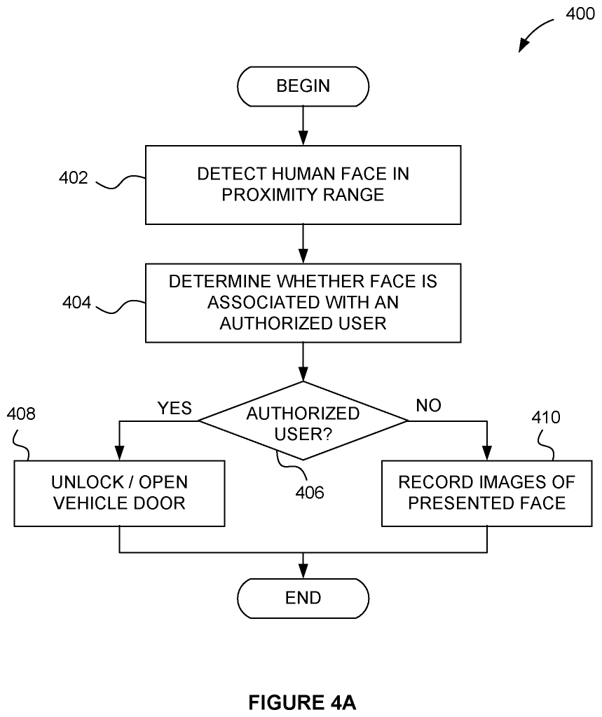

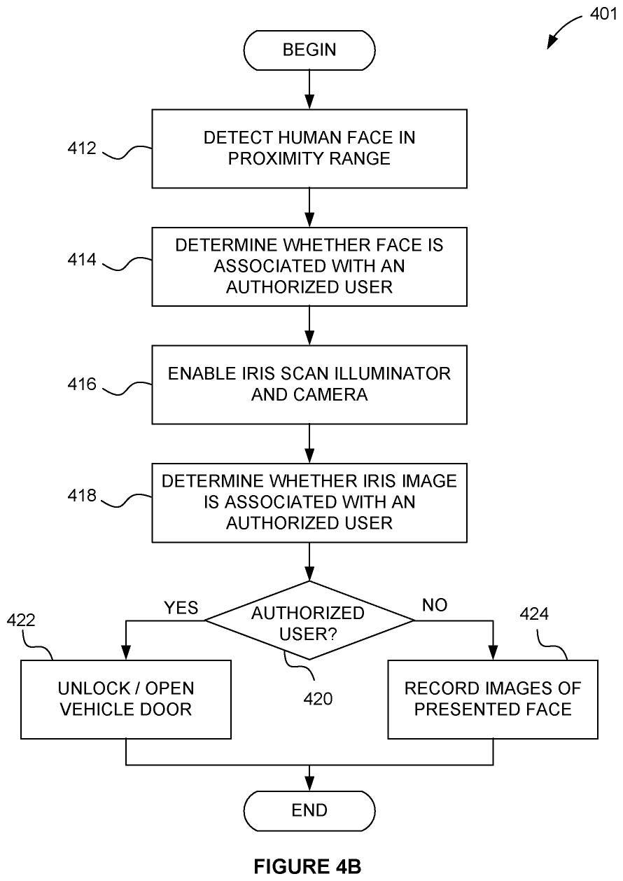

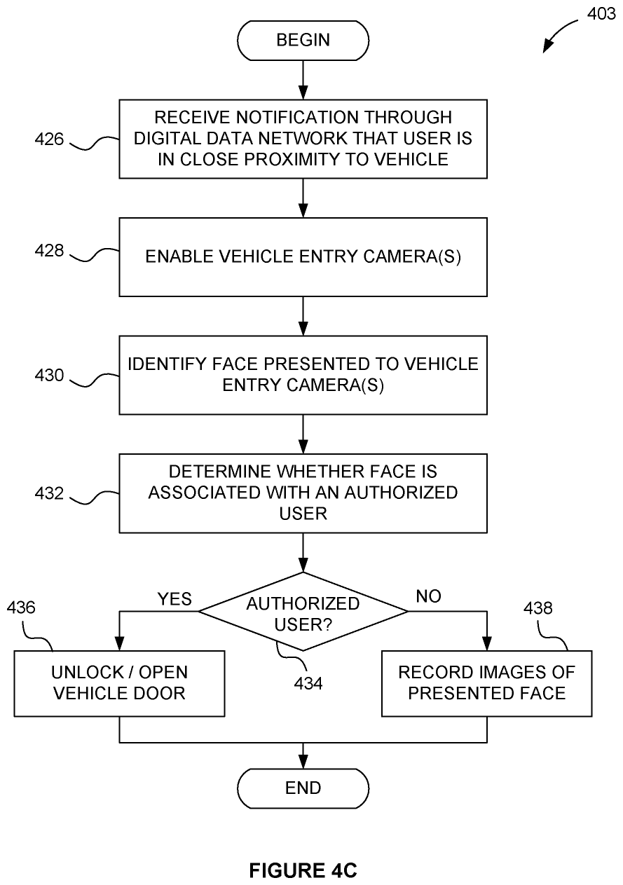

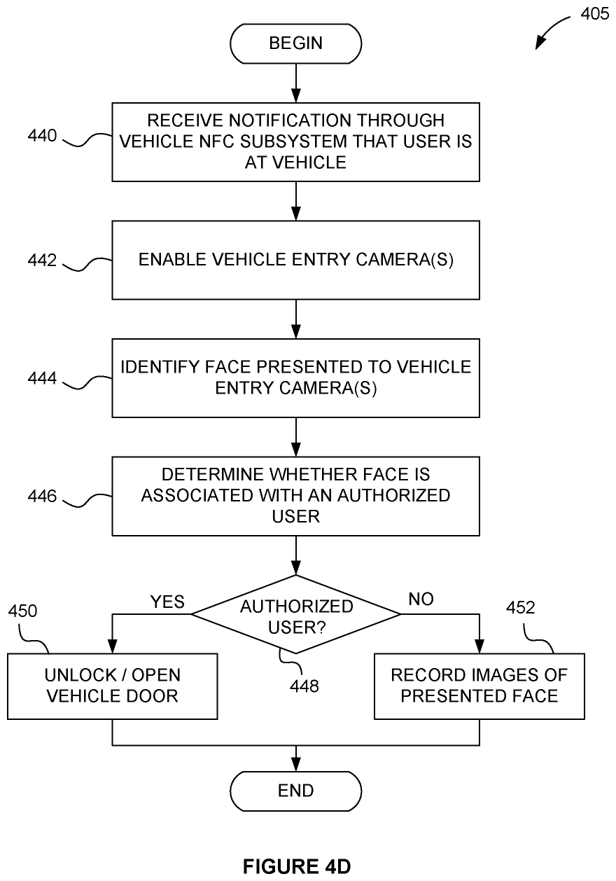

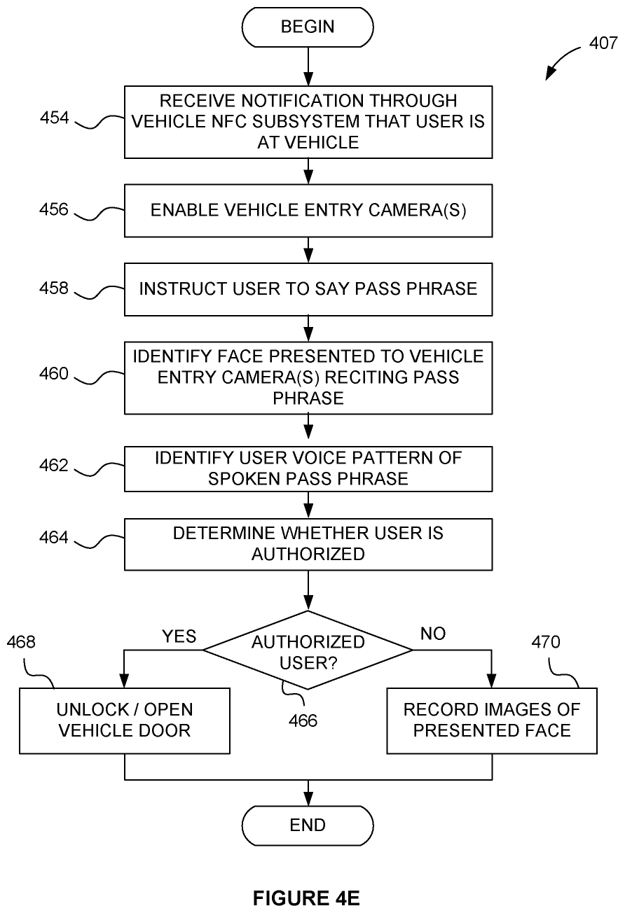

FIG. 4A illustrates a method 400 for admitting an authorized user into a vehicle based on visual metrics, in accordance with one embodiment. As an option, the method 400 may be implemented in the context of the details of any of the Figures disclosed herein. Of course, however, the method 400 may be implemented in any desired environment. Further, the aforementioned definitions may equally apply to the description below. It is to be appreciated that the method 400 (and subsequent methods pursuant to FIGS. 4B, 4C, 4D, and/or 4E) may be applied, at least in part, as operation 202 to admit an authorized user into the vehicle.

As shown, the method 400 begins with operation 402 where a human face is detected in proximity range. In one embodiment, the detection may occur based on a single capture of a user, or any number of captures. For example, the detection may include a real-time continuous detection in the form of a motion detection device mounted within the vehicle and configured to detect motion outside the vehicle, motion detection processing of captured video frames (e.g., from cameras mounted within the vehicle). In certain embodiments, an illuminator provides periodic illumination around the vehicle for detecting motion; furthermore, the periodic illumination may be generated within an invisible spectrum of light. In an embodiment, an infrared illumination source is positioned to illuminate a human face approaching a driver-side door of the vehicle. A camera may be mounted view and capture images of the human face. The images may then be analyzed (e.g., using machine learning recognition techniques) to determine whether the face is associated with a known and authorized user of the vehicle. It is to be appreciated that although a human face may be detected, any type of object may be used as the basis for detection (e.g. animal, drone, etc.).

In operation 404, the method 400 determines whether the face is associated with an authorized user. In one embodiment, the determination may be performed by a system that is integrated within the vehicle. For example, the detected face may be compared against models (or any technically feasible datasets) for authorized users stored within the vehicle. In one usage mode, a family may load images of family members that are permitted to use the vehicle. The loaded images may form the basis for the models and/or datasets that identify the authorized users. In one embodiment, it may be determined that the face of a user is not associated with a previously identified authorized user, and in response, a request may be sent (e.g., to an administrator of the vehicle, or to the owner of the vehicle) for authorization to use the vehicle. If authorization for the user is provided to the vehicle, then the user may be deemed to be an authorized user for the purposes of method 400. Such status as an authorized user may be permanent (e.g., for the duration of vehicle ownership) or limited (e.g., for a period of time, a number of rides, and so forth). In an embodiment, the request may be sent to a designated individual, who may provide authorization. In another embodiment, entry to the vehicle may be predicated on submitting (e.g., via key entry, a mobile application, or an optical code such as a QR code) a time-sensitive code, a one-time use code, or a pre-designated code given to the user. The code may be stored within the vehicle or the vehicle may transmit the submitted code to a data network-based service for authorization.

In decision 406, it is determined whether the user is authorized.

If the user is authorized, then per operation 408, the vehicle door is unlocked and/or opened. If the user is not authorized, then per operation 410, images of the presented face are recorded. In one embodiment, the images may be sent to another device (e.g. in real-time to an online server/service, an owner of the vehicle, etc.).

In one embodiment, if the user is not authorized (per decision 406), then one or more forensic and/or protective actions may be taken. For example, if multiple entry attempts are sought by an unauthorized user, then the vehicle may build a case file for the unauthorized user. If the unauthorized user continues to seek entry, then an audio and/or visual alarm may be triggered, one or more users may be notified (e.g. family member), the case file may be sent to a local security or police agency, and/or a warning may be displayed on a display device of the vehicle.

FIG. 4B illustrates a method 401 for admitting an authorized user into a vehicle based on visual and iris metrics, in accordance with one embodiment. As an option, the method 401 may be implemented in the context of the details of any of the Figures disclosed herein. Of course, however, the method 401 may be implemented in any desired environment. Further, the aforementioned definitions may equally apply to the description below.

As shown, method 401 begins with operation 412 where a human face is detected in proximity range. In one embodiment, the operation 412 may operate in a manner consistent with the operation 402. Additionally, in operation 414, it is determined whether the face is associated with an authorized user. In one embodiment, the operation 414 may operate in a manner consistent with the operation 404.

At operation 416, an iris scan illuminator and camera may be enabled, and at operation 418, it is determined whether the iris image is associated with an authorized user. Per decision 420, it is determined whether the user presenting for an iris scan is an authorized user. If yes, the vehicle door is unlocked and/or opened. See operation 422. If no, images of the presented face and iris are recorded. See operation 424. In one embodiment, operation 422 may operate in a manner consistent with the operation 408, and the operation 424 may operate in a manner consistent with the operation 410. Operation 424 may optionally record images of a presented iris.

In one embodiment, operation 416 and operation 418 may be alternative steps (based on the operation 412 and the operation 414). For example, per operation 414, determining whether the face is associated with an authorized user may include one or more minimum thresholds, such as an accuracy threshold (e.g., a confidence value that the user is an authorized user).

Additionally, in an alternative embodiment, determining whether the face is associated with an authorized user may include receiving input from a third party and asking the user to respond to queries about the input. For example, input may be received relating to social media data, and the authorizing step may include asking a targeted question based on social media data associated with the user (e.g. “you traveled to the Bahamas last June with who?”). A response may be provided to the system within a predetermined time period. Additionally, restrictions on use of a mobile device (or receiving auditory feedback from another device) may be applied. In this manner, the proximity range (per operation 412) may be used to not only detect that a user is present in front of a vehicle, but may also be used to detect that the user has remained in front of the vehicle with their attention focused on the system (as opposed to having attention in another device/user in order to answer a question). It is to be appreciated that any number of questions (based on input from a third party) may be used to satisfy a predetermined number of correct responses. In such an embodiment, if the predetermined number of correct responses is not achieved, then a second authentication may be used (such as the operation 412 and the operation 414) to determine whether an authorized user is present.

FIG. 4C illustrates a method 403 for admitting an authorized user into a vehicle based on visual metrics and RF/data network authentication, in accordance with one embodiment. As an option, the method 403 may be implemented in the context of the details of any of the Figures disclosed herein. Of course, however, the method 403 may be implemented in any desired environment. Further, the aforementioned definitions may equally apply to the description below.

As shown, the method 403 begins with receiving a notification through a digital data network that a user is in close proximity to a vehicle (e.g., less than ten meters). See operation 426. For example, a key fob, a smartphone, and/or any device in immediate possession of a user may be used to alert a vehicle that a user is approaching. In one embodiment, an authentication utility (e.g. fingerprint scan on mobile device) may be used to pre-authenticate the user, and such data (authenticated user data) may be sent to the vehicle prior to arriving at the vehicle.

In operation 428, vehicle entry camera(s) may be enabled, and in operation 430, a face presented to the vehicle entry camera(s) may be identified. In one embodiment, the data received per operation 426 may be used to more quickly identify the identity of the user. For example, the data received may provide an exact user profile to compare against an approaching user who then presents their face for identification. In this embodiment, therefore, rather than compare the face of the individual against an entire database of profiles, the identification can be made with respect to a dataset of just the user, which may speed up the comparison process such that the identification can occur more quickly and/or more accurately than a more general face search.

Per operation 432, it is determined whether the face is associated with an authorized user. In particular, per decision 434, it is determined whether an authorized user is present. If yes, the vehicle door is unlocked and/or opened. See operation 436. If no, images of the presented face are recorded. See operation 438. In one embodiment, operation 436 may operate in a manner consistent with the operation 408 (and/or any other similar operation disclosed herein), and the operation 438 may operate in a manner consistent with the operation 410 (and/or any other similar operation disclosed herein). Furthermore, operation 432 may operate in a manner consistent with operation 404 (and/or other similar operation disclosed herein).

FIG. 4D illustrates a method 405 for admitting an authorized user into a vehicle based on visual metrics and NFC authentication, in accordance with one embodiment. As an option, the method 405 may be implemented in the context of the details of any of the Figures disclosed herein. Of course, however, the method 405 may be implemented in any desired environment. Further, the aforementioned definitions may equally apply to the description below.

As shown, the method 405 begins at operation 440 with receiving a notification through a vehicle NFC subsystem that a user is at the vehicle. In one embodiment, an NFC device (e.g., smartphone, key fob, NFC credit card etc.) may be used to communicate with the vehicle's NFC subsystem. For example, the NFC device may operate in card-emulation mode and the vehicle's NFC subsystem may create an RF field to read the NFC device, which may emulate a particular card (e.g. debit card, credit card, personal identification card, etc.). In this manner, at close proximity to the vehicle, the vehicle's NFC subsystem may be used to initiate authentication of a user. In an alternative embodiment, a user smartphone may act as the NFC reader (e.g., generating an RF field) and the car may act as a tag and/or operate in card emulation mode, and the act of performing an authentication on the car provides the notification.

In one embodiment, authentication by the vehicle's NFC subsystem may be sufficient to determine an authorized user (per decision 448). However, cards and wallets may be stolen so secondary authentication may be provided by a face scan (per operation 444) In one embodiment, a vehicle may be configured to perform a two-step authentication, including a first step based on NFC (e.g., card-emulation) authentication, and a second step based on a face image capture.

In operation 442, vehicle entry camera(s) may be enabled, and in operation 444, a face presented to the vehicle entry camera(s) may be identified.

Per operation 446, it is determined whether the face is associated with an authorized user. In particular, per decision 448, it is determined whether an authorized user is present. If yes, the vehicle door is unlocked and/or opened. See operation 450. If no, images of the presented face are recorded. See operation 452. In one embodiment, operation 450 may operate in a manner consistent with the operation 408 (and/or any other similar operation disclosed herein), and the operation 452 may operate in a manner consistent with the operation 410 (and/or any other similar operation disclosed herein).

FIG. 4E illustrates a method 407 for admitting an authorized user into a vehicle based on visual, voice, and/or NFC metrics, in accordance with one embodiment. As an option, the method 407 may be implemented in the context of the details of any of the Figures disclosed herein. Of course, however, the method 407 may be implemented in any desired environment. Further, the aforementioned definitions may equally apply to the description below.

As shown, the method 407 begins at operation 454 with receiving a notification through a vehicle NFC subsystem that a user is at the vehicle. In one embodiment, operation 454 may operate in a manner consistent with operation 440. In operation 456, vehicle entry camera(s) may be enabled. Still frames and/or video footage of individuals in view of the vehicle entry camera(s) may be analyzed and a user (or potentially multiple users) may be tentatively identified according to their facial features. In operation 458, the user is instructed to say a pass phrase (“please say today's pass phrase”). In an embodiment, a certain pass phrase may be associated with the tentatively identified user, and the user instructed to say the pass phrase. Alternatively, the pass phrase may be generic (“say what day it is today”), randomly generated, uniquely assigned (e.g., an assigned unique pass phrase) or a combination thereof. In an embodiment, the user is sent an assigned pass phrase as a text message (or as a mobile app custom message).

In operation 460, identification is performed on a face presented by the user to the vehicle entry camera(s) while reciting the pass phrase. In an embodiment, audio recorded while the user recites the pass phrase is analyzed to determine whether the user's voice matches the user's face, based on models of the user's voice pattern and facial model. See operation 462. At operation 464, it is determined whether the user is an authorized user. In an embodiment, video of the user reciting the pass phrase may be analyzed to improve accuracy of identifying the user. Any technically feasible techniques may be applied or combined for identifying an authorized user using video in combination with audio without departing the scope and spirit of various embodiments.

At decision 466, it is determined whether an authorized user is present. If yes, the vehicle door is unlocked and/or opened. See operation 468. If no, images of the presented face are recorded. See operation 470. In one embodiment, operation 468 may operate in a manner consistent with the operation 408 (and/or any other similar operation disclosed herein), and the operation 470 may operate in a manner consistent with the operation 410 (and/or any other similar operation disclosed herein).

While various embodiments are discussed in the context of NFC communication, any other technically feasible wireless communication technique (RF, optical, acoustic, and so forth) may be implemented without departing the scope and spirit of the present disclosure.

In an embodiment, the user may recite one of two different pass phrases. Each one of the two pass phrases may allow admission (e.g., unlock/open a door). The first pass phrase may be recited for normal circumstances, while the second pass phrase may be recited in distressed circumstances. When the second pass phrase is received by the vehicle, the vehicle transmits an alert (e.g., at or prior to step 468). The alert may be transmitted to a vehicle authority and/or a law enforcement authority indicating a distressed or panic scenario is underway. For example, under normal circumstances, the user may recite a pass phrase “I am the storm”; but under distressed circumstances (e.g., the user is being coerced or hijacked), the user may recite the pass phrase “Dad, thank you for buying me this car”, causing the vehicle to transmit an alert to law enforcement. Furthermore, the vehicle may begin periodically transmitting geo-location information/coordinates to law enforcement. In distressed circumstances, a hijacker will not be able to distinguish between valid pass phrases, allowing the vehicle to participate in potentially protecting occupant(s).

In alternative embodiments, techniques disclosed herein may be performed to control admission for authorized persons into a mass-transit vehicle (e.g., a train, a bus), a building facility, a warehouse, an office building, a floor in a multi-level building, an elevator, an individual room, a fenced space, a compound, or any passage through a threshold. Furthermore, in other alternative embodiments, techniques disclosed herein may be performed to control use of equipment and non-automotive vehicles, such as a mass-transit vehicle, a military vehicle (troop carrier, tank, etc.), an aircraft, a forklift, a powered exoskeleton, a drone (e.g., at a control station for the drone), and so forth.

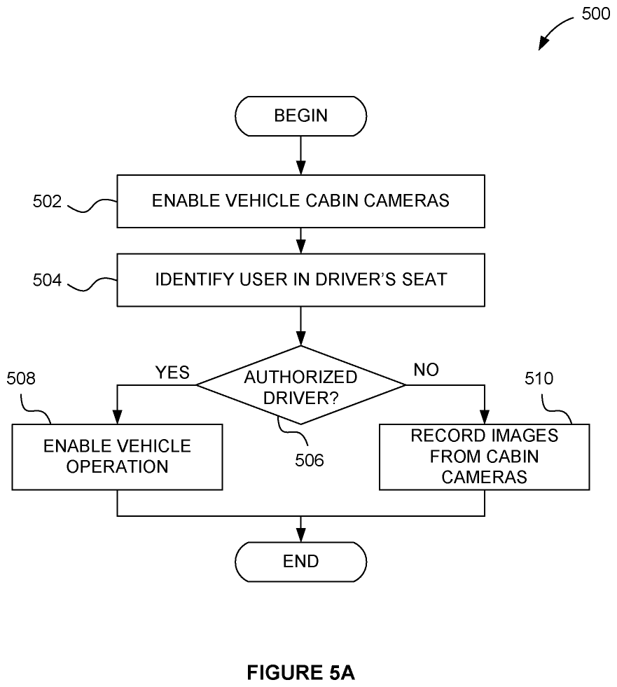

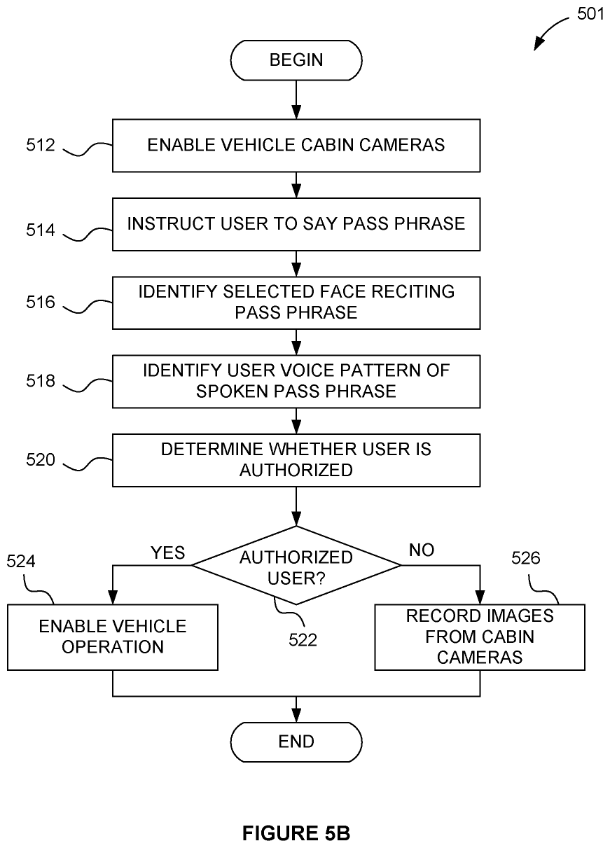

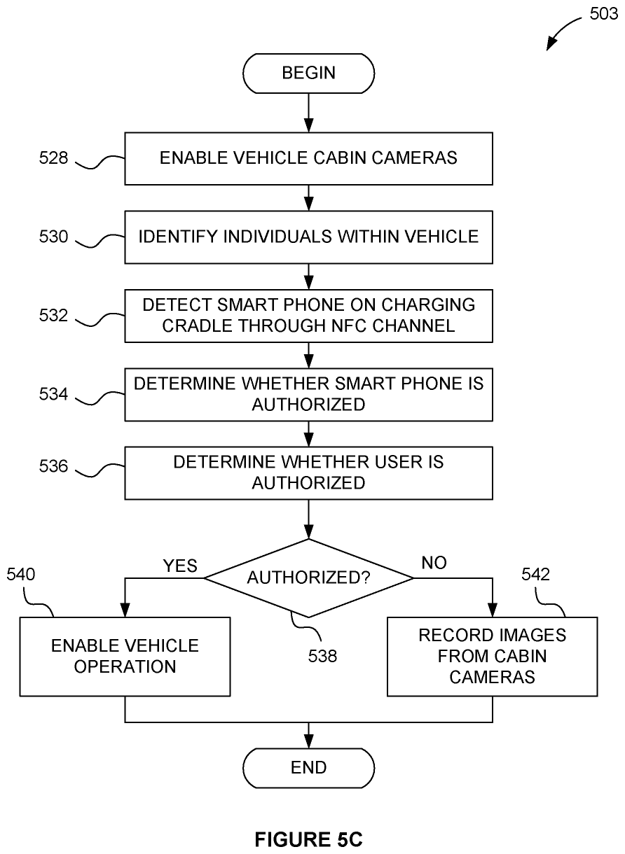

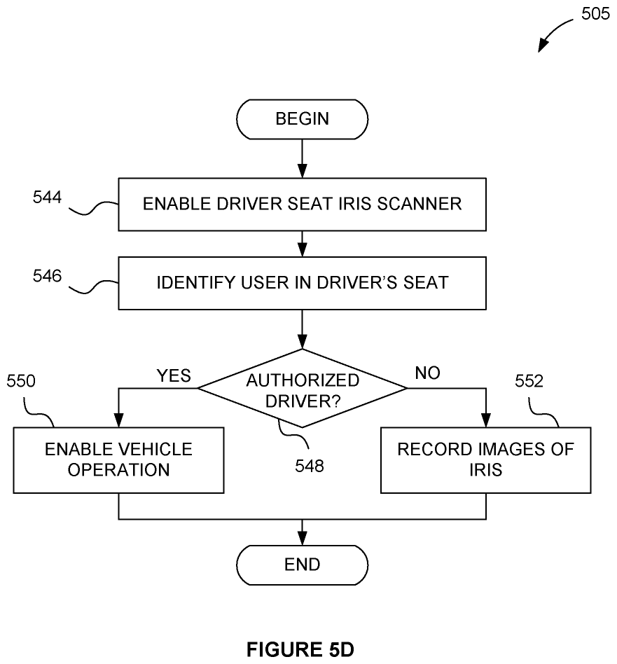

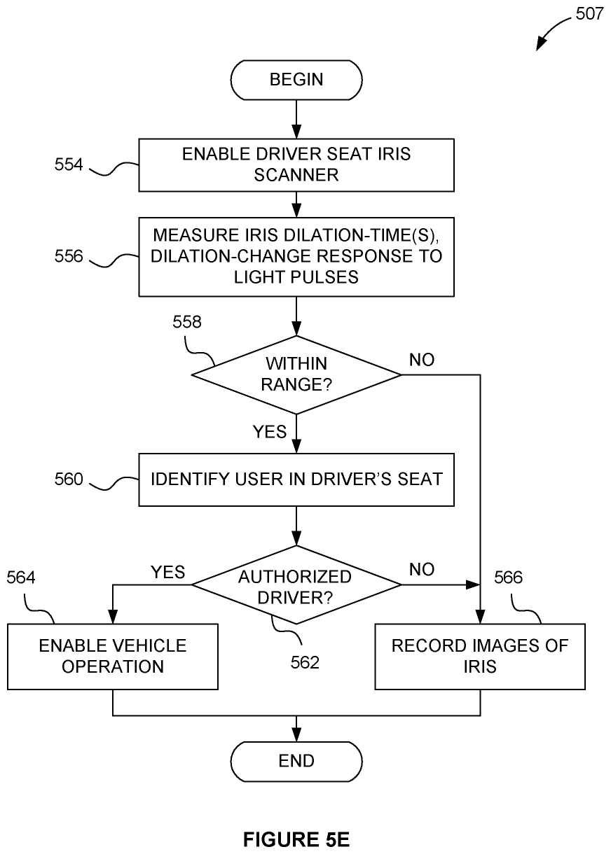

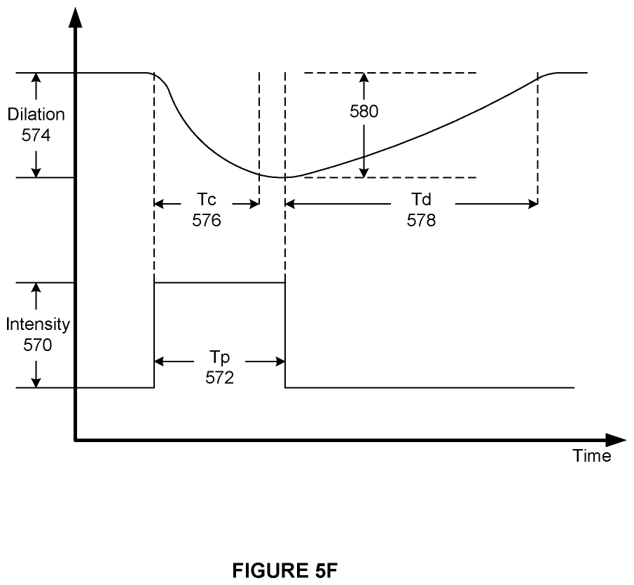

FIG. 5A illustrates a method 500 for verifying use of vehicle by authorized user based on visual metrics, in accordance with one embodiment. As an option, the method 500 may be implemented in the context of the details of any of the Figures disclosed herein. Of course, however, the method 500 may be implemented in any desired environment. Further, the aforementioned definitions may equally apply to the description below.

As shown, method 500 begins with enabling one or more vehicle cabin cameras. See operation 502. It is to be appreciated that the method 500 (and subsequent methods pursuant to FIGS. 5B, 5C, 5D, and/or 5E) may be applied after operation 202 has been satisfied, namely that an authorized user is admitted into the vehicle.

In response to enabling the vehicle cabin cameras, a user is identified in the driver's seat. See operation 504. In one embodiment, the identification may occur based on facial recognition systems, biometric feedback (e.g. fingerprint, iris scan, etc.), auditory response, etc.

It is then determined whether the individual is an authorized driver. See decision 506. If yes, the vehicle operation is enabled. See operation 508. If not, images are recorded from the cabin cameras. See operation 510. In one embodiment, the recorded images may be saved in a storage database on the vehicle, in a cloud-based repository, etc. Further, the recorded images may be sent to an individual (vehicle owner, vehicle administrator, etc.), and one or more actions may be taken in response. For example, the vehicle owner may enable vehicle operation (even when the driver is not known to be authorized by the vehicle). In this manner, a report of events occurring in the vehicle may be sent to the owner. It is to be appreciated additionally that such reports (and/or images) may be sent, in one embodiment, even if the driver is authorized (per decision 506).

FIG. 5B illustrates a method 501 for verifying use of vehicle by authorized user based on visual and voice metrics, in accordance with one embodiment. As an option, the method 501 may be implemented in the context of the details of any of the Figures disclosed herein. Of course, however, the method 501 may be implemented in any desired environment. Further, the aforementioned definitions may equally apply to the description below.

As shown, method 501 begins with enabling one or more vehicle cabin cameras. See operation 512. Next, a user is instructed to say a pass phrase. See operation 514. In various embodiments, the pass phrase may be one or more predetermined words or phrases, a response to a question (e.g. based on social media data, etc.), etc.

Additionally, a selected face reciting the pass phrase is identified. See operation 516. For example, in one embodiment, several individuals may be inside the vehicle, and the face associated with an individual reciting the pass phrase may then be selected and identified. If only one individual is present in the vehicle, then the face of the one individual may be used for both the pass phrase and the identification.

A user voice pattern of the spoken pass phrase is identified. See operation 518. In one embodiment, any voice analysis or voice recognition system may be used to determine a voice pattern. For example, a pass phrase may be analyzed, filtered, and/or presented to a machine learning inference engine in order to verify the voice pattern is associated with a specific individual (e.g., an authorized user).

In one embodiment, a user may be a driver in a conventional car (with method 501 performed to allow the user to drive), and/or may be any passenger in a self-driving vehicle. Additionally, the identification of the selected face may be based on a location within the vehicle (e.g. driver seat).

In another embodiment, the pass phrase may be used to create an audio signature, and/or voice code. The audio signature may be used by itself or in combination with other signatures (e.g. facial signature, data response signature, etc.) to authenticate an individual (as a driver of a conventional car or a passenger in a self-driving vehicle). Further, spatial coordinates of an audio source within the vehicle may be determined and used to authenticate that a pass phrase is being recited by a particular user within the vehicle. For example, the vehicle may be configured to require the driver of the vehicle to provide a pass phrase. The spatial coordinates of the driver's head/mouth may be used as the basis for authentication such that any other phrase spoken by another individual at another coordinate within the vehicle may be discarded. In an alternative embodiment, a passenger (e.g., parent) may be permitted to provide the audio pass phrase with a driver having restricted authorization (child) in the driver seat.

It is determined whether the user is authorized. See operation 520. Next, it is determined whether the individual is an authorized driver. See decision 522. If yes, the vehicle operation is enabled. See operation 524. If not, images are recorded from the cabin cameras. See operation 526. In one embodiment, the operation 524 may function in a manner similar or the same as the operation 508. Additionally, the operation 526 may function in a manner similar or the same as the operation 510.

FIG. 5C illustrates a method 503 for verifying use of vehicle by authorized user based on visual metrics and NFC authentication, in accordance with one embodiment. As an option, the method 503 may be implemented in the context of the details of any of the Figures disclosed herein. Of course, however, the method 503 may be implemented in any desired environment. Further, the aforementioned definitions may equally apply to the description below.

As shown, method 503 begins with enabling one or more vehicle cabin cameras. See operation 528. Next, individuals within the vehicle are identified. See operation 530. In one embodiment, the vehicle may be a personal vehicle, and restrictions on who may drive the vehicle may be applied. In such an embodiment, the vehicle may allow only authorized users to drive (or otherwise operate, such as to direct a self-driving vehicle). In another embodiment, the vehicle may be a self-driving vehicle operated by a ride-sharing service (e.g. Uber, Lyft, etc.), and restrictions on who may ride in the vehicle may be applied (e.g. to the individual that requested the service, etc.). As such, individuals may be identified within the vehicle and individual identity may allow or restrict vehicle operation.

A smart phone on a charging cradle (or other apparatus for holding a smartphone) may be detected through an NFC channel. See operation 532. In another embodiment, any limited-proximity system (such as bluetooth low energy) may be used to detect the presence of a smart phone. In one embodiment, if a single user is present in the vehicle, other smart phone detection systems may be implemented (e.g. WiFi, Bluetooth, etc.), whereas if multiple individuals are present in the vehicle, a charging cradle in combination with an NFC channel (or again, any limited-proximity system) may be used to detect a device associated with the user.

It is determined whether the smart phone is authorized. See operation 534. For example, the detection of the smart phone using an NFC channel (per operation 532) may be used as the basis for authentication of the smart phone (such as through a card-emulation mode verification process). In other embodiments, authorization may include a verification key, a one-time use password, a proximity to a secondary device (e.g. key fob), etc. In an embodiment, the smartphone may separately authenticate a user (e.g., enter a code, thumbprint scan, face scan, or any combination thereof) prior to fully authenticating with the vehicle. The smartphone may share authentication data (e.g., a code entered by the user) or simply allow the vehicle to proceed with authenticating the smartphone (e.g., by enabling card emulation after separately authenticating the user).

In other embodiments, a plurality of triggers may be used to authenticate a user, including but not limited to facial recognition, audible pass phrase, device detection (such as a smart phone), proximity to other device(s) and/or user(s), biometric features (e.g. iris scan, fingerprint, etc.). For example, a minimum of two triggers may need to be satisfied in order to authenticate and authorize a user.

It is determined whether the user is authorized. See operation 536. Next, it is determined whether the individual is authorized (e.g., to drive or direct the operation of a self-driving vehicle). See decision 538. If yes, the vehicle operation is enabled. See operation 540. If not, images are recorded from the cabin cameras. See operation 542. In one embodiment, the operation 540 may function in a manner similar or the same as the operation 508 (and/or any other similar type operation). Additionally, the operation 542 may function in a manner similar or the same as the operation 510 (and/or any other similar type operation).

FIG. 5D illustrates a method 505 for verifying use of vehicle by authorized user based on iris scan metrics, in accordance with one embodiment. As an option, the method 505 may be implemented in the context of the details of any of the Figures disclosed herein. Of course, however, the method 505 may be implemented in any desired environment. Further, the aforementioned definitions may equally apply to the description below.

As shown, the method 505 begins with enabling a driver seat iris scanner. See operation 544. In an embodiment, the driver seat iris scanner is positioned within the driver instrument console. In another embodiment, the driver seat iris scanner is positioned at a rear view mirror. In other embodiments, the driver seat iris scanner is positioned in any technically feasible location within or outside the vehicle that allows a clear, directional observation point to perform an iris scan of an individual seated in the driver seat. The driver seat iris scanner may include one or more cameras for performing the iris scan and a visible illuminated reference point (e.g., an LED) to assist a user in precisely fixing their gaze while their iris is scanned. The driver seat iris scanner may also include a non-visible illumination source directed at the iris being scanned.

Additionally, in response, a user is identified in the driver's seat. See operation 546. In one embodiment, the operation 544 may function in a manner similar to or the same as the operation 416. It is to be appreciated however that the operation 544 may be implemented for purposes of enabling vehicle operation.

Per decision 548, it is determined whether the user is an authorized user. If yes, the vehicle operation is enabled. See operation 550. If no, images of the iris are recorded. See operation 552.

FIG. 5E illustrates a method 507 for verifying use of vehicle by authorized user based on a response during an iris scan, in accordance with one embodiment. As an option, the method 507 may be implemented in the context of the details of any of the Figures disclosed herein. Of course, however, the method 507 may be implemented in any desired environment. Further, the aforementioned definitions may equally apply to the description below.

As shown, the method 507 begins with enabling a driver seat iris scanner. See operation 554. An iris dilation-time(s) response and a dilation-change response are measured in response to light pulses. See operation 556. In an embodiment, the light pulses are directed at a user's eye (or eyes). In another embodiment, the light pulses comprise ambient illumination within a vehicle cabin. For example, an iris dilation-time may indicate a first time that a user's iris requires to become fully dilated or, separately, a second time to become fully contracted. In this context, fully dilated refers to a maximum iris opening size for ambient lighting and fully contracted refers to a minimum iris opening size under light pulse illumination. In like manner, the dilation-change may indicate a relative dilation change in response to light pulses.

It is determined, per decision 558, whether the dilation-time and/or the dilation-change response are within range. If no, then images are recorded of the iris per operation 566. If yes, the user in determined to be competent to drive (e.g., sober and not drowsy) and the method 507 proceeds to step 560. At step 560, the driver's seat is identified.

Per decision 562, it is determined whether the user is an authorized user. If yes, the vehicle operation is enabled. See operation 564. If no, images of the iris are recorded. See operation 566.

In various embodiments, the measurement of the iris (including but not limited to the iris dilation-time(s) and/or the dilation-change response) may include a detection of rapid eye movement, and/or any other eye movement. The movement, dilation-time, and/or responses to the light pulse(s) may be compared against an individualized and normalized signature. For example, a dataset may be collected based on a plurality of previously collected data (e.g. movement, dilation-time, response). In this manner, the measurement per the operation 556 may be compared against a personalized dataset of eye-related data of the user.

In another embodiment, the movement, dilation-time(s), and/or responses to the light pulse(s) may be compared against a general eye signature. For example, a dataset based on the general population with general thresholds (e.g. minimum sobriety thresholds) may be applied to the iris dilation-time(s) and/or dilation-change response gathered per the operation 556. In other embodiments, additional and/or alternative techniques may be performed to determine whether an individual is either impaired or competent to drive.

FIG. 5F illustrates iris dilation in response to a pulse of light, in accordance with an embodiment. As shown, a dilation value 574 is plotted against time. The dilation value 574 may represent a pupil opening size of an eye of a user, and the user may be an occupant or driver of vehicle 370. Furthermore, an intensity value 570 is also plotted against time along the same scale as the dilation value 574. A light pulse of duration Tp 572 is directed to the eye, causing a contraction of the pupil of the eye. The contraction may be characterized by a contraction time Tc 576 and a subsequent dilation may be characterized by a dilation time Td 578. Both the contraction and dilation are limited to a certain size, the difference being characterized by dilation difference 580. In various embodiments, an occupant of vehicle 370 has a dilation response performed to measure metrics Tc 576, Td 578, and difference 580. Based on the metrics, the user may be determined to be in a sufficiently good condition to drive and vehicle operation is enabled. If the user is determined to not be in a sufficiently good condition to drive, vehicle operation may be disabled. In one usage model, an intoxicated or excessively tired user will have one or more metrics exceed a certain threshold and will be determined to not be in a sufficiently good condition to drive. In an embodiment, relevant thresholds may be determined by previous measurements taken on the user, or general thresholds may be applied as determined by large populations of individuals.

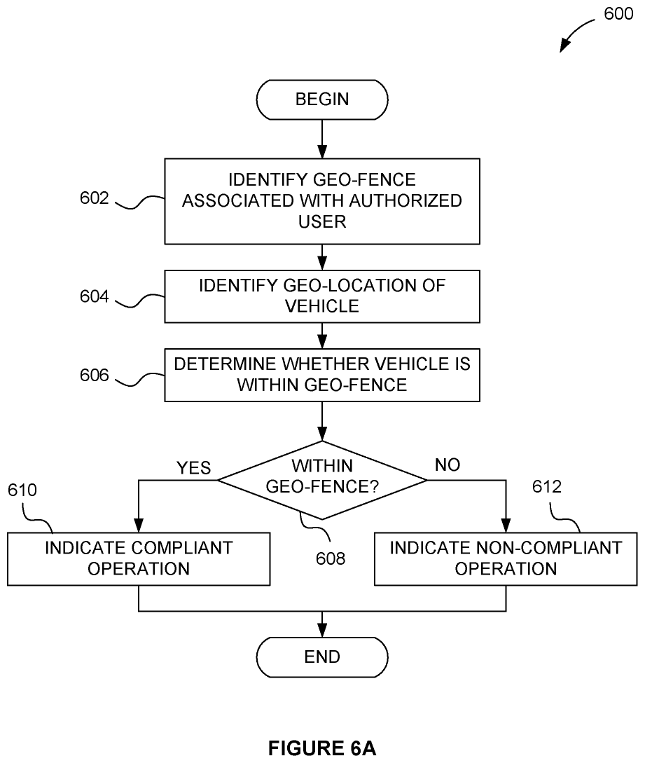

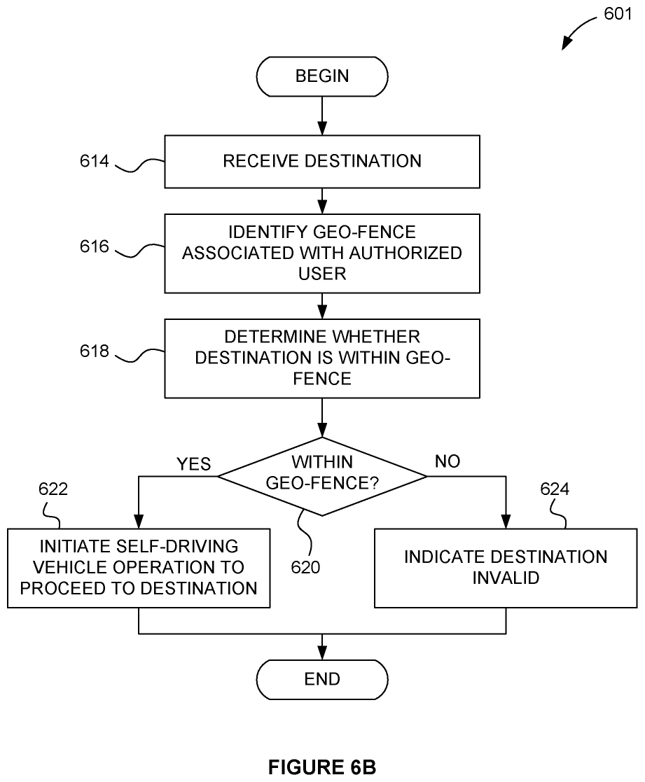

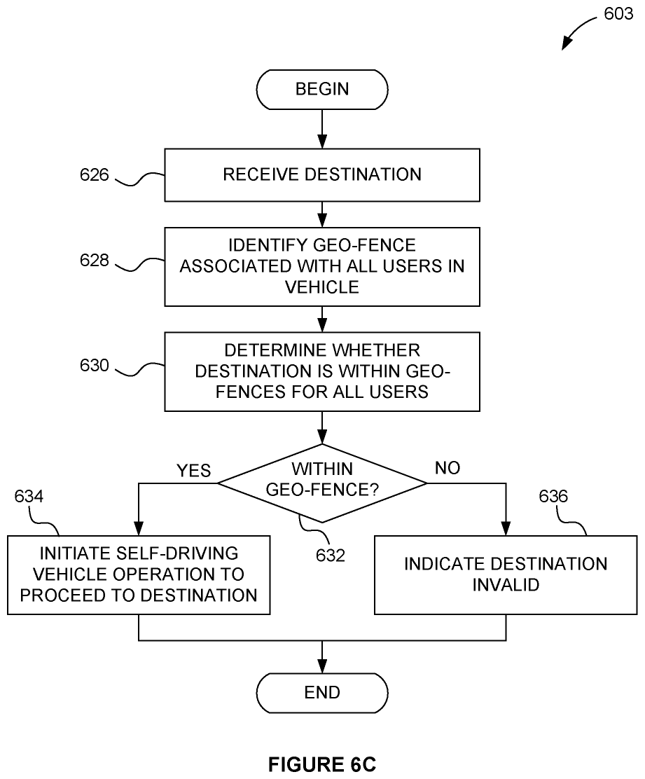

FIG. 6A illustrates a method 600 for enabling operation of a vehicle based on a user driving within a geo-fence, in accordance with one embodiment. As an option, the method 600 may be implemented in the context of the details of any of the Figures disclosed herein. Of course, however, the method 600 may be implemented in any desired environment. Further, the aforementioned definitions may equally apply to the description below.

As shown, method 600 begins with identifying a geo-fence associated with the authorized user. See operation 602. It is to be appreciated that the method 600 (and subsequent methods pursuant to FIGS. 6B, and/or 6C) may be applied after operation 204 has been satisfied, namely that use of a vehicle by an authorized user is verified.

In one embodiment, the geo-fence may be predetermined, e.g., by a user, parent, owner, operator of the vehicle, etc. For example, the geo-fence may be dynamically applied based on the authorized user (e.g. child with restrictive use, parent without restrictive use, etc.). Additionally, the restrictive use may be restricting vehicle use to within a geographic area (i.e. a geo-fence). In another embodiment, the geo-fence may be automatically established based on a route. For example, a list of pre-approved destinations may be selected by the authorized user, and a predetermined buffer geo-fence (e.g. a 2 block radius around the route selected) may be applied to the route. In various embodiments, the geo-fence may be adapted in real-time based on road conditions. For example, a temporary road closure or accident in a location blocking a path to an authorized destination may require the geo-fence to expand and include additional paths to the destination.

A geo-location of the vehicle is identified. See operation 604. Additionally, it is determined whether the vehicle is within the geo-fence. See operation 606. Per decision 608, if the vehicle is within the geo-fence, then per operation 610, a compliant operation is indicated. If the vehicle is not within the geo-fence, then per operation 612, a non-compliant operation is indicated. In one embodiment, the indication of the non-compliant operation may be sent to a third party (e.g. owner of the vehicle, cloud-based service, storage database, etc.). Furthermore, one or more actions may be taken in response to the non-compliant indication, including but not limited to, a procedure may be executed to secure permission to proceed forward with the non-compliant operation and/or a subset of the non-compliant operation. The procedure may include alerting a vehicle administrator (parent, owner, etc.) and receiving permission to proceed from the vehicle administrator. The process of alerting and receiving permission may be performed using a text message exchange with the vehicle administrator, an exchange with a custom mobile phone app possessed by the vehicle administrator, and so forth. The alerting process may include a video conference session through the custom mobile phone app in which a permission certificate is transmitted back to the vehicle upon a grant of permission from the mobile phone app.

In other embodiments, rather than determine whether the vehicle is within a geo-fence (per operation 606), it may be determined whether the vehicle is compliant with one or more conditions, including but not limited to, time-frame, speed limit, road conditions, selected route, occupants in the car, etc. If non-compliance with the one or more conditions is determined, then one or more limitations may be applied, including a limit on acceleration, a limit on speed, a modification (or limitation) to the route, etc. Further, compliance with the one or more conditions may include contextual awareness of traffic conditions. For example, a compliant use of the vehicle may include taking a predetermined route. However, an accident may have caused a 30 min (or any arbitrary time threshold) delay for such predetermined route. In view of such, a non-compliant operation may be automatically approved to minimize an amount of time to go from a current position to a selected destination. In another embodiment, the non-compliant operation may require an approval from the vehicle administrator (e.g. such as an owner or parent), an emergency services agent such as an emergency services technician, or a law enforcement agent.

Further, the approval of a non-compliant operation may include reducing a number of non-compliant operations. For example, an accident may have caused a 30 min (or any specific time) delay for such predetermined route which, in turn, may cause non-compliance with an imposed curfew for the authorized user. As such, determining whether the vehicle is compliant with the one or more condition may include determining a number of non-compliant faults (where one non-compliance fault may be caused by another non-compliance fault), and selecting an operation that minimizes the overall non-compliant faults.

In one embodiment, a hierarchy of rules and/or conditions may be stored on the vehicle such that determining whether the vehicle is compliant with the one or more conditions may be based on ranking the faults against the hierarchy of rules and/or conditions. In certain embodiments, a display within the vehicle (e.g., within the driver instrument console) may indicate compliance and/or faults associated with compliance. In an embodiment, a map may be displayed with the vehicle geo-location and geo-fences. In another embodiment, a speed limit is displayed along with a maximum speed limit, said maximum speed limit may be determined by a prevailing speed limit for the road and/or a maximum user speed limit. The maximum speed limit may be determined by a combination of a road speed limit in combination with estimated road/weather conditions. For example, a particular road may have a posted speed limit of 65 MPH, but recent heavy rain is known to have caused flooding on the road; in such an example the maximum speed may be reduced to 40 MPH to reduce the likelihood of an inexperienced driver having an accident.

In an embodiment, a self-driving vehicle may be configured to return occupants home (or to a designated emergency location) if road conditions deteriorate. Furthermore, the vehicle may notify a designated emergency contact (e.g., a parent) should road conditions be deemed sufficiently deteriorated to indicate an emergency return to home (or designated emergency location). In certain embodiments, the designated emergency location may be updated to a different location, according to prevailing conditions. In an embodiment, the vehicle may determine prevailing conditions are unsafe and the vehicle may stop; furthermore, the vehicle may generate an alert requesting assistance from first responders and/or other authorities.

FIG. 6B illustrates a method 601 for enabling operation of a vehicle based on one user and a self-driving vehicle operating within a geo-fence, in accordance with one embodiment. As an option, the method 601 may be implemented in the context of the details of any of the Figures disclosed herein. Of course, however, the method 601 may be implemented in any desired environment. Further, the aforementioned definitions may equally apply to the description below.

As shown, the method 601 begins with receiving a destination. See operation 614. In one embodiment, the method 601 may operate within the context of a self-driving vehicle. In one embodiment, the destination may be received at the vehicle (e.g. via a touch input display attached to the vehicle, via a microphone attached to the vehicle, etc.), and/or may be received at the vehicle from a device associated with the user. For example, a user may select a destination on a smart phone, which may in turn send the destination to the vehicle (e.g., directly to the vehicle, through a cloud-based vehicle operation service, etc.) for implementation. Additionally, in another embodiment, if the user is a child, the child may have a key fob (or some other device such as a smartphone or smart card) with a pre-approved location (e.g. default location home, etc.) that is sent automatically to the vehicle for implementation. In certain embodiments, the destination is predetermined, with a passenger being allowed to add one or more stops within the geo-fence along a path to the destination. For example, a passenger may decide to stop for a coffee along the way to the destination.

A geo-fence associated with an authorized user is identified. See operation 616. Additionally, it is determined whether the destination is within the geo-fence. See operation 618. If the destination is within the geo-fence (per decision 620), then the self-driving vehicle initiates operation to proceed to the destination. See operation 622. If the destination is not within the geo-fence, then the destination is indicated as being invalid. See operation 624.

As an example, a destination may be provided that a user of the vehicle desires to go to Starbucks. It may be determined that the Starbucks destination is outside of the geo-fence. As such, the destination may be indicated as being invalid. In response, the user may request permission or an override of the geo-fence. In one embodiment, a request may be sent to a user (e.g. a parent, an owner of the vehicle, etc.) who may provide an override of the geo-fence. Any technically feasible technique may be performed to provide the override (e.g., alerting parent/vehicle operator and receiving permission).

FIG. 6C illustrates a method 603 for enabling operation of a vehicle based on multiple users and a self-driving vehicle operating within a geo-fence, in accordance with one embodiment. As an option, the method 603 may be implemented in the context of the details of any of the Figures disclosed herein. Of course, however, the method 603 may be implemented in any desired environment. Further, the aforementioned definitions may equally apply to the description below.

As shown, the method 603 begins with receiving a destination. See operation 626. A geo-fence associated with all users (e.g., passengers) in the vehicle is identified. See operation 628. For example, a group of users in the vehicle may include five individuals, and for four individuals, no geo-fence restrictions may apply. However, because one individual is subject to geo-fence restrictions, the entire group of occupants of the vehicle will be subject to the geo-fence.

In another example, a first individual may be subject to a first geo-fence, and a second individual may be subject to a second geo fence, and a combined geo-fence may be based on overlapping geographic areas for each of the first individual and the second individual. In a separate embodiment, a first geo-fence for a first individual may be added to a second geo-fence for a second individual. For example, the first individual may be an older sibling of the second individual. Furthermore, the older sibling may have a more extensive geo-fence than the younger sibling; but when the older and younger siblings are together, the younger sibling may travel within the more extensive geo-fence of the older sibling. Alternatively, the geo-fence of the older sibling may be restricted to that of the younger sibling when the siblings are traveling together. It is to be appreciated that the geo-fences of multiple individuals may be added to, subtracted from, and/or manipulated in any technically feasible manner based on predetermined rules associated with processing the geo-fences.

Additionally, it is determined whether the destination is within the geo-fences for all users. See operation 630. If the destination is within the geo-fence (per decision 632), then the self-driving vehicle initiates operation to proceed to the destination. See operation 634. If the destination is not within the geo-fence, then the destination is indicated as being invalid. See operation 636. Additionally, the operation 636 may operate in a manner similar to the operation 624.

In an embodiment, a route and/or geo-fence may be constructed to avoid high-crime areas (as indicated by map data for the area), even at the cost of a longer distance or slower travel time. Furthermore, vehicle self-driving operations may be tuned to a more vigilant mode in higher-crime areas. For example, the self-driving operation may be tuned to preferentially avoid traffic scenarios where the vehicle may become blocked in by other vehicles. Similarly, the self-driving operation may be tuned to assume other vehicles are more likely to break traffic rules in higher crime areas. In certain embodiments, a self-driving vehicle is in communication with a cloud-based server system that is configured to guide route decisions that may be generally or otherwise calculated by the self-driving vehicle.

In an embodiment, for the purpose of geo-fence compliance, vehicle location is determined using at least two different techniques (GPS, WiFi, cell tower triangulation, visual street information, inertial sensing, and so forth). Furthermore, if, during the course of self-driving operation, vehicle location reported by the at least two different techniques deviates beyond a certain maximum deviation distance, then an alert may be transmitted and the vehicle may take one or more mitigation actions. The alert may be sent to an operations center, an owner, and operator, a registered user, law enforcement officials, or any combination thereof. In an embodiment, after the alert is transmitted the vehicle may enable a kill switch. Operation of the kill switch may be delegated to a registered person, including law enforcement officials. In an embodiment, if vehicle location reported by the at least two different techniques deviates beyond the maximum deviation distance, then the vehicle may continue operation using at least two different location sensing techniques that are in agreement. In an embodiment, upon transmitting the alert, the vehicle may begin transmitting video image data from digital cameras (e.g., user ID sensors 372, self-driving sensors 374, etc.) to a service center, an operator, law enforcement officials, or a recording service. In an embodiment, a smartphone or other user device may provide vehicle location to the vehicle as one of the techniques. Furthermore, when a location deviation occurs, the user may be given an option to select which location technique to use for continued vehicle operation.

FIG. 7A illustrates a system 700 for enabling and directing operation of a vehicle, in accordance with one embodiment. As an option, the system 700 may be implemented in the context of the details of any of the Figures disclosed herein. Of course, however, the system 700 may be implemented in any desired environment. Further, the aforementioned definitions may equally apply to the description below.

In various embodiments, the system 700 may be configured to perform one or more of methods 100, 200, 400, 401, 403, 405, 407, 500, 501, 503, 505, 507, 600, 601, 603, and 701. Furthermore, system 700 may be configured to receive and interpret sensor data for vehicle and/or navigational operation of a driver-controlled and/or self-driving vehicle.

As shown, the system 700 includes a vehicle control and navigation system 702 which includes a vehicle navigation subsystem 704, a neural-net inference subsystem 706, and/or a vehicle operation subsystem 708. In one embodiment, the vehicle navigation subsystem 704 may be in communication with the neural-net inference subsystem 706, such communication including sending data and/or commands from the vehicle navigation subsystem 704 to the neural-net inference subsystem 706, and receiving data and/or commands from the neural-net inference subsystem 706 at the vehicle navigation subsystem 704. Further, the vehicle navigation subsystem 704 may be in communication with the vehicle operation subsystem 708, including sending data and/or commands from the vehicle navigation subsystem 704 to the vehicle operation subsystem 708. In an embodiment, the vehicle navigation subsystem 704 is configured to manage overall vehicle movement, the neural-net inference subsystem 706 is configured to interpret vehicle surroundings, and the vehicle operation subsystem 708 is configured to execute basic vehicle operation (e.g., accelerating, breaking, turning, etc.).

The vehicle navigation subsystem 704 may be in communication with a touch input display screen 714, a GPS receiver 716, a speaker 718, and/or a microphone 720. It is to be appreciated that other components (not shown) may be in communication with the vehicle navigation subsystem 704, including but not limited to, an accelerometer, a cellular data connection (to allow for triangulation of position, and offloading of various tasks to a stationary server array), etc. The microphone 720 may include multiple microphones, and in one embodiment, the microphones may be located through the vehicle such that a 3D audio map may be created (to identify a position of an individual speaking). Further, as shown, the vehicle navigation subsystem 704 may control the vehicle operation subsystem 708 and/or the neural-net inference subsystem 706. In an embodiment, vehicle navigation subsystem 704 and/or neural-net inference subsystem 706 may comprise one or more instances of processor complex 310.

The neural-net inference subsystem 706 may be in communication with user ID sensors 372 and/or self-driving sensors 374. It is to be appreciated that other components (not shown) may be in communication with the neural-net inference subsystem 706, including but not limited to, one or more ultrasonic proximity scanners, one or more radar scanners (e.g., mm radar scanner), one or more Light Detection and Ranging (LiDAR) scanners, one or more lasers, one or more light pulse generators, one or more visual light cameras, one or more infrared cameras, one or more ultraviolet cameras, etc. The user ID sensors 372 may include bio-capture sensors, one or more cameras (including cabin cameras, exterior cameras, etc.), iris scanner, proximity sensor, a scale (to measure a weight of an occupant), a NFC reader, etc. The self-driving sensors 374 may provide environmental data to be interpreted by the neural-net inference subsystem 706, which may generate an abstraction of an environment surrounding the vehicle.

Further, the vehicle operation subsystem 708 may be in communication with vehicle operation actuators 710 and/or vehicle operation sensors 712. It is to be appreciated that other components (not shown) may be in communication with the vehicle operation subsystem 708, including but not limited to, oxygen sensor, temperature sensor, pressure sensor, air flow sensor, voltage sensor, fuel temperature sensor, etc.

In an embodiment, a location receiver 717 may be included to provide a secondary and/or tertiary mechanism for detecting vehicle location. In an embodiment, the location receiver 717 comprises a WiFi receiver, and the secondary mechanism may include WiFi location detection. In another embodiment, the location receiver 717 comprises a cellular (e.g. LTE) receiver, and the mechanism may include, cell tower triangulation. In an embodiment, the location receiver 717 includes both a WiFI receiver and a cellular receiver and two different location techniques may be applied according to signal availability. In certain embodiments, the location receiver 717 further includes an inertial sensor and inertial tracking is used to provide a location estimate. In still other embodiments, a wheel rotation count (odometer), wheel velocity (speedometer), and wheel position (steering angle) may be used to estimate location. In certain embodiments, an accelerometer and/or gyro may be included in location receiver 717 to provide yet another location estimate, optionally in combination with any other technique for estimating location.

In an embodiment, if the GPS receiver 716 deviates beyond a predetermined deviation distance from one or more other location estimation techniques provided by location receiver 717, then a notification and/or alert is transmitted. The alert may be transmitted to a service provider, a vehicle operator/owner, a parent, or law enforcement. In certain scenarios, an attacker may attempt to spoof a GPS signal or other signals in an attempt to cause a vehicle to deviate from a desired path; by providing multiple different location measurements, the vehicle can attempt to mitigate such attacks. The deviation distance may be measured as a Manhattan distance, a geometric distance, or any other technically feasible distance measure.

In an embodiment, image data from self-driving sensors 374 may be processed to identify current location of the vehicle and provide yet another location estimate based on visual data of the vehicle's surroundings. In such an embodiment, any significant deviation between a visually-based location estimate and a GPS location may also cause the alert to be transmitted.

In certain embodiments, certain mitigation functions may be provided, including disabling the vehicle. In an embodiment, disabling the vehicle may be directed by an operator, owner, or law enforcement. Furthermore, disabling the vehicle may include causing the vehicle to slow down and pull off the road while avoiding any collision scenarios.

In an embodiment, one or more chemical sensors 373 are included in system 700 and configured to sample, measure, and/or analyze the chemical environment of the cabin of vehicle 370. In an embodiment, a chemical sensor 373 is configured to measure carbon-dioxide in the cabin. In another embodiment, a chemical sensor 373 is configured to measure carbon-monoxide in the cabin. In yet another embodiment, a chemical sensor 373 is configured to measure alcohol vapor in the cabin. In still yet another embodiment, a chemical sensor 373 is configured to detect smoke in the cabin. In other embodiments, a chemical sensor 373 may be configured to perform any technically feasible measurement or analysis that may guide vehicle behavior, including toxin and biological hazard detection.

In an embodiment, if the vehicle is operating in a self-driving mode and the cabin carbon-dioxide (or carbon-monoxide) is measured to be above a certain threshold, then actuators in the vehicle may be configured to flush out stale air, such as through bringing in fresh air through a vehicle air-conditioning system.

In another embodiment, if the vehicle is being driven by a human operator and the cabin carbon-dioxide (or carbon-monoxide) is measured to be above a certain threshold, then a warning signal (light indicator, sound indicator, vibration indicator, or a combination of indicators) may be activated; furthermore, actuators in the vehicle may be configured to flush out stale air, such as through bringing in fresh air through a vehicle air-conditioning system. Furthermore, the system 700 may observe the driver for signs of drowsiness and transition to a robust driver-assist mode if the driver appears excessively drowsy for accidence avoidance while proceeding to pull the vehicle over at a safe location. In an embodiment, the threshold for carbon-dioxide is between one tenth of one percent and one percent carbon-dioxide measured in the cabin air.

In an embodiment, if the vehicle is operating under a human driver control and alcohol, toxins, one or more specified chemical markers, or hazardous vapor is detected in the cabin air, the vehicle may activate a warning indicator. Furthermore, the vehicle may be configured to slow down, pull over and stop at a safe location off the road if the driver is assessed to be compromised (drowsy, intoxicated, injured, ill). In certain embodiments, the vehicle control and navigation system 702 reads image data from digital cameras to assess the source of vapor and if the source is determined to be outside the cabin then the vehicle may continue driving.

In an embodiment, the vehicle control and navigation system 702 reads image data from digital cameras (e.g., user ID sensors 372) to assess whether a driver is remaining alert. In other embodiments, the vehicle control and navigation system 702 reads image data from digital cameras (e.g., user ID sensors 372) to assess whether a vehicle occupant is observing the environment surrounding the vehicle (e.g., road conditions, off-road hazards, etc); if so and the occupant is focused on a particular area outside the vehicle, the area is analyzed with heightened scrutiny and/or a bias for likely danger from the area.

In an embodiment, the vehicle control and navigation system 702 may be configured to determine operational limits for the vehicle 370. Such operational limits may be assessed by the vehicle control and navigation system 702 based on sensor inputs and/or a combination of geo-location information and map information. Road conditions, including weather conditions (e.g., rain, water accumulation, snow, ice, and so forth) may be considered when assessing the limits. In an embodiment, the neural-net inference subsystem 706 is configured to (at least in part) determine current weather conditions. Furthermore, the vehicle control and navigation system 702 may communicate with a remote, network-based weather service to determine (at least in part) current weather conditions. The limits may also be based (at least in part) on tire temperature, pressure, and/or current vehicle weight. For example, a velocity (speed) limit may be reduced as the current vehicle weight increases or tire pressure decreases. The operational limits may include acceleration and/or velocity, which may be assessed for a given section of road (e.g., based on road geometry, weather conditions, vehicle weight, etc.). The limits may be used as a basis for providing feedback to the driver. In an embodiment, feedback related to a velocity and/or acceleration limit may be provided in the form of increased resistance to a driver pressing the accelerator (gas) pedal if additional vehicle acceleration or velocity would exceed a respective limit.

In an embodiment, the system 700 is configured to assess the character of sound within the vehicle 370 (e.g., sampled by microphone 720) and/or outside the vehicle. For example, the assessment of sound character may indicate an occupant is in medical distress (e.g., heart attack), causing the system 700 to respond; for example, by alerting authorities and requesting medical assistance at the vehicle location. The system 700 may further cause the vehicle 370 to navigate through traffic and pull over awaiting assistance. Alternatively, the system 700 may drive the vehicle 370 to an Emergency medical facility. The assessment of sound may be further validated by video imagery from vehicle cameras prior to taking significant action.

FIG. 7B illustrates a method 701 for configuring a neural-net inference subsystem, in accordance with one embodiment. As an option, the method 701 may be implemented in the context of the details of any of the Figures disclosed herein. Of course, however, the method 701 may be implemented in any desired environment. Further, the aforementioned definitions may equally apply to the description below.

As shown, the method 701 begins with configuring the neural-net inference subsystem 706 to identify authorized users. See operation 726. For example, the neural-net inference subsystem 706 may be used to identify individuals within captured images of the individuals approaching the vehicle, as well as those that enter the vehicle (e.g., after authorization to enter has been granted). In like manner, an iris scanner, an NFC reader, etc. may be used to collect information to be used by the neural-net inference subsystem 706 to identify one or more authorized users.

The user is authorized to operate the vehicle. See operation 728. Additionally, a command is received to initiate self-driving operation. See operation 730. Further, the neural-net inference subsystem 706 is configured to perform self-driving operations. See operation 732. It is to be appreciated that method 701 advantageously improves system utilization compared to techniques that required multiple different hardware resources configured separately to perform user authentication and self-driving operations.

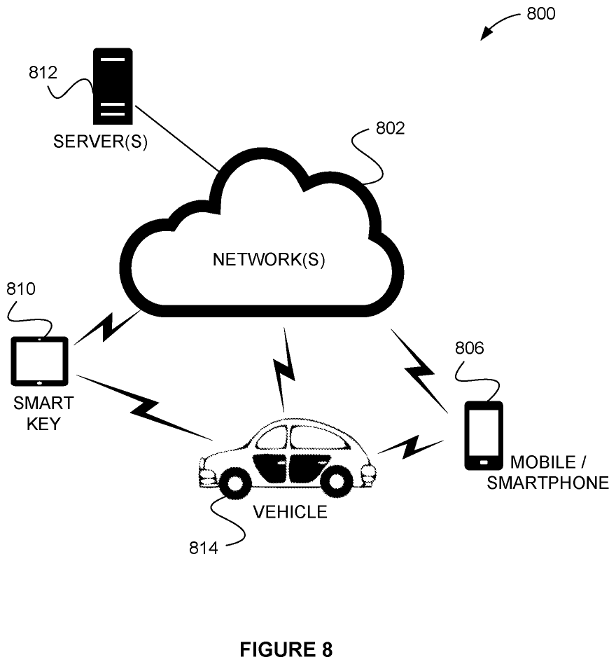

FIG. 8 illustrates a communications network architecture 800, in accordance with one possible embodiment. As shown, at least one network 802 is provided. In the context of the present network architecture 800, the network 802 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 802 may be provided. In an embodiment, the network 802 includes a wireless network comprising Long Term Evolution (LTE) digital modems at network access points/cell towers, as well as at client devices, such as a vehicle 814 (e.g. vehicle 370), a smartphone 806, and a smart key 810. During normal operation, client devices communicate data through network access points.

Coupled to the network 802 is a plurality of devices. For example, a server computer 812 may be coupled to the network 802 for communication purposes. Still yet, various other devices may be coupled to the network 802 including smart key device 810, smartphone 806, vehicle 814, etc. In an embodiment, the vehicle 814 includes one or more instances of the system 700 of FIG. 7A. Furthermore, the vehicle system 700 within vehicle 814 may be in communication with network 802, and in particular smart key 810 and/or server 812.

In an embodiment, smart key 810 is configured to exclusively allow one or more specific persons to operate vehicle 814. The one or more specific person are associated with the smart key 810. Furthermore, different instances of smart key 810 may allow different sets of people to operate the vehicle 814. In an embodiment, the smart key 810 may include identifying information for the one or more specific persons. The identifying information may be digitally signed. In an embodiment, the identifying information includes a list of one or more indices used by a vehicle processor system (e.g., system 700) to look up recognition information for the one or more persons. The recognition information may include coefficients for identifying a person (e.g., face, finger print, iris pattern, retina pattern, etc.).

In an embodiment, the vehicle processor system is configured to record identifying information for vehicle occupant devices. For example, the vehicle processor system may record all WiFI media access control (MAC) addresses, International Mobile Subscriber Identity (IMSI) values, electronic serial number (ESIN) values, and/or mobile equipment identifier (METD) values for devices within the vehicle passenger compartment. Furthermore, the vehicle 814 may record and attempt to identify faces of individuals within and/or around the vehicle and correlate the identifying information with the recorded faces.

In an embodiment, smartphone 806, smart key 810, and/or vehicle 814 are configured to store medical information for a vehicle occupant. For example, smartphone 806 may be configured to store drug allergies (or lack of allergies) and/or critical medical conditions (or lack of conditions) for the device's owner. In an accident scenario, the medical information can be made available (from the smartphone 806, smart key 810, and/or vehicle 814) to first responders for more expeditious treatment upon arrival.

In an embodiment, one or more of biometric data (heart rate, heart waveform, blood oxygen saturation), cabin CO2 and/or CO level, video data analyzed to assess individual health (e.g., healthy and wake, drowsy, injured, ill, in acute distress, unconscious, etc.) are analyzed (e.g., by the system 700) periodically to determine in real-time whether a driver or occupant needs assistance. Assistance may include the vehicle 814 driving or taking over driving from a person to safely maneuver the vehicle 814 off the road. Assistance may also include driving the vehicle 814 to an emergency medical facility. Assistance may also include calling an ambulance, notifying law enforcement that the vehicle 814 is inbound to an emergency medical facility and, optionally, requesting an escort. In an embodiment, certain biometric data may be sampled by a smartwatch and transmitted to the vehicle 814. For example, a user may pair their smartwatch with the vehicle 814, allowing the vehicle 814 to monitor heart rate, heart waveform, oxygen, blood pressure, or a combination thereof sampled by the smartwatch in real-time. Should the user become medically distressed, the vehicle 814 may provide assistance, such as described above. In an embodiment, a user device may be configured to notify the vehicle 814 if the user may be compromised or need assistance. For example, a smartwatch may have detected an irregular heart rhythm or cardiac stress or a smartwatch and/or smartphone may have detected an irregular walking gait en route to the vehicle 814.

In an embodiment, vehicle 814 is configured to detect a chemical marker, e.g., present on an occupant. Upon detecting the chemical marker, the vehicle 814 may alert an authority, such as law enforcement, that the chemical marker is present on the vehicle occupant. The vehicle 814 may be configured to allow operation, while transmitting geo-location information to law enforcement. This scenario may occur, for example, should the occupant commit a crime (e.g., rob a bank), and be marked by a system at the crime scene. A bank entry way may include such as system, such a compressed air atomizer configured to mark a perpetrator on the way out of the bank with the chemical marker, and the vehicle 814 may then detect the chemical marker and alert authorities. The chemical marker may include any technically feasible compound or compounds.

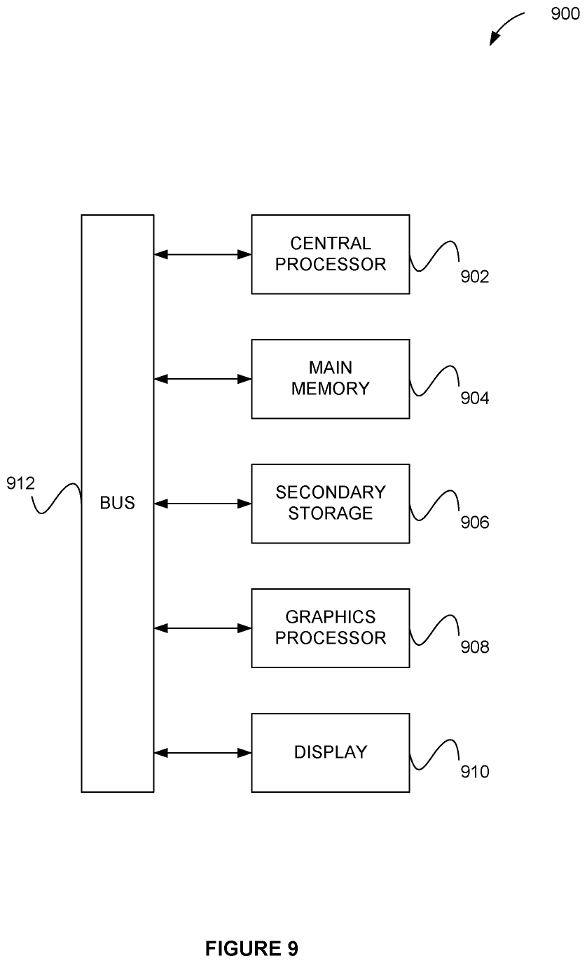

FIG. 9 illustrates an exemplary system 900, in accordance with one embodiment. As an option, the system 900 may be implemented in the context of any of the devices of the network architecture 800 of FIG. 8 and/or system 700 of FIG. 7A. Of course, the system 900 may be implemented in any desired environment.

As shown, system 900 is provided including at least one central processor 902 which is connected to a communication bus 912. The system 900 also includes main memory 904 [e.g. random access memory (RAM), etc.]. The system 900 also includes a graphics processor 908 and a display 910.

The system 900 may also include a secondary storage 906. The secondary storage 906 includes, for example, a hard disk drive, a solid-state memory drive, and/or a removable storage drive, etc. The removable storage drive reads from and/or writes to a removable storage unit in a well known manner.

Computer programs, or computer control logic algorithms, may be stored in the main memory 904, the secondary storage 906, and/or any other memory, for that matter. Such computer programs, when executed, enable the system 900 to perform various functions (as set forth above, for example). Memory 904, storage 906 and/or any other storage are possible examples of non-transitory computer-readable media.

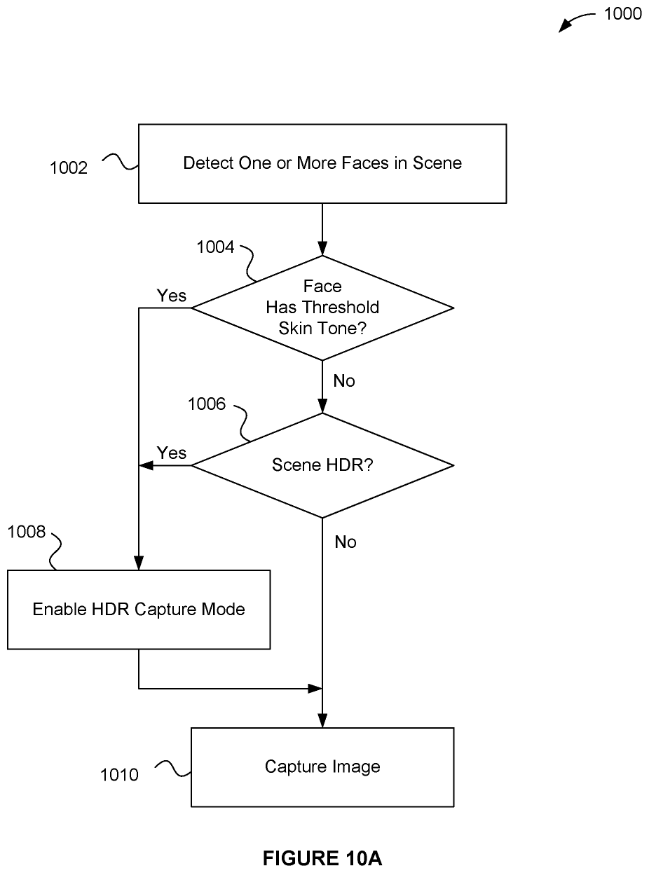

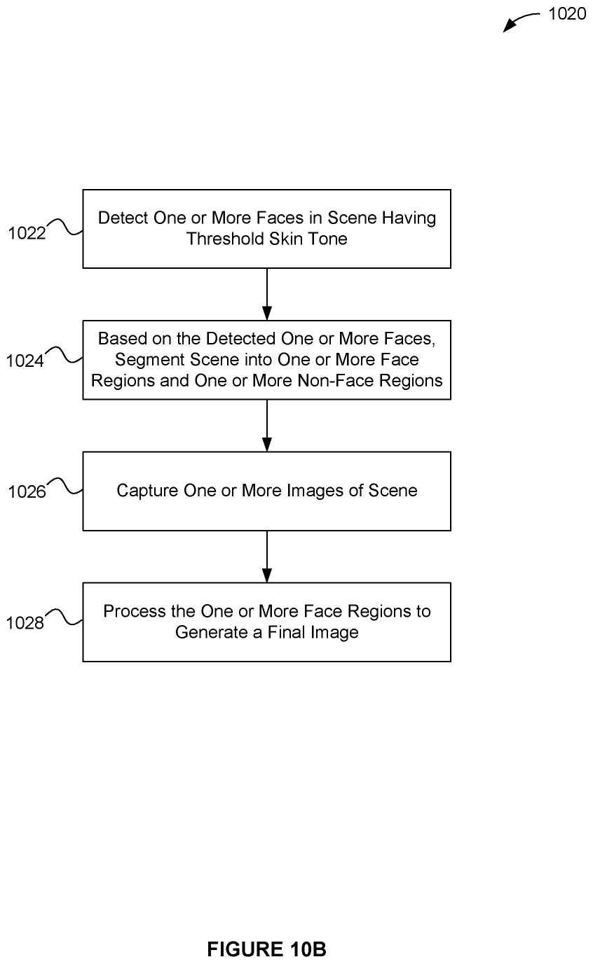

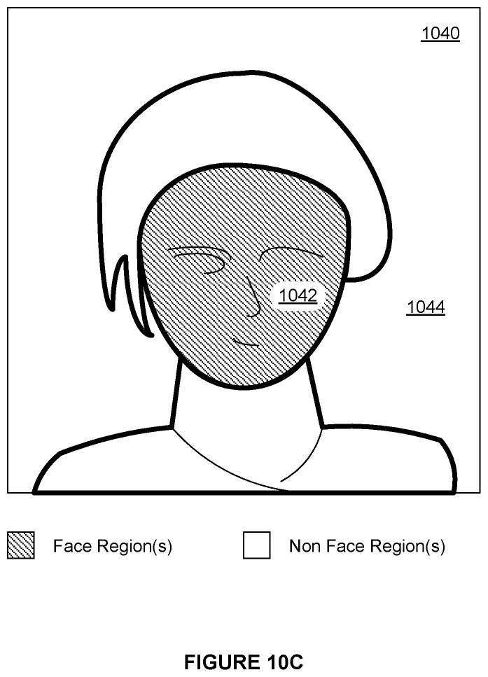

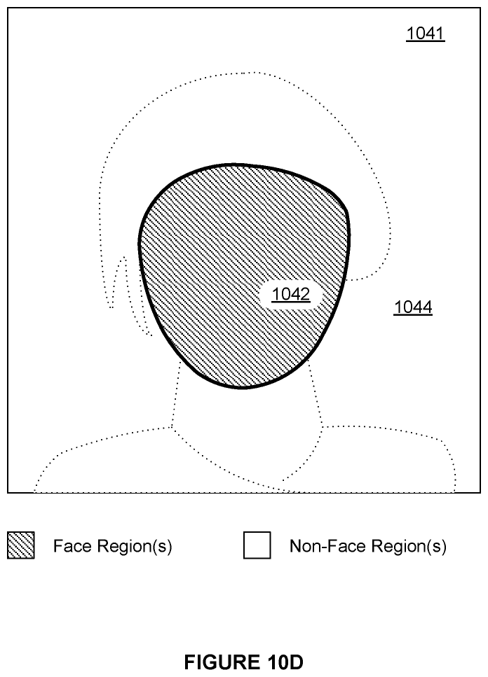

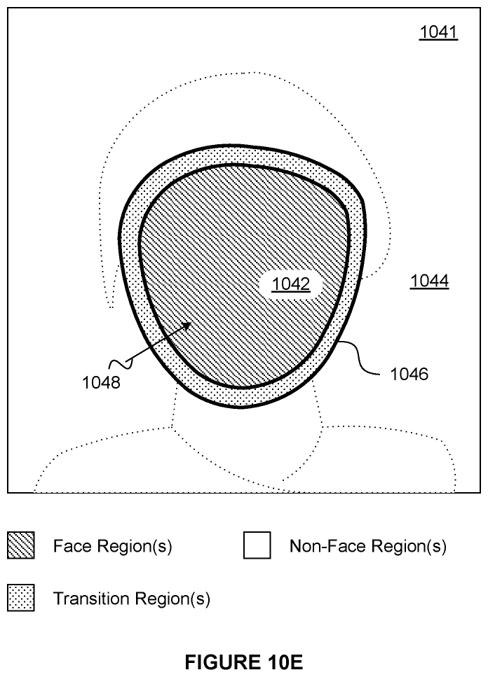

FIG. 10A illustrates an exemplary method 1000 for capturing an image, in accordance with one possible embodiment. Method 1000 may be performed by any technically feasible digital photographic system (e.g., a digital camera or digital camera subsystem). In one embodiment, method 1000 is performed by digital photographic system 300 of FIG. 3A.

At step 1002, the digital photographic system detects one or more faces within a scene. It is to be appreciated that although the present description describes detecting one or more faces, one or more other body parts (e.g. arms, hands, legs, feet, chest, neck, etc.) may be detected and used within the context of method 1000. Any technically feasible technique may be used to detect the one or more faces (or the one or more body parts). If, at step 1004, at least one of the one or more faces (or the one or more body parts) has a threshold skin tone, then the method proceeds to step 1008. In the context of the present description, skin tone refers to a shade of skin (e.g., human skin). For example, a skin tone may be light, medium, or dark, or a meld between light and medium, or medium and dark, according to a range of natural human skin colors.

If, at step 1004, no face within the scene has a threshold skin tone, the method proceeds to step 1006. In the context of the present description, a threshold skin tone is defined to be a dark skin tone below a defined low intensity threshold or a light skin tone above a defined intensity high threshold. For dark skin tones, an individual's face may appear to be highly underexposed, while for light skin tones, an individual's face may appear to be washed out and overexposed. Such thresholds may be determined according to any technically feasible technique, including quantitative techniques and/or techniques using subjective assessment of captured images from a given camera system or systems.

Additionally, a threshold skin tone may include a predefined shade of skin. For example, a threshold skin tone may refer to a skin tone of light shade, medium shade, or dark shade, or a percentage of light shade and/or medium shade and/or dark shade. Such threshold skin tone may be predefined by a user, by an application, an operating system, etc. Additionally, the threshold skin tone may function in a static manner (i.e. it does not change, etc.) or in a dynamic manner. For example, a threshold skin tone may be tied to a context of the capturing device and/or of the environment. In this manner, a default threshold skin tone may be applied contingent upon specific contextual or environmental conditions (e.g. brightness is of predetermined range, etc.), and if such contextual and/or environmental conditions change, the threshold skin tone may be accordingly modified. For example, a default threshold skin tone may be tied to a ‘normal’ condition of ambient lighting, but if the environment is changed to bright sunlight outside, the threshold skin tone may account for the brighter environment and modify the threshold skin tone.

A low threshold skin tone may be any technically feasible threshold for low-brightness appearance within a captured scene. In one embodiment, the low threshold skin tone is defined as a low average intensity (e.g., below 15% of an overall intensity range) for a region for a detected face. In another embodiment, the low threshold skin tone is defined as a low contrast for the region for the detected face. In yet another embodiment, the low threshold is defined as a low histogram median (e.g., 20% of the overall intensity range) for the region for the detected face. Similarly, a high threshold may be any technically feasible threshold for high-brightness appearance within a captured scene. In one embodiment, the high threshold is defined as a high average intensity (e.g., above 85% of an overall intensity range) for a region for a detected face. In another embodiment, the high threshold is defined as high intensity (bright) but low contrast for the region for the detected face. In yet another embodiment, the high threshold is defined as a high histogram median (e.g., 80% of the overall intensity range) for the region for the detected face.

If, at step 1006, the scene includes regions having collectively high dynamic range intensity, then the method proceeds to step 1008. Otherwise, the method proceeds to step 1010.

At step 1008, the digital photographic system enables high dynamic range (HDR) capture. At step 1010, the digital photographic system captures an image of the scene according to a capture mode. For example, if the capture mode specified that HDR is enabled, then the digital photographic system captures an HDR image.

FIG. 10B illustrates an exemplary method 1020 for capturing an image, in accordance with one possible embodiment. Method 1020 may be performed by any technically feasible digital photographic system (e.g., a digital camera or digital camera subsystem). In one embodiment, method 1020 is performed by digital photographic system 300 of FIG. 3A.

At step 1022, the digital photographic system detects one or more faces within a scene having threshold skin tone, as described herein. Of course, it is to be appreciated that method 1020 may be applied additionally to one or more other body parts (e.g. arm, neck, chest, leg, hand, etc.).

At step 1024, the digital photographic system segments the scene into one or more face region(s) and one or more non-face region(s). Any technically feasible techniques may be implemented to provide scene segmentation, including techniques that surmise coverage for a segment/region based on appearance, as well as techniques that also include a depth image (z-map) captured in conjunction with a visual image. In an alternative embodiment, step 1024 may include edge detection between one part (e.g. head, etc.) and a second part (e.g. neck, etc.). In certain embodiments, machine learning techniques (e.g., a neural network classifier) may be used to detect image pixels that are part of a face region(s), or skin associated with other body parts.

At step 1026, the one or more images of the scene are captured. The camera module and/or digital photographic system may be used to capture such one or more images of the scene. In one embodiment, the digital photographic system may capture a single, high dynamic range image. For example, the digital photographic system may capture a single image, which may have a dynamic range of fourteen or more bits per color channel per pixel. In another embodiment, the digital photographic system captures two or more images, each of which may provide a relatively high dynamic range (e.g., twelve or more bits per color channel per pixel) or a dynamic range of less than twelve bits per color channel per pixel. The two or more images are exposed to capture detail of at least the face region(s) and the non-face region(s). For example, a first of the two or more images may be exposed so that the median intensity of the face region(s) defines the mid-point intensity of the first image. Furthermore, a second of the two or more images may be exposed so that the median intensity of the non-face region(s) defines a mid-point intensity of the second image.

At step 1028, the digital photographic system processes the one or more face regions to generate a final image. In one embodiment, to process the one or more face regions, the digital photographic system applies a high degree of HDR effect to final image pixels within the face region(s). In certain embodiments, a degree of HDR effect is tapered down for pixels along a path leading from an outside boundary of a given face region through a transition region, to a boundary of a surrounding non-face region. The transition region may have an arbitrary thickness (e.g., one pixel to many pixels). In one embodiment, the degree of HDR effect is proportional to a strength coefficient, as defined in co-pending U.S. patent application Ser. No. 14/823,993, filed Aug. 11, 2015, entitled “IMAGE SENSOR APPARATUS AND METHOD FOR OBTAINING MULTIPLE EXPOSURES WITH ZERO INTERFRAME TIME,” which is incorporated herein by reference for all purposes. In other embodiments, other HDR techniques may be implemented, with the degree of HDR effect defined according to the particular technique. For example, a basic alpha blend may be used to blend between a conventionally exposed (ev 0) image and an HDR image, with the degree of zero HDR effect for non-face region pixels, a degree of one for face regions pixels, and a gradual transition (see FIG. 2) between one and zero for pixels within a transition region. In general, applying an HDR effect to pixels within a face region associated with an individual with a dark skin tone provides greater contrast at lower light levels and remaps the darker skin tones closer to an image intensity mid-point. Applying the HDR effect to pixels within the face region can provide greater contrast for pixels within the face region, thereby providing greater visual detail. Certain HDR techniques implement tone (intensity) mapping. In one embodiment, conventional HDR tone mapping is modified to provide greater range to pixels within the face region. For example, when capturing an image of an individual with dark skin tone, a darker captured intensity range may be mapped by the modified tone mapping to have a greater output range (final image) for pixels within the face region, while a conventional mapping is applied for pixels within the non-face region. In one embodiment, an HDR pixel stream (with correct tone mapping) may be created, as described in U.S. patent application Ser. No. 14/536,524, now U.S. Pat. No. 9,160,936, entitled “SYSTEMS AND METHODS FOR GENERATING A HIGH-DYNAMIC RANGE (HDR) PIXEL STREAM,” filed Nov. 7, 2014, which is hereby incorporated by reference for all purposes. Additionally, a video stream (with correct tone mapping) may be generated by applying the methods described herein.

In another embodiment, to process the one or more images, the digital photographic system may perform a local equalization on pixels within the face region (or the selected body region). The local equalization may be applied with varying degrees within the transition region. In one embodiment, local equalization techniques, including contrast limited adaptive histogram, equalization (CLAHE) may be applied separately or in combination with an HDR technique. In such embodiments, one or more images may be captured according to method 1020, or one or more images may be captured according to any other technically feasible image capture technique.

In certain embodiments, a depth map image and associated visual image(s) may be used to construct a model of one or more individuals within a scene. One or more texture maps may be generated from the visual image(s). For example, the depth map may be used, in part, to construct a three-dimensional (3D) model of an individual's face (photographic subject), while the visual image(s) may provide a surface texture for the 3D model. In one embodiment, a surface texture may include colors and/or features (e.g. moles, cuts, scars, freckles, facial fair, etc.). The surface texture may be modified to provide an average intensity that is closer to an image mid-point intensity, while preserving skin color and individually-unique skin texture (e.g. moles, cuts, scars, freckles, facial fair, etc.). The 3D model may then be rendered to generate a final image. The rendered image may include surmised natural scene lighting, natural scene lighting in combination with added synthetic illumination sources in the rendering process, or a combination thereof. For example, a soft side light may be added to provide depth cues from highlights and shadows on the individual's face. Furthermore, a gradient light may be added in the rendering process to provide additional highlights and shadows.

In certain other embodiments, techniques disclosed herein for processing face regions may be implemented as post-processing rather than in conjunction with image capture.

FIG. 10C illustrates an exemplary scene segmentation into face region(s) 1042 and non-face region(s) 1044, in accordance with one possible embodiment. As shown, an image 1040 is segmented into a face region 1042 and a non-face region 1044. Any technically feasible technique may be used to perform the scene segmentation. The technique may operate solely on visual image information, depth map information, or a combination thereof. As an option, FIG. 10C may be implemented in the context of any of the other figures, as described herein. In particular, FIG. 10C may be implemented within the context of steps 1022-1028 of FIG. 10B.

In another embodiment, a selected body-part region may be distinguished and separately identified from a non-selected body-part region. For example, a hand may be distinguished from the surroundings, an arm from a torso, a foot from a leg, etc.

FIG. 10D illustrates a face region mask 1041 of a scene, in accordance with one possible embodiment. In one embodiment, a pixel value within face region mask 1041 is set to a value of one (1.0) if a corresponding pixel location within image 1040 is within face region 1042, and a pixel value within face region mask 1041 is set to a value of zero (0.0) if a corresponding pixel location within image 1040 is outside face region 1042. In one embodiment, a substantially complete face region mask 1041 is generated and stored in memory. In another embodiment, individual mask elements are computed prior to use, without storing a complete face region mask 1041 in memory. As an option, FIG. 10D may be implemented in the context of any of the other figures, as described herein. In particular, FIG. 10D may be implemented within the context of steps 1022-1028 of FIG. 10B, or within the context of FIG. 10C.

FIG. 10E illustrates a face region mask 1041 of a scene including a transition region 1046, in accordance with one possible embodiment. As shown, transition region 1046 is disposed between face region 1042 and non-face region 1044. Mask values within face region mask 1041 increase from zero to one along path 1048 from non-face region 1044 to face region 1042. A gradient of increasing mask values from non-face region 1044 to face region 1042 is indicated along path 1048. For example, a mask value may increase from a value of zero (0.0) in non-face region 1044 to a value of one (1.0) in face region 1042 along path 1048. Any technically feasible technique may be used to generate the gradient. As an option, FIG. 10E may be implemented in the context of any of the other figures, as described herein. In particular, FIG. 10E may be implemented within the context of steps 1022-1028 of FIG. 10B, or within the context of FIGS. 10C-10D.

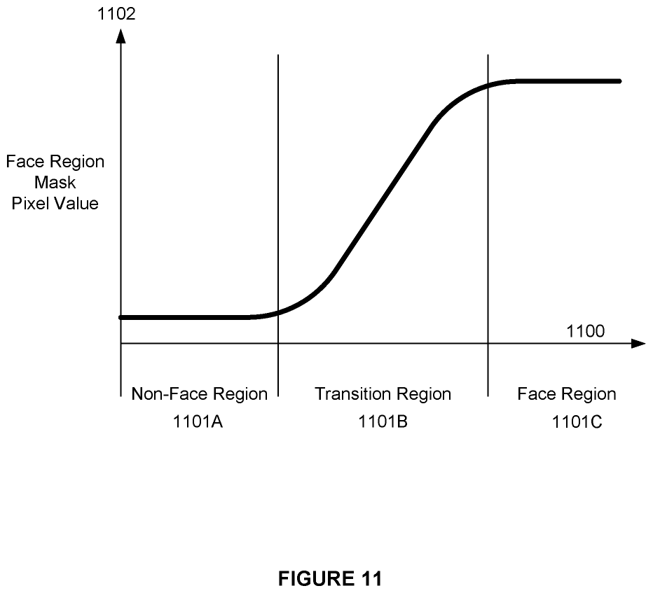

FIG. 11 illustrates an exemplary transition in mask value from a non-face region (e.g., non-face region 1044) to a face region (e.g., face region 1042), in accordance with one possible embodiment. As an option, FIG. 11 may be implemented in the context of the details of any of the Figures disclosed herein. Of course, however, FIG. 11 may be implemented in any desired environment.

As shown, a face region mask pixel value 1102 (e.g., mask value at a given pixel within face region mask 1041) increases from non-face region 1101A pixels to face region 1101C pixels along path 1100, which starts out in a non-face region 1101A, traverses through a transition region 1101B, and continues into face region 1101C. For example, path 1100 may correspond to at least a portion of path 1048 of FIG. 10E. Of course, it is to be appreciated that FIG. 11 may be implemented with respect to other and/or multiple body regions. For example, FIG. 11 may be implemented to indicate mask values that include face regions and neck regions. Furthermore, FIG. 11 may be implemented to indicate mask values that include any body part regions with skin that is visible.

In other embodiments, a depth map may be used in conjunction with, or to determine, a face region. Additionally, contrast may be modified (e.g., using CLAHE or any similar technique) to enhance contrast for a skin tone. In one embodiment, if the skin tone is lighter (or darker), additional contrast may be added (or removed). In other embodiments, if the contours of a face are known (e.g., from 3D mapping of the face), lighting, shadowing, and/or other lighting effects may be added or modified in one or more post processing operations. Further, voxelization (and/or 3d mapping of 2d images) or other spatial data (e.g., a surface mesh of a subject constructed from depth map data) may be used to model a face and/or additional body parts, and otherwise determine depth values associated with an image.

In one embodiment, depth map information may be obtained from a digital camera (e.g. based on parallax calculated from more than one lens perspectives, more than one image of the same scene but from different angles an/or zoom levels, near-simultaneous capture of the image, dual pixel/focus pixel phase detection, etc.). Additionally, depth map information may also be obtained (e.g., from a depth map sensor). As an example, if a face is found in an image, and a depth map of the image is used to model the face, then synthetic lighting (e.g., a lighting gradient) could be added to the face to modify lighting conditions on the face (e.g., in real-time or in post-processing). Further, a texture map (sampled from the face in the image) may be used in conjunction with the depth map to generate a 3D model of the face. In this manner, not only can synthetic lighting be applied with correct perspective on an arbitrary face, but additionally, the lighting color may be correct for the ambient conditions and skin tone on the face (or whatever skin section is shown), according to a measured color balance for ambient lighting. Any technically feasible technique may be implemented for measuring color balance of ambient lighting, including identifying illumination sources in a scene and estimating color balance for one or more of the illumination sources. Alternatively, color balance for illumination on a subject's face may be determined based on matching sampled color to a known set of human skin tones. In other embodiments, a gray scale image is produced, enhanced, or generated/rendered and used for identifying one or more individuals inside or outside vehicle 370.

In one embodiment, a texture map may be created from the face in the image. Furthermore, contrast across the texture map may be selectively modified to correct for skin tone. For example, a scene(s) may be segmented to include regions of subject skin (e.g., face, arm, neck, etc.) and regions that are not skin (e.g., clothing, hair, background). Additionally, the scene(s) may include other skin body parts (e.g. arm, neck, etc.). In such an example, all exposed skin may be included in the texture map (either as separate texture maps or one inclusive texture map) and corrected (e.g., equalized, tone mapped, etc.) together. The corrected texture map is then applied to a 3D model of the face and any visible skin associated with visible body parts. The 3D model may then be rendered in place in a scene to generate an image of the face and any other body parts of an individual in the scene. By performing contrast correction/adjustment on visible skin of the same individual, the generated image may appear to be more natural overall because consistent skin tone is preserved for the individual.

In certain scenarios, non-contiguous regions of skin may be corrected separately. As an example, a person may have light projected onto their face (e.g., from illuminators comprising vehicle 370), while the person's neck, hands, or arms may be in shadows. Such face may therefore be very light, whereas the neck, hands, arms may all be of a separate and different hue and light intensity. As such, the scene may be segmented into several physical regions having different hue and light intensity. Each region may therefore be corrected in context for a more natural overall appearance.

In one embodiment, an object classifier and/or other object recognition technique(s) (e.g. machine learning, etc.) may be used to detect a body part (hand, arm, face, leg) and associate all body parts with exposed skin such that contrast correcting (according to the texture map) may be applied to the detected body part or parts. In one embodiment, a neural-network classification engine is configured to identify individual pixels as being affiliated with exposed skin of a body part. Pixels that are identified as being exposed skin may be aggregated into segments (regions), and the regions may be corrected (e.g., equalized, tone-mapped, etc.).

In one embodiment, a hierarchy of the scene may be built and a classification engine may be used to segment the scene. An associated texture map(s) may be generated from a scene segment(s). The texture map(s) may be corrected, rendered in place, and applied to such hierarchy. In another embodiment, the hierarchy may include extracting exposure values for each skin-exposed body part, and correlating the exposure values with a correction value based on the texture map.

In some embodiments, skin tone may be different based on the determined body part. For example, facial skin tone may differ from the hand/arm/etc. In such an embodiment, a 3D model including the texture map and the depth map may be generated and rendered to separately correct and/or equalize pixels for one or more of each different body part. In one embodiment, a reference tone (e.g., one of a number of discrete, known human skin tones) may be used as a basis for correction (e.g., equalization, tone mapping, hue adjustment) of pixels within an image that are affiliated with exposed skin. In other embodiments, correction/skin tone may be separately applied to different, visually non-contiguous body parts.

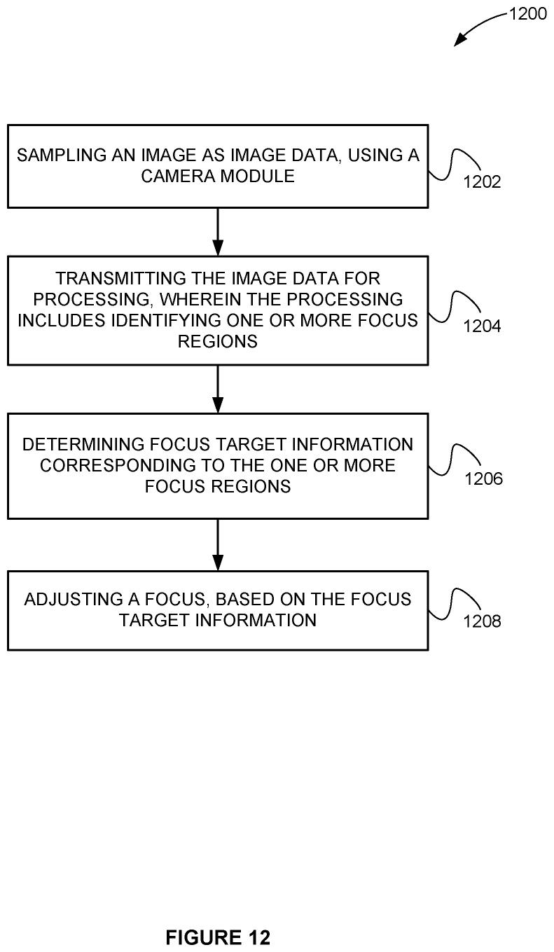

FIG. 12 illustrates an exemplary method 1200 carried out for adjusting focus based on focus target information, in accordance with one possible embodiment. As an option, the exemplary method 1200 may be implemented in the context of the details of any of the Figures. Of course, however, the exemplary method 1200 may be carried out in any desired environment.

As shown, an image is sampled as image data, using a camera module. See operation 1202. Additionally, the camera module may transmit the image data to an application processor. In the context of the present description, such image data includes any data associated with an image, including voltages or currents corresponding to pixel intensity, and data resulting from analog-to-digital converters sampling voltages and/or currents. Furthermore, additional images may be sampled and added to the image data.

In one embodiment, the camera module may include an image sensor, a controller comprising interface circuitry for the image sensor (e.g., timing control logic, analog-to-digital conversion circuitry, focus control system circuitry, etc.) and interface circuitry for communicating with an application processor and/or SoC, a lens assembly, and other control electronics. Additionally, in another embodiment, the application processor may include an SoC or an additional integrated circuit (e.g., one or more memory chips).

In operation 1204, the image data is transmitted for processing, wherein the processing includes identifying one or more focus regions. In one embodiment, an SoC may be used to transmit the image data, and/or to process the image data. Additionally, in one embodiment, such a processing of the image data may include compressing the image data, at least in part, normalizing the image data, correcting and/or adjusting one or more parameters (e.g. white balance, color balance, exposure, brightness, saturation, black-points, mid-points, etc.) associated with the image data, or analyzing the image data. Further, analyzing the image data may include identifying one or more objects.

In one embodiment, identifying one or more focus regions may include identifying one or more objects (e.g., human faces), identifying a fixed region bounding a specified location, detecting edges within the image data (e.g., region boundaries), detecting changes in color or lighting, changes in viewing direction, changes in size or shape, grayscale matching, gradient matching, or changes in a histogram. Furthermore, identifying one or more focus regions may include executing an image classifier to identify objects within the image data. Moreover, in an embodiment, identifying objects may be used to match the image data with the identity of a person. For example, image data may be processed by an image classifier and/or one or more machine learning modules to identify a person, and more specifically to identify an authorized operator and/or occupant of vehicle 370 In some embodiments, identifying the person may include sending image data to a separate server to more accurately identify the person.

As such, in various embodiments, identifying one more persons may include, at one step, separating one image of a first person at one location comprising image data of a scene from another image of a second person at another location as contained within image data, and at another step, identifying the identity of the first person and the identity of the second person.

As such, the focus target information corresponding to the one or more focus regions is determined. See operation 1206. In the context of the present description, such focus target information includes any two dimensional (2D) coordinates, pixel image plane coordinates, integer pixel coordinates, normalized coordinates (e.g., 0.0 to 1.0 in each dimension), XY coordinates, or any other technically feasible coordinates within an orthogonal or non-orthogonal coordinate system. The coordinates may be represented using any technically feasible technique, such as a list or array of XY coordinates, or a bit map where the state of each bit map element represents whether a coordinate corresponding to the element is included as one of the coordinates. In one embodiment, a translation of coordinates may occur, including, for example, from 3D mapping to 2D mapping, from image sensor row and column mapping to image plane mapping, or from XY image coordinates to pixel image coordinates.

In one embodiment, the determination of the focus target information may be automatic. For example, based on the identification of one or more objects (e.g., one or more persons), it may be determined which object is closest to the camera module, and focus target information for that indicated closest object may be provided to the camera module as a focus region. Of course, in other embodiments, the settings associated with the camera module may be configured to establish a priority associated with object(s). For example, one or more faces may take collectively a higher priority score than an inanimate object in the background. As such, in various embodiments, the position, type (e.g. face), number, brightness, and coloring (e.g. known human skin tones) of the object(s), among other characteristics, may be used to establish a priority for the object(s). The priority may be used in setting a focus for the camera module. The priority may also be used to specify a set of focus distances for capturing different images in an image stack. The image stack may then be used for focus stacking to generate images having sharper overall focus for identifying objects (e.g., persons) in the generated images.

In an embodiment, more than one camera is used to photograph an object, and the data collected from each camera may collectively be used to assess the priority ranking of the identified object(s). For example, a first person may be standing near vehicle 370, while a second person may be standing at a distance from vehicle 370. Continuing the example, a first camera within vehicle 370 captures an image of the first person and the second person. However, based on just the position of the first person it may not be automatically determined that the first person should be in focus. Receiving input from multiple cameras, may allow a processing system within vehicle 370 to identify that the first person in a photo is consistently an object of interest. Furthermore, collective image data from multiple camera modules may be used to determine priority of object(s), such object priority may then be used to determine the focus target information of the object(s) automatically.

As shown, a focus is adjusted, based on the focus target information. See operation 1208. In one embodiment, the camera module may adjust focus of an optical lens assembly to focus at the focus target information (e.g. coordinates), which may be associated with a two-dimensional coordinate space of an active sensing region of an image sensor within the camera module. In one embodiment, the image sensor includes an array of focus pixels, each associated with a region identified by an XY coordinate. In one embodiment, the native resolution of the image sensor may be higher than the resolution of focus pixels embedded within the image sensor, and a given XY coordinate may be mapped to one or more of the focus pixels embedded within the image sensor. For example, an XY coordinate may be positioned between two or more focus pixels and mapped to a nearest focus pixel. Alternatively, the XY coordinate may be positioned between two or more focus pixels and a weight or priority may be applied when focusing based on the two or more focus pixels to achieve focus at the XY coordinate. In certain embodiments, information from a collection of focus pixels associated with a focus region is aggregated to generate a focus estimate (e.g., according to a cost function) for the focus region (or multiple focus regions). In an embodiment, adjusting the focus may involve physically moving one or more lenses into a target focus position or adjusting an electrical focus signal (e.g., voltage level) to control an optical element having an electrically-variable index of refraction into a target focus configuration.

In an embodiment, system 700 identifies critical items in a scene, such as face for authentication, but also dangerous objects such as a gun, a knife, a raised stick, and so forth. The system 700 then indicates the critical items as target focus positions. Furthermore, system 700 may record video footage with the target focus positions for potential forensic purposes.

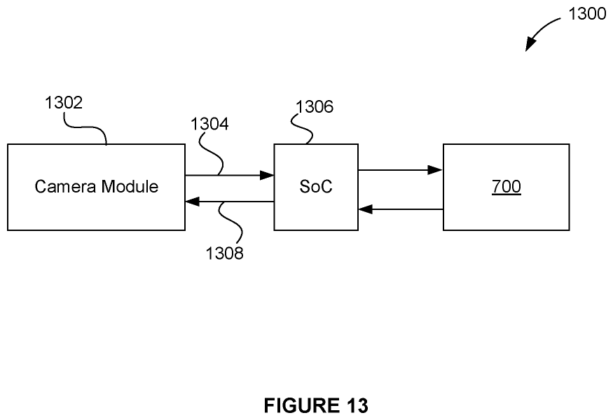

FIG. 13 illustrates an exemplary system 1300 configured to adjust focus based on focus target information, in accordance with one embodiment. As an option, the exemplary system 1300 may be implemented in the context of the details of any of the Figures. Of course, however, the exemplary system 1300 may be implemented in any desired environment. Further, the aforementioned definitions may equally apply to the description below.

As shown, a camera module 1302 transmits image data 1304 to SoC 1306. In one embodiment, based on the received image data, the SoC 1306 may identify one or more objects in the image data, and may determine focus target information (e.g. coordinates) associated with the identified one or more objects. Further, the SoC 1306 may transmit the focus target information 1308 back to the camera module 1302 which may then adjust the focus based on the focus target information indicated by the SoC 1306. In an embodiment, the SoC 1306 is configured to identify human faces within the image data 1304 and specify the location(s) of one or more human faces as focus targets within the focus target information 1308. The location(s) may be specified according to any coordinate system associated with the image data 1304. In an embodiment, an instance of a user ID sensor 372 comprises an instance of camera module 1302. In an embodiment, an instance of a user ID sensor 372 may additionally comprise an instance of SoC 1306. In certain embodiments, SoC 1306 is packaged in an enclosure with camera module 1302.

In an embodiment, the SoC 1306 may be configured to identify a specific person associated with one or more of the human faces. The identified person may be an authorized operator or occupant (e.g. passenger) of vehicle 370. In such an embodiment, identity information for the identified person is transmitted to system 700, which may respond accordingly (e.g., using one or more of the methods described herein).

In another embodiment, the SoC 1306 may be used to generate image data that is transmitted to system 700 for processing. The image data may include still and/or video frames with focus target locations identified by the SoC 1306 and focus maintained by the camera module 1302. In an embodiment, once focus target information is identified (either by SoC 1306 or system 700), the SoC 1306 may transmit the focus target information 1308 back to the camera module 1302, which may then continuously adjust the focus based on the focus target information indicated by the SoC 1306.

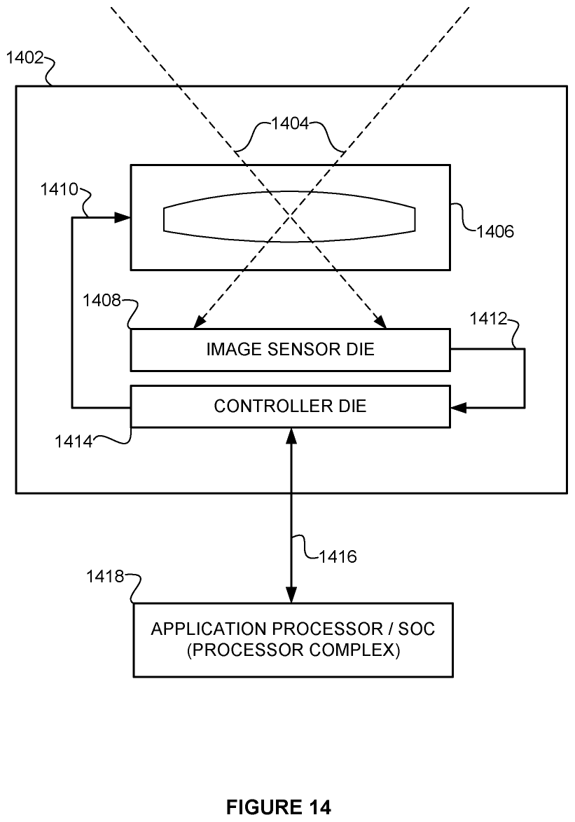

FIG. 14 illustrates a camera module 1402 in communication with an application processor 1418, in accordance with an embodiment. As an option, the camera module 1402 may be implemented in the context of the details of any of the Figures disclosed herein. Of course, however, the camera module 1402 may be implemented in any desired environment. Further, the aforementioned definitions may equally apply to the description below.

As shown, the camera module 1402 may be in communication 1416 with application processor 1418. Additionally, the camera module 1402 may include lens assembly 1406, image sensor die 1408, and controller die 1414. The image sensor die 1408 may receive optical scene information 1404 from the lens assembly 1406. Further, the image sensor die 1408 may be in communication 1412 with the controller die 1414, and the controller die 1414 may be in communication 1410 with the lens assembly 1406, and may be further in communication 1416 with application processor 1418. In one embodiment, application processor 1418 may be located outside a module housing of the camera module 1402.

As shown, the lens assembly 1406 may be configured to focus optical scene information 1404 onto image sensor die 1408 to be sampled. The optical scene information may be sampled by the image sensor die 1408 to generate an electrical representation of the optical scene information. The electrical representation may comprise pixel intensity information and pixel focus information, which may be communicated from the image sensor die 1408 to the controller die 1414 for at least one of subsequent processing (e.g., analog-to-digital processing) and further communication to application processor 1418. In another embodiment, the controller die 1414 may control storage of the optical scene information sampled by the image sensor die 1408, and/or storage of processed optical scene information comprising the electrical representation.

Further, in various embodiments, the lens assembly 1406 may be configured to control the focus of the optical scene information 1404 by using a voice coil to move an optical element (e.g., a lens) into a focus position, a variable index (e.g. liquid crystal, etc.) optical element, or a micro-electromechanical systems (MEMS) actuator to move an optical element into a focus position. Of course, in other embodiments, any technically feasible method for controlling the focus of a lens assembly may be used. In one embodiment, controller die 1414 includes a focus control system (not shown) comprising circuitry for evaluating the pixel focus information from image sensor die 1408 and communicating (transmitting) focus adjustments (represented as a focus signal) to lens assembly 1406 to achieve a focus goal based on focus region information transmitted from application processor 1418 to the controller die 1414. The focus adjustments may be determined based on a focus estimate value calculated according to techniques disclosed herein or, alternatively, calculated according to any technically feasible techniques. The focus adjustments may include a focus adjustment direction and focus adjustment magnitude, both based on the focus estimate and, optionally, at least one previous focus estimate and one corresponding focus adjustment. In another embodiment, image sensor die 1408 includes the focus control system. In still yet another embodiment, a separate die (not shown) includes the focus control system. In an alternative embodiment, application processor 1418 includes at least a portion of the focus control system.

In one embodiment, camera module 1402 comprises camera module 330 and image sensor die 1408 comprises image sensor 332. In such an embodiment, the controller die 1414 may enable a strobe unit, such as strobe unit 336 of FIG. 3A, to emit strobe illumination 350. Further, the controller die 1414 may be configured to generate strobe control signal 338 in conjunction with controlling operation of the image sensor die 1408. In other embodiments, controller die 1414 may sense when strobe unit 336 is enabled to coordinate sampling a flash image in conjunction with strobe unit 336 being enabled.

In certain embodiments, the image sensor die 1408 may have the same capabilities and features as image sensor 332, the controller die 1414 may have the same capabilities and features as controller 333, and application processor 1418 may have the same capabilities and features as application processor 335.

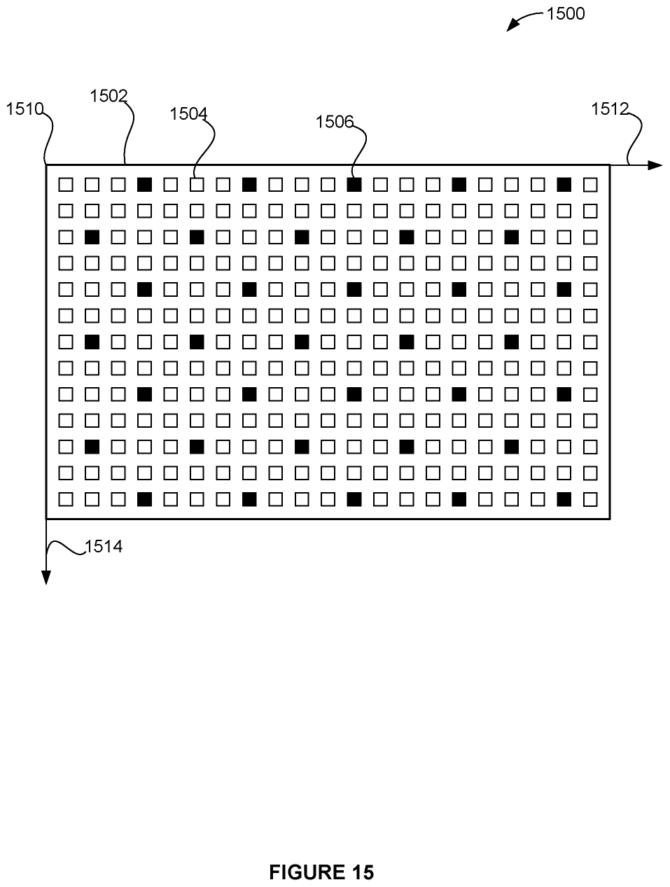

FIG. 15 illustrates an array of pixels 1500 within an image sensor 1502, in accordance with one embodiment. As an option, the array of pixels 1500 may be implemented in the context of the details of any of the Figures disclosed herein. Of course, however, the array of pixels 1500 may be implemented in any desired environment. Further, the aforementioned definitions may equally apply to the description below.

As shown, an image sensor 1502 (e.g., image sensor die 1408, image sensor 332) may include color pixels, indicated as white squares, and focus pixels, indicated as black-filled squares. For example pixel 1504 is a color pixel and pixel 1506 is a focus pixel. Each color pixel senses light intensity (e.g., red, green, and blue components). Each focus pixel senses focus, and may also sense light intensity. In one embodiment, each pixel is a focus pixel, configured to sense both color and focus. In another embodiment, as currently shown in FIG. 15, only a subset of pixels may be used as focus pixels.

The array of pixels 1500 may be organized according to a coordinate system, having an origin 1510, a row dimension 1514, and a column dimension 1512. A given pixel within image sensor 1502 may be uniquely identified based on corresponding coordinates within the coordinate system. The coordinates may include an integer address along a given dimension. Alternatively, normalized coordinates may identify a point or region within the coordinate system. While one orientation of an origin and different dimensions is illustrated, any technically feasible orientation of an origin and dimensions may be implemented without departing the scope of the present disclosure.

In various embodiments, image sensor 1502 may include one of a front-lit image sensor, a back-lit image sensor, or a stacked color plane (all color pixels) in combination with a focus plane (all focus pixels) sensor die. In the context of the present description, a focus pixel is a pixel which is used at least for focusing and may also provide color or intensity information. For example, in one embodiment, a given coordinate (e.g., as indicated by a SoC) may correspond with a focus pixel, which is used as the basis for focusing optical information onto image sensor 1502. Additionally, in various embodiments, focusing may include sensing contrast (e.g. contrast detection), sensing focus points (e.g. phase detection, etc.), or a combination or hybrid of one or more known techniques.

In some embodiments, light entering a lens (e.g., lens assembly 1406 of FIG. 14) and focused onto image sensor 1502 may arrive at a focus pixel, which may comprise a first and second photodiode (or potentially any greater number of photodiodes). Incident light at the focus pixel may arrive at different phases depending on incident angle. A phase difference detection structure provides a difference in photodiode current between the first and second photodiode when light arriving at the photodiodes is not in focus. Furthermore, the sign of the difference in current may indicate whether to adjust focus closer or further to achieve focus at the focus pixel. Each of the first and second photo diode currents may be integrated over an exposure time by an associated capacitive structure. A voltage at each capacitor provides an analog signal that may be transmitted, either as a voltage or as a current (e.g., through a transconductance circuit at the capacitor), to an analog readout circuit. Differences in the analog signal may indicate whether incident light is in focus, and if not in focus then in which direction the lens needs to be adjusted to achieve focus at the focus pixel. Difference measurements to assess focus may be performed in an analog domain or digital domain, as an implementation decision.

Of course, various embodiments may also include any number of focus pixels. Applying the techniques set forth herein, focus for the image sensor may be adjusted according to focus information associated with a selected focus pixel or focus pixels. Additionally, the image sensor may implement aspects of the adjustment of focus associated with one or more focus pixels, wherein the implementation includes determining whether the focus pixel indicates a focus condition and the camera module adjusting the lens assembly so that the focus is corrected with respect to the focus pixel. The camera module may receive focus target information (e.g. coordinates, such as those communicated to controller die 1414) that are associated with one or more focus pixels and adjust lens assembly 1406 to achieve focus at the one or more focus pixels. In this manner, camera module 1402 may implement a closed loop focus control system for focusing images captured by the camera module. In such embodiments, focus target information comprising a given focus point, region, or weight mask may be used to specify a focus target for the focus control system. The focus target information may be provided to the focus control system by application processor 1418. In one embodiment, the controller die 1414 includes circuitry configured to implement the focus control system, and application processor 1418 is configured to transmit focus target information to the focus control system. The focus control system may respond to receiving focus target information and/or a focus command by adjusting lens assembly 1406 to focus optical scene information 1404 onto the image sensor, in accordance with the focus target information. The focus control system may generate a focus signal and transmit the focus signal to lens assembly 1406 to perform focus adjustments. The focus signal may represent focus and/or focus adjustments using any technically feasible techniques. In one embodiment, the focus signal may be represented as an electrical signal (e.g., voltage or current level) that directly drives an actuator for adjusting a lens position within lens assembly 1406 into a focus position. In another embodiment, the electrical signal drives a variable index optical element to adjust focus. In yet another embodiment, the focus signal may encode a digital focus value used by the lens assembly to adjust focus, such as by driving an actuator or variable index optical element.

In one embodiment, an application processor (e.g., application processor 1418) may provide focus target information comprising a point, a point with a radius, a point with a radius and a weight profile, a region of weights around a point of interest, or a weight mask, such that the identified focus target information (of where to focus) has been determined. A given weight (focus weight) may provide a quantitative indication of how much influence focusing at an associated focus target and/or pixels within a region at the focus target should have in an overall focus distance for the camera module. Once such a focus location/focus target determination is completed, the camera module may then proceed with independently adjusting the focus associated with the focus target information as given by the application processor. Adjusting the focus may proceed as a sequence of focus adjustment iterations, wherein at each iteration a focus estimate is generated based on focus target information and measured focus information; the focus control system then adjusts focus according to the focus estimate. Focus adjustment may be continuous and independently performed within a control loop driven by the controller die 1414. As used herein, the term “continuous” includes quasi-continuous implementations having quantized time (e.g., based on a digital clock signal) and/or quantized focus adjustment (e.g., resulting from a digital to analog converter).

Further, in certain embodiments, a focus pixel(s) may be implemented as one channel (e.g. green) of an R-G-G-B (red-green-green-blue) pixel pattern. Of course, any of the color channels, including a color channel having a different color than red, green, or blue may be used to make a focus pixel. A given focus region may have focus target information that corresponds to a given focus pixel or set of focus pixels.

In another embodiment, every pixel may function as a focus pixel and include at least two photodiodes configured to detect a phase difference in incident light. In such an embodiment, each pixel may generate two intensity signals for at least one intensity sample (e.g., one of two green intensity samples), wherein a difference between the two intensity signals may be used for focus, and one or a combination of both of the intensity signals may be used for color associated with the pixel.

Still yet, in another embodiment, a camera module may include dual photo detecting planes, one for focusing and another for creating an image. As such, a first photo detecting plane may be used to focus and a second photo detecting plane may be used to create an image. In one embodiment, the photo detecting plane used for focusing may be behind the first photo detecting plane (e.g. which gathers color, etc.).

In one embodiment, one or more selected focus pixels residing within image sensor die 1408 provide focus information (e.g., phase difference signals) to circuits comprising a focus control system (not shown) residing within controller die 1414. The one or more selected focus pixels are selected based on focus target information (e.g. coordinates) associated with focus regions identified by application processor 1418. Various techniques may be implemented by the application processor 1418 to identify the focus regions, the techniques including, without limitation, automatically identifying objects within a scene using image classifiers, which may be implemented using a neural network inference engine. In an embodiment, focus regions are preferentially selected to identify human faces as focus targets, and a given human face may be further classified according to whether the face is associated with an authorized operator or occupant of a vehicle (e.g., vehicle 370). For example, a user ID sensor 372 may include an instance of camera module 1402, with focus and/or exposure targets preferentially selected to be human faces within a scene visible to the camera module 1402. In another embodiment, vehicle occupant gaze (e.g., observed from user ID sensors 372) is analyzed to determine gaze directionality and focus and/or exposure for at least one external camera (e.g., a self-driving sensor 374) is directed according to the occupant gaze. Furthermore, the system 700 may allocate real-time image processing and/or inference engine resources to analyzing a portion of the scene indicated by the occupant gaze; in this way, system 700 may leverage the environmental awareness of human occupants to provide additional environmental analysis and potentially additional safety for the vehicle.

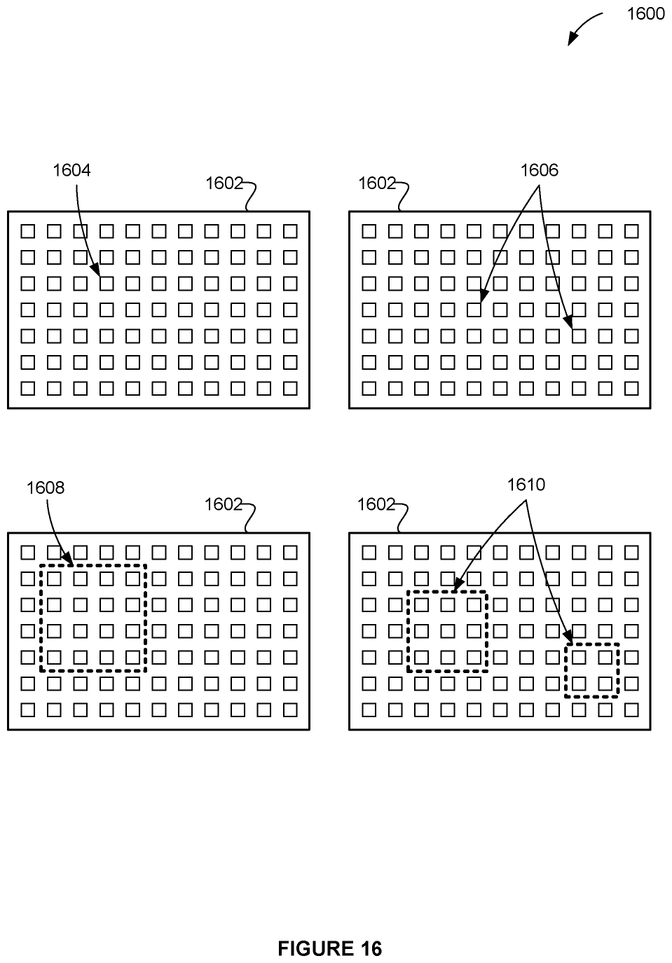

FIG. 16 illustrates arrays of focus pixels and focus regions 1600 within an image sensor 1602, in accordance with an embodiment. As an option, arrays of focus pixels and focus regions 1600 may be implemented in the context of the details of any of the Figures disclosed herein. Of course, however, arrays of focus pixels and focus regions 1600 may be implemented in any desired environment. Further, the aforementioned definitions may equally apply to the description below.

As shown, image sensor 1602 (e.g., image sensor die 1408, image sensor 1502, image sensor 332) may have focus information specified as a focus point 1604, focus points 1606, focus region 1608, and/or focus regions 1610. Any pixels (e.g., at focus point 1604, at focus points 1606, or within focus regions 1608, 1610, etc.) within the image sensor may be configured to be focus pixels. In one embodiment, a focus point (or points) is a specific pixel(s) that is selected as a focus pixel. In another embodiment, a focus region (or regions) may include a collection of many pixels (e.g. a N×M pixel region), wherein at least some of as the pixels are focus pixels. Each pixel may have an associated point location or pixel point.

Additionally, in one embodiment, a focus region(s) may include one or more implicit or explicit weights. Further, various shapes (e.g. a circular shape) may define a focus region. For example, a circular region (rather than an N×M rectangular region or N×N square region) may be implemented by assigning weights of 0 to portions of an N×N region not covered by an inset circular region within the N×N region.

In various embodiments, the focus point(s) and/or focus region (s) may be defined by identifying regions that include a human face. For example, in one embodiment, a human face may be identified as a focus target by the application processor 1418 (or system 700), and the application processor 1418 may specify that focus target as focus target information for a region at the human face. A camera module (e.g. camera module 1402, camera module 330) may be directed to continuously maintain focus at the target based on the focus target information. If the face moves, the focus target information may be updated and the camera module directed to continuously maintain focus at an updated location. In an embodiment, a human face is tracked with focus target information periodically updated, so that the object is continuously tracked by the application processor 1418 and the camera module continuously keeps the image information associated with the object focus target information (e.g. coordinate(s)) in focus. In this manner, the application processor 1418 (e.g. SoC, etc.) performs object tracking and/or pixel flow tracking to continuously track and update a focus region or regions, and the camera module maintains continuous focus based on focus target information and/or coordinates associated with the continuously updated focus region or regions.

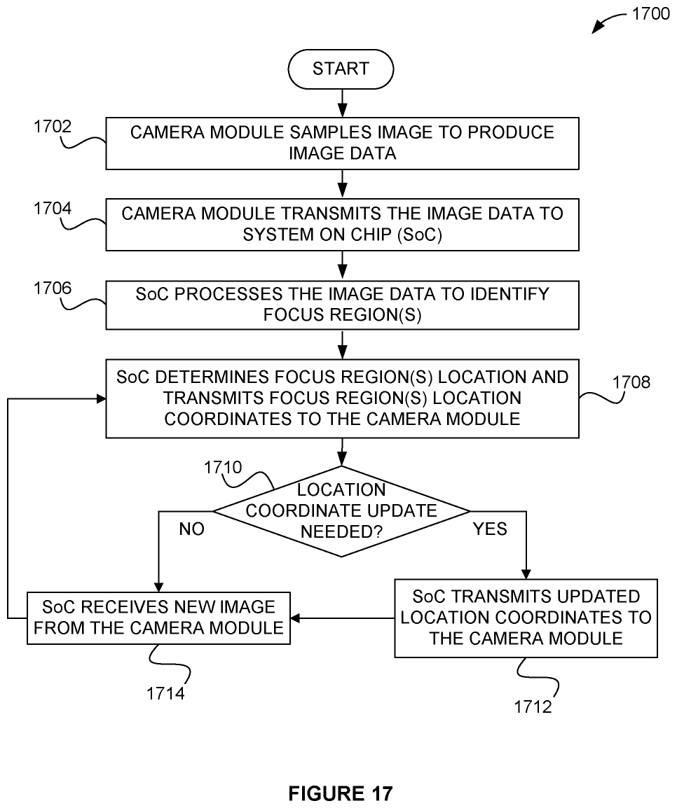

FIG. 17 illustrates a method 1700 for adjusting focus based on focus target information, in accordance with an embodiment. As an option, the method 1700 may be implemented in the context of the details of any of the Figures disclosed herein. Of course, however, the method 1700 may be implemented in any desired environment. Further, the aforementioned definitions may equally apply to the description below.

As shown, a camera module (e.g. camera module 1402, camera module 330) samples an image to produce image data. See operation 1702. In one embodiment, the image data may include multiple frames. Additionally, the camera module transmits the image data to an SoC. See operation 1704. Of course, in other embodiments, the camera module may transmit the image data to any type of application processor.

In operation 1706, the SoC processes the image data to identify focus region(s). Next, the SoC determines a focus region(s) location, and transmits the focus region(s) location coordinates to the camera module. See operation 1708. Next, it is determined whether a location coordinate update is needed. See decision 1710. If it is determined that a location coordinate update is needed, the SoC transmits updated location coordinates to the camera module. See operation 1712. If it is determined that a location coordinate update is not needed or after the SoC transmits updated location coordinates to the camera module, the SoC receives a new image from the camera module. See operation 1714. After the SoC receives the image from the camera module, the method returns to operation 1708.

In one embodiment, when the SoC processes the image data to identify object(s), the SoC may also determine which object(s) have the greatest likelihood of being the object of focus. In one embodiment, a known object (e.g., a human face) may have a priority ranking that is higher than another identified object. For example, a photo may include a human face that is close to the camera module and human face that is distant from the camera module. Both faces may be associated with a ranking score such that the priority is given to the closer face to ensure that the more relevant face is in focus. In some embodiments, a sweep of multiple images may be captured such that any object which is identified may be separately focused and captured, and a resulting image may be generated using focus stacking over the multiple images.

In another embodiment, the SoC may have a library of stored information to assist in identifying a face and furthermore, a specific person. For example, information relating to a generic eye, nose, or mouth, may assist with determining that a face is present in the image. Additionally, descriptive details and/or training data for the specific person may also be stored and used for identifying a specific person (e.g., an authorized operator or occupant of vehicle 370).

Further, in one embodiment, multiple objects may be identified. For example, in one embodiment, a photo may include ten individuals with ten corresponding separate faces. In one embodiment, ten separate captures may be obtained with a separate focus for each face, with each of the captures having a designated face in focus. An image stack may then be blended such that each of the ten faces is in focus. In such an embodiment, the captured photos may be obtained in a rapidly-sequenced acquisition, wherein any lag-time is minimized to prevent any distortion (e.g. blurring) in a resulting image. In one embodiment, an alignment step may be performed to ensure that all of the images being blended are aligned properly, at least at their respective focus points of interest, and an intensity and/or color normalization may be performed to ensure that lighting and color is consistent from one captured image to the next during a blend operation.

In one embodiment, fast, low latency focus performed by hardware within the camera module may allow for more precise image focus and/or stabilization. One advantage of a low latency focus control loop provided within the camera module is crisper, cleaner images with better detail. Such detail may provide more accurate identification of specific people within a database of authorized vehicle operators/occupants.

Additionally, in one embodiment, tracking object location in the SoC and adjusting the focus in the camera module may improve focus in capturing video footage. For example, objects frequently will move as a video is recorded. However, the SoC only needs to track the object (e.g. identified automatically) and transmit the location coordinates as focus target(s) to the camera module, wherein once the location coordinates change, the camera module can respond by providing continuous focus at the new focus target(s).

In one embodiment, in an image sensor having a Bayer red-green-green-blue filter per pixel, one or more of the two green channels at each pixel may implement a focus pixel configured to provide two or more focus detection outputs. This first green channel may be referred to herein as a focus channel. In alternative embodiments, a different filter color including clear may be selected for the focus channel. The remaining red, green, and blue channels at each pixel may be referred to herein as image channels. Each pixel therefore may provide two or more samples (phase detection samples) of focus channel information, and three or more channels (red, green, blue intensity) of image channel information. The image sensor may include a two-dimensional (2D) array of pixels, and focus channel information associated with the 2D array of pixels may be referred to herein as a focus array, while corresponding image channel information may be referred to herein as an image array. Focus points, focus regions, focus maps, and coordinates associated thereto may be mapped to a 2D extent of the image array. In certain embodiments, focus pixels are more sparsely distributed over the image sensor, but a comparable coordinate mapping may nonetheless be made.

In one embodiment, the focus array and image array are sampled (exposed) concurrently. In such an embodiment, intensity information sampled by the focus array may be blended with image data sampled by the image array. For example, the focus array intensity information may be added together and treated as a second green channel per pixel. In another embodiment, the focus array may be exposed for a longer duration or a shorter duration than the image array. For example, the focus array may be exposed for a longer exposure time than the image array in a low-light setting for better focus performance, but the image array may be sampled for a shorter exposure time at a higher sensitivity (ISO) to reduce shake, while accepting image chromatic noise as a quality trade off.

In one embodiment, exposure time and sensitivity for the focus array may be metered to achieve balanced exposure (“EV 0”) over a whole scene. Alternatively, exposure time and sensitivity for the focus array may be metered to achieve balanced exposure within one or more regions while generally excluding regions outside the focus regions.

In certain embodiments, the image array includes two or more analog storage planes, each having separately configured exposure time and/or sensitivity from the other. Furthermore, the exposure time and timing for each analog storage plane may be independent of the exposure time and timing of the focus array. In certain embodiments, image channel and focus channel circuits for each pixel include two photodiodes, and two analog sampling circuits. Furthermore, in focus channel circuits, one of the two analog sampling circuits is configured to integrate current from one of the two photodiodes to generate a first analog intensity sample, and the other of the two analog sampling circuits is configured to integrate current from the other of the two photodiodes to generate a second analog intensity sample. In image channel circuits, both photodiodes may be coupled together to provide a photodiode current to two different analog sampling circuits; the two different analog sampling circuits may be configured to integrate the photodiode current independently. The two different analog sampling circuits may integrate the photodiode current simultaneously and/or separately. In other words, intensity samples associated with the focus channel should be integrated simultaneously to generate focus information at the pixel, while intensity samples associated with the image channel may be integrated independently to generate independently exposed intensity samples.

In certain embodiments, an image sensor includes a 2D array of pixels, wherein each pixel includes an analog sampling circuit for capturing focus information and two or more analog sampling circuits per color channel for capturing image information (e.g., two or more analog sampling circuits for each of red, green, blue). In such embodiments, a first analog storage plane comprises instances of a first of two or more different analog sampling circuits at corresponding pixels within the array and associated with the image channel, and a second analog storage plane comprises instances of a second of two or more different analog sampling circuits at the pixels and also associated with the image plane. In certain embodiments, readout circuits for selecting and reading rows of image channel samples may be configured to also select and read rows of focus channel samples.

Still yet, in certain related embodiments, an ambient image (strobe unit turned off) may be captured within the first analog storage plane and a flash image (strobe unit turned on) may be captured within the second analog storage plane. Capture of the ambient image and the flash image may be non-overlapping in time or overlapping in time. Alternatively, two flash images may be captured in each of the two different analog storage planes, with each of the two flash images having different exposure times. In such embodiments, the camera module may be configured to establish focus based on specified focus points and/or regions (focus information), with or without the strobe unit enabled.

Still yet, in one embodiment, the camera module is directed to capture a flash image based on specified focus information. In response, the camera module may perform exposure metering operations to establish an appropriate exposure for at least focus pixels and subsequently proceeds to achieve focus based on the focus information. The camera module then captures the flash image after focus is achieved. Capturing the flash image may proceed once the focus control system has achieved focus, and without waiting for the SoC or application processor, thereby reducing power consumption and shutter lag. In one embodiment, the camera module captures a sequence of flash images after focus is achieved. Each flash image in the sequence of flash images may be captured concurrently with an accelerometer measurement that captures camera motion as an estimate for image blur. A flash image with minimal estimated image blur is stored and/or presented to a user, while the other flash images may be discarded.

Still yet, in another embodiment, the camera module is directed to capture an image stack of two or more images, the images corresponding to available analog storage planes within the camera module image sensor. Each of the two or more images may be an ambient image, a flash image, or a combined image. Each of the two or more images may be specified according to focus information and/or exposure information. Capture of each image may overlap or not overlap with the capture of other images in the image stack. Capturing the image stack may proceed once the focus control system has achieved focus, and without waiting for the SoC or application processor.

In one embodiment, a first camera module comprises an image sensor configured to include at least one focus pixel, and may include a focus array, while a second camera module comprises an image sensor that does not include a focus array. The first camera module and the second camera module may be included within the same device, such as user ID sensors 372 and/or self-driving sensors 374. The first camera module may be configured to perform focus operations described herein, while the second camera module may be configured to operate in a tracking mode that dynamically tracks a focus distance determined by a focus control system within the first camera module.

In one embodiment, a user ID sensor 372 and/or a self-driving sensor 374 includes two or more camera modules, each configured to independently maintain focus on a respective focus region or regions provided by an SoC (or any other form of application processor) coupled to the two or more camera modules. The two or more camera modules may be substantially identical in construction and operation, and may be mounted facing the same direction. When the SoC identifies two or more focus regions, each of the two or more camera modules may be configured to separately maintain focus on different, assigned objects within the scene. The two or more camera modules may capture two or more corresponding images or video footage, each having independent focus. The two or more previews, images, and/or video footage may be processed according to any technically feasible focus stacking techniques to generate a single image or sequence of video footage. Each of the two or more images, and/or video footage may undergo an alignment procedure to be aligned with a reference perspective. Said alignment procedure may be implemented as at least an affine transform based on camera placement geometry within the mobile device and/or focus distance from the mobile device. In one embodiment, the affine transform is configured to generally align view frustums of the two or more camera modules. In certain embodiments, one or more images from one of the two or more camera modules serve as a reference and image data from different camera modules of the two or more camera modules is aligned and/or blended with the reference image or images to produce still images, and/or video footage.

The focus control system may be implemented within a controller (e.g., controller 333 of FIG. 3D or controller die 1414 of FIG. 14) that is coupled to the image sensor, wherein both the image sensor and the controller may reside within the camera module. The controller may include a readout circuit comprising an array of analog-to-digital converter circuits (ADCs) configured to receive analog intensity signals from the image sensor and convert the analog intensity signals into a corresponding digital representation. Each pixel may include a red, green, and blue (or any other combination of color) analog intensity signal that may converted to a corresponding digital representation of red, green, and blue color intensity for the pixel. Similarly, each focus channel of each focus pixel includes at least two phase detection analog signals that may be converted to digital representations.

In one embodiment, each focus pixel generates two phase detection samples by integrating each of two different photodiode currents from two different photodiodes within a phase difference detection structure. A difference signal generated by subtracting one phase detection signal from the other indicates relative focus at the focus pixel. If the sign of the difference signal is positive, then the incident optical information is out of focus in one direction (e.g., focus plane is above photodiodes); if the sign is negative then the incident optical information is out of focus in the opposite direction (e.g., focus plane is below photodiodes). That is, the sign of the difference signal determines whether the camera module should adjust focus distance closer or further to achieve focus at the focus pixel. If the difference signal is below a predefined threshold, then the incident optical information may be considered to be in focus at the focus pixel.

In one embodiment, analog intensity information for the focus plane and the image plane are transmitted from an image sensor within the camera module (e.g. image sensor die 1408) to a controller within the camera module (e.g., controller die 1414). The controller performs analog-to-digital conversion on the analog intensity information. In such an embodiment, the difference signal at each focus pixel is computed as a digital domain subtraction or comparison operation. A digital representation of the analog intensity information may be transmitted from the controller to the SoC, or to any other technically feasible application processor. The digital representation may include image array information, focus array information, or a combination thereof.

In a different embodiment, the difference signal at each focus pixel is generated as a digital domain result of an analog domain subtraction or an analog domain comparison operation during row readout of associated focus pixels. For example, in one embodiment, an analog comparator circuit is coupled to each of two phase detection samples for a given pixel within a row. The comparator circuit may be configured to generate a digital domain “1” when the difference signal is positive and a digital domain “0” when the difference signal is negative. When the comparator output transitions from 1 to 0 or 0 to 1 in response to a focus adjustment, the focus adjustment has likely overshot an optimal focus distance. The focus control system may then may an opposite, smaller focus adjustment to converge focus. The comparator circuit may implement a specified hysteresis threshold, so that when a first fine focus adjustment causes the comparator output to transition and a second fine focus adjustment in the opposite direction does not cause a transition, then incident optical information at the focus pixel may be considered in focus because the difference signal is below the hysteresis threshold. Furthermore, a plurality of comparators may be included in either the image sensor or the controller, the plurality of comparators configured to concurrently generate difference signals for a row of focus pixels. Alternatively, using half the number of comparators, difference signals for a first half of the focus pixels may be generated and stored in a first sampling cycle and difference signals for a second half of the focus pixels may be generated and stored in a second sampling cycle. Other analog domain focus estimation techniques may also be implemented without departing the scope of embodiments disclosed herein.

More generally, the focus control system within a camera module may selectively sample digital domain difference signals to adjust focus distance for the camera module based on a given focus cost function. The digital domain difference signals may be generated using any technically feasible technique, such as the above techniques that implement a subtraction or comparison operation in either a digital or analog domain. The selective sampling may be directed by focus points, focus maps, focus regions, or any other focus specification transmitted to the controller within the camera module. Selective sampling may include sampling only certain difference signals to generate a focus estimate or multiplying each difference signal by a specified weight and generating a focus estimate from resulting multiplication products. In certain embodiments, the multiplication products may be signed.

In one embodiment, the focus control system implements a weighted sum cost function to generate a focus estimate. In such an embodiment, the focus control system may accumulate weighted focus information during frame readout. For example, during a readout time for a given row in a sequential row readout process, digital domain difference signals for each focus pixel may be multiplied by a corresponding weight associated with focus region information previously transmitted to the camera module. Each multiplication result may be added to others in the row to generate a row focus estimate, and row focus estimates for a complete frame may be added together to calculate a frame focus estimate. In certain embodiments, the frame focus estimate may be normalized to a specific range to generate a normalized frame focus estimate. For example, the normalized frame focus estimate may be calculated by multiplying the frame focus estimate by a reciprocal of the sum of focus weights. A given frame focus estimate or normalized frame focus estimate may comprise a discrete sample of a discrete time feedback signal used by the focus control system to maintain focus. In one embodiment, a lower absolute value (magnitude) for the frame focus estimate indicates better focus and a higher magnitude indicates worse focus. In general, the focus control system may be configured to minimize magnitude of the frame focus estimate.

In one embodiment, each digital difference signal is generated by a comparator configured to compare analog phase detection samples for a corresponding focus pixel as described previously. With only one comparator generating a difference signal, only focus excursions in one direction are known to produce out of focus results (e.g. positive difference signal), while focus excursions that pass through zero are not known to be in focus or out of focus in a negative direction. In such an embodiment, the focus control system may adjust focus to achieve a minimum magnitude for frame focus estimates, but avoid focus adjustments that may pass through zero to avoid overshooting focus in the negative direction.

In alternative embodiments, two comparators may be used to generate each digital difference signal, which may include two values; a first value indicates if the difference signal is positive, while the second value indicates if the difference signal is negative. The two comparators may be configured to have a known offset that is non-zero but sufficiently small to that when both comparators report a “0” output, the focus pixel may be considered to be in focus and an associated focus pixel contributes a zero value to a frame focus estimate. When one of the comparators indicates a “1” value, this 1 may be multiplied by a focus weight assigned to the focus pixel coordinate and result in a positively signed contribution to the frame focus estimate. When the other comparator indicates a “1” value, this may be multiplied by a negative of the focus weight and result in a negatively signed contribution to the frame focus estimate.

Embodiments of the present disclosure may provide a focus estimate for a frame immediately after readout for the frame completes. Immediate availability of a complete focus estimate allows the focus control system to begin adjusting focus immediately after a frame readout completes, thereby reducing perceived lags in focus tracking. Furthermore, with the focus control system implemented on the controller within the camera module, less overall system power consumption may be necessary to maintain a specific focus response time as less data needs to be transmitted to the SoC for focus maintenance. By contrast, conventional systems require additional time and power consumption to maintain focus. For example, a conventional system typically transmits frames of image data, potentially including focus pixel data, to a conventional SoC, which then processes the image data to generate a focus estimate; based on the focus estimate, the conventional SoC then calculates an updated focus distance target and transmits the updated focus target to a conventional camera module, which receives the focus distance target and executes a focus adjustment. These conventional steps generally require more power consumption (reduced device battery life) and more execution time (increased focus lag) than embodiments disclosed herein.

In one embodiment, focus weight values are quantized as having a value of 0 or 1, so that any focus pixel within a focus region provides an equal contribution to a focus estimate and focus weights outside a focus region contribute a zero weight. Such a quantization of focus weights provides a relatively compact representation of a focus map, focus point, list of focus points, and the like. In other embodiments focus weight values are quantized to include multiple levels, which may include a weight of 0, a weight of 1, and weights between 0 and 1. In yet other embodiments, different quantization ranges may be implemented, including, without limitation, quantization ranges specified by fixed-point and/or floating-point representation.

A focus map may specify a 2D array of focus weights to be applied by the focus control system within the camera module when generating a focus estimate for maintaining focus. Each focus weight of the 2D array of focus weights may be mapped to a corresponding pixel location for the image sensor. In one embodiment, each focus weight of the 2D array of focus weights corresponds to a focus pixel within the image sensor in a one-to-one correspondence. In another embodiment, the 2D array of focus weights comprises a lower resolution set of focus weights than available focus pixels and focus weights for each focus pixel may be calculated by interpolation between focus weights specified by the 2D array of focus weights. Such interpolation may produce fractional or binary (1 or 0) focus weights used in conjunction with focus pixel digital domain difference signals to generate a focus estimate.

The focus point may comprise focus target information (e.g. coordinates) used to select a focus pixel within the image sensor. The focus point may define a location between focus points, and an appropriate fractional focus weight may be applied by the controller to two or four focus pixels bounding the location. Furthermore, the focus point may include a radius forming a geometric region (e.g., circle, square, etc.) about the focus point. Focus pixels within the geometric region may be assigned non-zero focus weights. The non-zero focus weights may be assigned 1, or a fractional value, such as according to a weight profile. A focus point list may include a list of coordinates, each operable as a focus point, with a focus estimate calculated over regions associated with the focus points in the list of focus points.

In certain embodiments, the camera module may provide a variable focus plane orientation so that the focus plane may be tilted. In one embodiment, a tilt lens comprising the camera module lens assembly may include two or more actuators configured to move at least one optical element into an arbitrary orientation relative to conventional planar alignment of optical elements in an optical path. For example, an optical element may be coupled to three independent actuators configured to position the optical element according to a specified plane orientation, which may be non-planar relative to other optical elements. As such, the lens assembly may implement focus operations analogous to that of a conventional tilt lens. However, in one embodiment, when two or more focus regions are specified, the camera module may orient the optical element (focus plane) to achieve focus over the two or more focus regions. For example, when two or more people are standing within a plane that is not normal to the camera module lens assembly, the focus plane may be tilted to include people at each focus extreme, thereby allowing the camera module to capture an image of the people with everyone generally in focus.

In one embodiment, determining focus information in video may include receiving location coordinate(s) associated with a first image frame, sending the coordinate(s) to camera module, and adjusting the focus associated with the coordinate(s) to a second (or subsequent) image frame. In this manner, focus information as determined for one image frame may be applied to one or more subsequent frames.

Still yet, in one embodiment, identifying an object (e.g. by the SoC) may include one or more triggers. For example, a trigger may include a movement, a sound, a disparity (e.g. change in color, brightness, intensity), etc. In one embodiment, such a trigger may be applied to security applications. For example, a security camera may be pointed to a scene, but the recording of the scene may be initiated based on satisfying a trigger (e.g. movement) as detected within the scene. Once movement is detected, then the SoC may track the moving object and send the corresponding coordinates to the camera module to adjust the focus.

Additionally, in another embodiment, once an object has been identified, then an intelligent zoom function may be enabled. For example, if movement has been detected, coordinates associated with the moving object may be captured and sent to the camera module which may then adjust the focus as well as automatically increase/decrease the zoom on the identified object. For example, in one embodiment, the SoC may determine that the moving object is a region of pixels. The camera module may zoom into an area immediately surrounding but encompassing the identified region of pixels by the SoC.

Still yet, in one embodiment, use of the SoC to identify and/or track objects and use of the camera module to adjust the focus, may also relate to multiple devices. For example, in one embodiment, a collection of drones may be used to track and focus on the same object. Additionally, images that are captured through use of such a system would allow for multiple angles and/or perspectives and/or zoom of the same object. Such a collection of aggregated images would also allow for augmented or virtual reality systems.

Further, use of such a system would allow for clearer immersive 360 degree capture and/or panoramic scenes, wherein multiple images may be stitched together in a manner where surrounding objects have a consistent focus. Additionally, in one embodiment, such a capture may also allow modifying the brightness, intensity, frame rate, sensitivity, so that when the images are stitched together, blurring and distortions are minimized between one image and another. As such, more effective focusing during capture may allow for more efficient post-processing work for captured images.

Still yet, in one embodiment, sweeping a scene with multiple focus points may allow for processor-defined focus points during post-processing. For example, a scene with multiple objects may be swept such that the focus for each identified object may be captured. An image set of all captured images may be compiled for the photographic scene such that during post-processing, a classifier (e.g., an inference engine) may define a point of focus and readjust the photo (after capture) to account for the change in focus.

In one embodiment, the focus target information transmitted to the camera module may include, without limitation, one of four coordinate types associated with a coordinate system that maps to a field of view for the camera module: 1) one or more point(s) in a list of points; 2) one or more point(s) with an implicit or specified radius around each point and/or weight profile for each point; 3) as one or more point(s) within a weight mask; and 4) as a 2D mask of values for each discrete location covered by the 2D mask. In one embodiment, one or more of such coordinate types may be saved as metadata associated with the image, thereby recording focus point information for the image. Further, such saved metadata may be reused as needed (e.g. fetched and applied) to other subsequently captured images and/or video footage.

In an embodiment, one or more point(s) comprising target locations for focus information may correspond with a specific one or more focus pixel point(s) having associated coordinates within the coordinate system. In another embodiment, the one or more point(s) may have a radius and/or a weight profile indicating a specific one or more focus pixel region(s). Still yet, in one embodiment, a weight profile may include a start point and an end point, with a predefined function to be applied between the two points. For example, in a coordinate including a point plus a radius, the radius may include a weight profile, wherein the weight profile determines the weights that are to be applied at each point along the radius. The radius may define a dimension of a geometric region (e.g., a circular, elliptical, or rectangular region) encompassing a point, wherein non-zero weights are defined within the region. Furthermore, an implicit or explicit weight profile may define weight values within the geometric region based on a radial distance from the point or based on a geometric relationship relative to the point. For example, a weight profile may define a weight of 1.0 at the point and a linear reduction in weight to a value of 0.0 at a distance of the radius. Persons skilled in the art will recognize that any and arbitrary weight profiles are also possible. In another embodiment, a weight mask includes a weight matrix, wherein the weight matrix includes a specific weight to be applied at each coordinate point. A weight mask provides a general and easily implemented construct for applying a set of focus weights at the camera module, while a point and weight profile may provide a less general but more compact representation for transmission to the camera module.

The weights, either explicitly stated by focus points or a weight mask, or implied by a radius and/or weight profile, establish a focus estimate contribution to a focus cost function. In one embodiment, the focus cost function serves to estimate how well a focus goal is presently being achieved. In certain embodiments, a focus control system residing within a controller die 1414 of FIG. 14 or within controller 333 of FIG. 3F receives one or more focus points and focus weights. The focus control system computes the focus cost function based on the focus points and focus weights. The focus control system then adjusts a lens (e.g., lens 331) in a direction appropriate to reducing the cost function. New focus information is available as focus is adjusted, and with each new adjustment focus pixels may be sampled again and a new focus cost function may be calculated. This process may repeat and continue for an arbitrary duration, with focus constantly and continuously being adjusted and updated. In one embodiment, the focus cost function is defined to be a sum of focus pixel phase difference values, each multiplied by a corresponding focus weight. Of course, other focus cost functions may also be implemented without departing the scope of embodiments of the present disclosure.

In this manner, the focus target information (e.g. coordinates) transmitted to the camera module may have varying degrees of detail and varying degrees of data which is transmitted. For example, transmitting one or more points would include less data than one or more points with radius and/or weight profiles, which would include less data than one or more points comprising a weight mask. As such, the coordinate type may be selected based on the needs of a particular system implementation.

Additionally, in one embodiment, a weight profile may be implied or explicit (e.g. stated). For example, a weight profile which is implied may include a profile which references the same profile. In one embodiment, an implied profile may remain the same (i.e. it cannot be changed). In another embodiment, an implied profile may include use of a set pattern (e.g. circle, rectangle, etc.). Additionally, a weight profile which is explicit may include a profile where weights are referenced every time the weight profile is requested or transmitted.

Still yet, in one embodiment, a weight mask may be explicit, and/or stored and indexed. For example, a weight mask which is explicit would include a mask which is referenced every time the mask is requested or transmitted. A mask may be stored and indexed, and may be referenced later by index. Furthermore, a mask may be stored as metadata within an image.

In one embodiment, information (e.g. metadata) associated with a prior capture may be applied to subsequent frames. For example, in various embodiments, weight profiles and weight masks selected for a first image may be applied to a subsequent image(s). In some instances, a high number of frames may be received (e.g. rapid fire capture, video, etc.) such that previously selected weight profiles and weight masks may be applied to subsequent frames. Furthermore, the information may be associated with one or more focus points, and the coordinates of the one or more focus points may change during the course of capturing the frames or subsequent frames. Of course, in some embodiments, weight profiles and weight masks (as well as any one or more points) may be modified as desired to be applied to the current and subsequent frames.

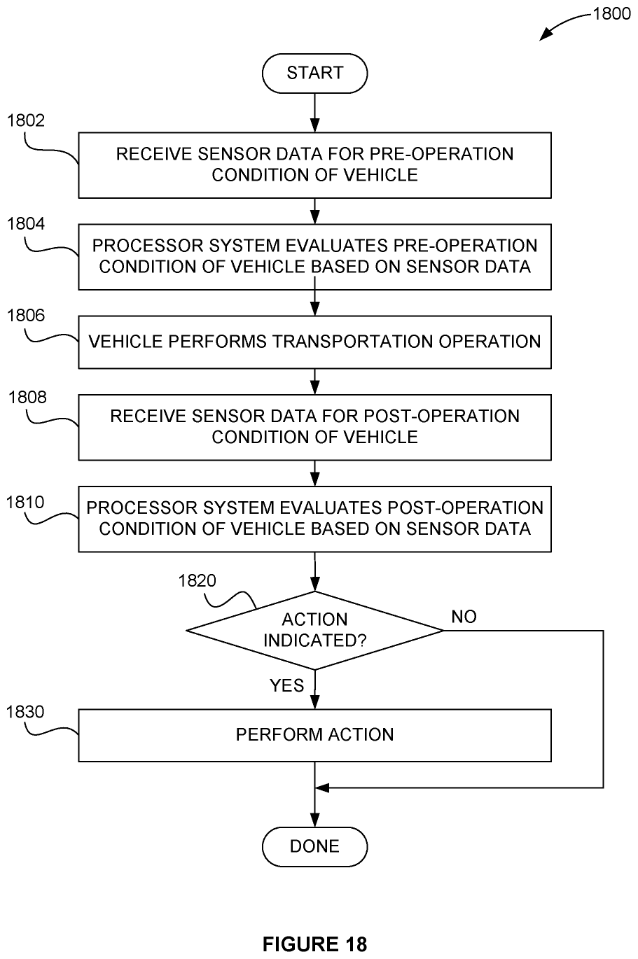

FIG. 18 illustrates a method 1800 for monitoring vehicle condition, in accordance with an embodiment. As an option, the method 1800 may be implemented in the context of the details of any of the Figures disclosed herein. Of course, however, the method 1800 may be implemented in any desired environment. Further, the aforementioned definitions may equally apply to the description below. In an embodiment, method 1800 may be performed by a processor system (e.g., vehicle control and navigation system 702) included within a vehicle (e.g., vehicle 370).

In the present context, vehicle condition may include, without limitation, vehicle weight, weight detected at various locations of vehicle (on seats, on floor panels, glove box, trunk, etc.), an inventory of items within the vehicle, an inventory of items coupled to the vehicle, and so forth. Furthermore, a pre-operation condition may refer to vehicle condition prior to performing a transportation operation, while post-operation condition may refer to vehicle condition after performing the transportation operation. In an embodiment, images may be collected by user ID sensors 372, self-driving sensors 374, additional imaging sensors. Furthermore vehicle condition data may be sampled by sensors for measuring fuel/charge levels, battery health, tire pressure and other elements of vehicle system health, measuring vehicle weight, sensors for performing chemical analysis/measurement, and so forth.

In an embodiment, the transportation operation may include driving to a passenger pick up location, admitting one or more passengers into the vehicle, driving the vehicle to a designated location, and dropping off the one or more passengers. In such an embodiment, pre-operation condition may include a weight for the vehicle prior to picking up passengers and post-operation condition may include a weight for the vehicle after dropping off the passengers. Additionally, pre-operation condition may include a visible assessment of the vehicle, an assessment of potential loose objects being inside the vehicle (or in any storage compartments), and an assessment of potential objects attached to the vehicle exterior or underside. Upon dropping passengers off, post-operation condition may include a weight for the vehicle after passengers have exited the vehicle, and furthermore that no items are left behind inside the vehicle (or in any storage compartments). If a passenger leaves a item behind, the passenger may be alerted to remove the item. If the passenger refuses or ignores the alert, the vehicle may be required to be inspected prior to being redeployed for another transportation operation.

In another embodiment, the transportation operation includes admitting an authorized operator (e.g., driver) into the vehicle, allowing the operator to drive/control the vehicle, and then exit the vehicle. For example, the authorized operator may be admitted into a rental vehicle at a first designated location, with the vehicle assessed for pre-operation condition; and the authorized operator may subsequently exit the vehicle at a second designated location, with the vehicle assessed for post-operation condition. If an item is left inside the vehicle, the authorized operator may be alerted to remove the item. If the authorized operator refuses or ignores the alert, the vehicle may be required to be inspected prior to being redeployed for another transportation operation.

At step 1802, the processor system receives sensor data for pre-operation condition of the vehicle. The sensor data may include, without limitation, images of the vehicle interior, images of the vehicle exterior, images of a history of the vehicle environment, overall vehicle weight, weight at different surfaces and/or compartments, physical state of the vehicle, operational state of the vehicle (diagnostic system status, tire inflation levels, etc.), charge/fuel level of the vehicle, environmental state of the interior of the vehicle, and geo-location of the vehicle. The geo-location of the vehicle may be determined using GPS signals and/or additional signals such as WiFi or cell tower signals. The environmental state may include, without limitation, temperature, humidity, whether smoke/odors are present (chemical analysis of interior air), whether toxins or intoxicants are present (chemical/bio-chemical analysis of interior air), and so forth.

In an embodiment, the sensor data may include a visual verification of a person securing use of the vehicle. Upon visual verification, the person may be authorized to use the vehicle. Vehicle use may include transporting the authorized person from one location to another, allowing other persons to ride in the vehicle from one location to another, delivering a payload form one location to another, or any combination thereof.

At step 1804, the processor system evaluates pre-operation condition of the vehicle based on sensor data. Evaluating may include, without limitation, determining whether the vehicle is in condition to perform a required transportation operation, and recording the condition of the vehicle for comparison to post-operation condition. In an embodiment, a history of images of vehicle components may be assessed prior to admitting a passenger or authorized operator. The assessment may indicate that the vehicle had been tampered with (e.g., a malicious device attached to the vehicle underside) and a warning should be generated. The assessment may also provide a baseline of vehicle condition prior to admitting an authorized occupant (e.g., operator or passenger). A post-operation condition assessment may indicate damage to the vehicle that may have been caused by the authorized occupant.

At step 1806, the processor system causes and/or directs the vehicle to perform a transportation operation. In an embodiment, the transportation operation comprises transporting a person, persons, and/or other payload from one location to another location. In another embodiment, the transportation operation comprises allowing a person to operate or drive the vehicle (e.g., from one location to another, for a certain time period, or for an unspecified time period).

At step 1808, the processor system receives sensor data for post-operation condition of the vehicle. In an embodiment, similar data may be received as in step 1802. Additional sensor data may also be received, including, without limitation, video recordings of vehicle interior, exterior, as well as different instrument readings (speed, breaking rate, fuel/charge level, etc.). The additional data may be received during and/or after the transportation operation.

At step 1810, the processor system evaluates post-operation condition of the vehicle based on the sensor data. In an embodiment, evaluation may include comparing the pre-operation vehicle condition to the post-operation vehicle condition, with differences being optionally recorded. In an embodiment, evaluation may further include one or more of: assessing whether major or minor damage was done to the vehicle, assessing whether an item was left with the vehicle, assessing whether the vehicle needs to be cleaned, assessing whether the vehicle needs to be refueled or charged, and so forth.

In an embodiment, assessing whether an item was left with the vehicle includes one or more of: analyzing vehicle weight measurements for the entire vehicle and/or surfaces or compartments of the vehicle, analyzing image data to determine whether an additional item is present in the vehicle, analyzing video footage starting prior to admitting any persons into the vehicle to determine whether any person has left an item behind, and so forth. Vehicle weight may change according to fuel consumption, windshield cleaning fluid consumption, and so forth; consequently, comparing vehicle weight at pre-operation and post-operation may account for consumable product usage (fuel, windshield fluid, etc).

At step 1820, if action is indicated, the method 1800 proceeds to step 1830, otherwise the method 1800 completes.

At step 1830, the processor system performs an action based on evaluated post-operation condition of the vehicle. In an embodiment, various evaluation outcomes may indicate different, corresponding actions.

For example, if the vehicle is low on fuel or charge (as indicated by received sensor data), then fueling or charging is indicated, and performing the action comprises fueling or charging the vehicle. In another example, if an item is determined to have been left behind in the vehicle or vehicle trunk, then the authorized operator is notified immediately (verbal notice spoken by vehicle with authorized operator still present, text message, etc.) to offer an opportunity to retrieve the item. If the authorized operator is observed receiving and ignoring the notices (or observed not receiving the notices), then the indicated action may be a risk mitigation action. The risk mitigation action may include analyzing video footage of the authorized operator abandoning the item. Analyzing the video footage may be performed by system 700, a different system at a service center, or by a person or persons tasked with such analysis. The risk mitigation action may also include, without limitation, transmitting an alert (e.g., to law enforcement authorities), transmitting video footage (e.g. of the authorized operator who abandoned the item) and location information (e.g., to law enforcement authorities), driving the item to a designated safe location or disposal facility (e.g., preset or indicated by law enforcement in response to alert), and the like.

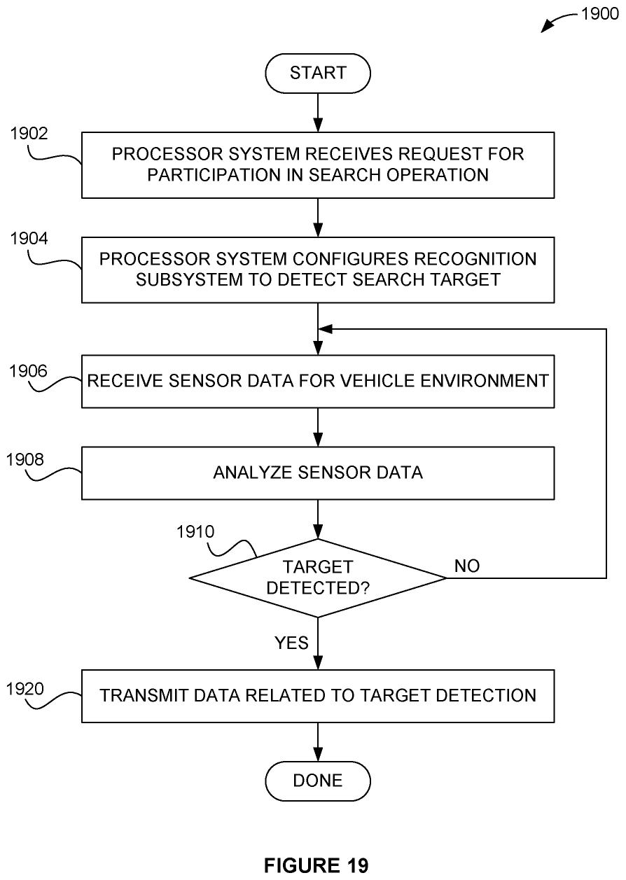

FIG. 19 illustrates a method 1900 for participating in a search operation, in accordance with an embodiment. As an option, the method 1900 may be implemented in the context of the details of any of the Figures disclosed herein. Of course, however, the method 1900 may be implemented in any desired environment. Further, the aforementioned definitions may equally apply to the description below. In an embodiment, method 1900 may be performed by a processor system (e.g., vehicle control and navigation system 702) included within a vehicle (e.g., vehicle 370).

At step 1902, the processor system receives a request for participation in a search operation. The request may include identifying information for a search target. Such identifying information may include, without limitation, a vehicle license plate string, a vehicle description (e.g., make, model, or physical description of specific vehicle), one or more photos of a vehicle, one or more photos of one or more individuals being sought, a set of pre-computed coefficients for an inference engine/convolutional neural network (CNN) for identifying the search target, or a combination thereof.

At step 1904, the processor system configures a recognition subsystem to detect the search target. For example, the processor system may configure the neural-net inference subsystem 706 of system 700 to identify a particular license plate, a particular vehicle, a particular individual, or a combination thereof. In an embodiment, the system 700 may include multiple instances of the neural-net inference subsystem 706, with certain instances dedicated to driving tasks and certain other instances dedicated to secondary recognition tasks, such as performing search operations. In certain embodiments, the different instances may comprise separate hardware subsystems, separately packaged integrated circuits, or separate circuit instances on the same integrated circuit die.

At step 1906, the processor system receives sensor data for a vehicle environment (e.g., a current vehicle environment). The sensor data may include image data from one or more digital cameras (e.g., self-driving sensors 374, user ID sensors 372, other digital cameras) mounted to the vehicle; the image data may include still images and/or video frames. Furthermore, the sensor data may include location data, such as geo-location coordinates.

At step 1908, the processor system analyzes the sensor data. In particular, the processor system analyzes image data comprising the sensor data for visual detection of the search target. Such detection may include, without limitation, detecting the vehicle license plate string from vehicles visible in the image data, detecting a vehicle matching the appearance of the search target, detecting one or more individuals being sought as search targets. In an embodiment, detection confidence may be very high for a matching license place string or matching the one or more individuals, while confidence may be lower for just matching a vehicle appearance.

At step 1910, if a target is detected, then the method 1900 proceeds to step 1920, otherwise the method 1900 proceeds back to step 1906.

At step 1920, the processor system transmits data related to target detection to a service center, which may further provide the data to a law enforcement organization. In an embodiment, the data comprises a geo-location (e.g., GPS coordinates) and image data that served as a basis for the detection. The method 1900 may proceed back (not shown) to step 1906 and continuously operate.

In an embodiment, a target is determined to be detected only for high confidence detection, such as detecting a matching license place string and a matching vehicle appearance, or a matching individual appearance and a matching vehicle appearance. In other embodiments, a target may be determined to be detected even for lower confidence detection, such as a matching vehicle appearance but no license or a non-matching license (e.g., a search target may remove or change the license plate on their vehicle). Such lower confidence detection may be consolidated by the service center for indirect pattern matching that may ultimately yield a conclusive detection.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A device, comprising:
a non-transitory memory storing instructions; and
one or more processors in communication with the non-transitory memory, wherein the one or more processors execute the instructions to:
authenticate a first user by:
receiving one or more first image based on a first set of sampling parameters;
identifying at least one face associated with the one or more first image; and
determining that the at least one face is an authorized user;
based on the authentication, permit the first user to access a first vehicle;
verify use of the first vehicle for the first user; and
in response to the verification, enable operation of the first vehicle by the first user.

2. The device of claim 1, wherein the at least one face is identified by creating a face model, and comparing the face model to a database of authorized face models.

3. The device of claim 1, wherein the at least one face is identified by using at least one of a depth map or a texture map of the at least one image.

4. The device of claim 1, wherein the first user is further authenticated by:
receiving at least one second image based on a second set of sampling parameters, and
blending the one or more first image and the at least one second image to form a blended image.

5. The device of claim 4, wherein the first user is further authenticated by aligning the one or more first image with the at least one second image.

6. The device of claim 1, wherein the first set of sampling parameters relate to an ambient exposure, and the one or more processors execute the instructions to receive at least one second image based on a second set of sampling parameters, the second set of sampling parameters relating to a strobe exposure.

7. The device of claim 1, wherein the first set of sampling parameters include exposure coordinates.

8. The device of claim 1, wherein the first user is further authenticated by receiving an audio input, the audio input compared against an audio signature of authorized users.

9. The device of claim 1, wherein the first user is further authenticated by receiving an iris scan, the iris scan compared against iris scans of authorized users.

10. The device of claim 1, wherein the at least one face is identified using a face model, the face model including an image depth map, an image surface texture map, an audio map, and a correlation map.

11. The device of claim 10, the correlation map matches up audio associated with phonetics, intonations, and/or emotions, with one or more face data points.

12. The device of claim 1, wherein the use of the first vehicle is verified using at least one of a geo-fence, vehicle conditions, road conditions, user conditions, or user restriction rules.

13. The device of claim 1, wherein the first user is further authenticated by using a card emulation mode of a secondary device associated with the first user, the secondary device in communication with the first vehicle using near-field communication (NFC).

14. The device of claim 13, wherein the first user is further authenticated by an audio signature in combination with the card emulation mode.

15. The device of claim 1, wherein the one or more processors execute the instructions to determine that the first vehicle is being operated in a non-compliant manner, and in response, provide a report to a second user.

16. The device of claim 15, wherein the non-compliant manner is overridden based on feedback from the second user in response to the report.

17. The device of claim 1, wherein the use of the first vehicle is restricted based on all occupants of the first vehicle, each occupant of the occupants having a separate occupant profile.

18. The device of claim 17, wherein the operation of the first vehicle is enabled with at least restriction based on a combination of all occupant profiles of the occupants, the at least one restriction including at least one of a time restriction, a speed limit restriction, a route restriction, a location restriction, or a driver restriction.

19. A method, comprising:
authenticating a first user by:
receiving, using a processor, one or more first image based on a first set of sampling parameters;
identifying, using the processor, at least one face associated with the one or more first image; and
determining, using the processor, that the at least one face is an authorized user;
based on the authentication, permitting the first user to access a first vehicle;
verifying use of the first vehicle for the first user; and
in response to the verification, enabling operation of the first vehicle by the first user.

20. A computer program product comprising computer executable instructions stored on a non-transitory computer readable medium that when executed by a processor
authenticate a first user by:
receiving one or more first image based on a first set of sampling parameters;
identifying at least one face associated with the one or more first image; and;
determining that the at least one face is an authorized user;
based on the authentication, permit the first user to access a first vehicle;
verify use of the first vehicle for the first user; and
in response to the verification, enable operation of the first vehicle by the first user.
